(19) United States
(12) Patent Application Publication
(10) Pub. No.: US 2025/0074125 A1
(43) Pub. Date: Mar. 6, 2025

(54) DEVICE FOR COUPLING A TRAILER AND/OR A LOAD CARRIER UNIT

(71) Applicants: Christian Holz, Fellbach (DE); Bertrand Carlier, Kornwestheim (DE); Armin Klein, Wiehl (DE)

(72) Inventors: Christian Holz, Fellbach (DE); Bertrand Carlier, Kornwestheim (DE); Armin Klein, Wiehl (DE)

(73) Assignee: ACPS Automotive GmbH, Ingersheim (DE)

(21) Appl. No.: 18/956,643

(22) Filed: Nov. 22, 2024

Related U.S. Application Data
(63) Continuation of application No. PCT/EP2023/062317, filed on May 9, 2023.

(30) Foreign Application Priority Data
May 25, 2022 (DE) 10 2022 113 310.9

(51) Int. Cl. B60D 1/24; B60D 1/54

(52) U.S. Cl. CPC B60D 1/248; B60D 1/54

(57) ABSTRACT

The invention relates to a method and a device for operating a device that is mountable on the rear side of a motor vehicle body, for coupling a trailer and/or a load carrier unit, comprising a holding arm, which during operation is firmly connected at a first end to the motor vehicle body and at a second end carries a coupling element for the trailer and/or the load carrier unit, wherein during operation forces acting on the coupling element and transmitted from the holding arm to the motor vehicle body are detected by an evaluation unit using deformation sensors, wherein the holding arm has at least two deformation regions of which the deformation behavior in the event of a force acting on the holding arm is detected in each case by at least one deformation sensor that is rigidly coupled to the respective deformation region of the holding arm and as a result detects its deformation behavior.

### CROSS-REFERENCE TO RELATED PATENT APPLICATIONS

This application is a continuation of international application number PCT/EP2023/062317 filed on 9 May 2023 and claims the benefit of German application number 10 2022 113 310.9 filed on 25 May 2022.

The present disclosure relates to the subject matter disclosed in international application number PCT/EP2023/062317 of 9 May 2023 and German application number 10 2022 113 310.9 of 25 May 2022, which are incorporated herein by reference in their entirety and for all purposes.

### BACKGROUND OF THE INVENTION

The invention relates to a method for operating a device that is mountable on the rear side of a motor vehicle body, for coupling a trailer and/or a load carrier unit, comprising a holding arm, which during operation is firmly connected at a first end to the motor vehicle body and at a second end carries a coupling element for the trailer and/or the load carrier unit, wherein during operation forces acting on the coupling element and transmitted from the holding arm to the motor vehicle body are detected by an evaluation unit using deformation sensors, wherein the holding arm has at least two deformation regions of which the deformation behavior in the event of a force acting on the holding arm is detected in each case by at least one deformation sensor that is rigidly coupled to the respective deformation region of the holding arm and as a result detects its deformation behavior, characterized in that the evaluation unit has a load analysis stage which, taking as a starting point deformation values of the at least two deformation regions that are determined by the deformation sensors, determines at least one load type on the holding arm using analytical methods.

### SUMMARY OF THE INVENTION

The advantage of the solution according to the invention can thus be seen in the fact that it provides the possibility of analyzing load types on the holding arm and distinguishing between load types in order thus to be able to deliver for example information regarding the effects of the load on the coupling element on the vehicle.

It is particularly advantageous if the load analysis stage uses the deformation values with no transformation thereof into a force in the vertical direction and/or a force in the vehicle longitudinal direction and/or a force transverse to the vehicle longitudinal center plane.

An advantageous solution here provides for the at least one analytical method to be a value comparison method, that is to say a method that analyzes different determined or stored deformation values by making comparisons with other values.

It is particularly favorable if, in the value comparison method, the deformation values are compared with one another and/or with reference values in order thus to identify whether these fulfill different analytical criteria.

In particular, it is advantageously provided for the reference values to be reference values that are predetermined, in particular stored, in the load analysis stage.

The reference values may fundamentally be established theoretically or by model calculations.

However, it is particularly advantageous if the reference values are determined by tests.

In particular, it is favorable here if the reference values are determined by loading tests of a representative holding arm.

The most diverse procedures are conceivable as regards performing the analytical methods.

An advantageous solution provides, in at least one of the analytical methods, for absolute values of the load-induced deformation values to be evaluated.

The term “load-induced deformation values” is to be understood to mean deformation values that are detected by the deformation sensors in the event of a load on the holding arm and—where applicable, if it is considered necessary—are corrected in respect of the deformation values detected under zero load by a zero-load detection.

For example, in the case of one analytical criterion the focus is on a comparison of the absolute values of the load-induced deformation values with threshold values as reference values.

Another advantageous solution provides, in the case of at least one further analytical criterion, for the focus to be on a comparison of each of the absolute values of the load-induced deformation values with a stored reference value range.

In this case, however, this stored reference value range is also established either theoretically or is preferably to be determined by tests, in particular also by loading tests of a representative holding arm.

A further advantageous solution provides, in the case of at least one analytical criterion, for at least one deformation value of a deformation region to be compared with a deformation value of the at least one other deformation region.

In particular in an analytical method of this kind, a comparison is made of the behavior of the deformation value of a deformation region having high sensitivity to tongue weight relative to a deformation region having little sensitivity to tongue weight.

The method according to the invention may be performed particularly advantageously if an analytical criterion focuses on a comparison of the behavior of at least one of the deformation values of a deformation region having high sensitivity to tongue weight relative to at least one of the deformation values of a deformation region having little sensitivity to tongue weight.

This comparison allows conclusions to be drawn using the most diverse further analytical methods.

A simple solution, in the analytical method, provides for the difference between the two deformation values to be determined.

This difference between the two deformation values could fundamentally be compared with pre-defined reference value ranges.

However, it is particularly advantageous if, in the analytical method, the ratio of the difference between the two deformation values to the larger of the two deformation values is determined.

This ratio could also for example be likewise compared with established reference values.

It is particularly favorable if the analytical criterion focuses on the ratio of the difference between the two deformation values to the larger of the deformation values by comparison with stored reference value ranges.

Each of the analytical criteria explained above enables for example a distinction to be made, using simple arrangements, between the fact that a trailer is acting on the coupling element and the fact that a load carrier, in particular a bicycle carrier, is acting on the coupling element.

Thus, for example in the case of a trailer, the load-induced deformation value or values of a deformation region having high sensitivity to tongue weight lie(s) above a threshold value, and the load-induced deformation value or values of a deformation region having little sensitivity to tongue weight lie(s) below the threshold value.

By contrast, in the case of a bicycle carrier, the load-induced deformation value or values of both deformation regions lie above the threshold value.

Further, in the case of a trailer, the load-induced deformation value or values of the deformation region having little sensitivity to tongue weight lie(s) within a reference value range comprising a deformation value of zero, whereas the load-induced deformation value or values of the deformation region having high sensitivity to tongue weight lie(s) outside the reference value range.

Moreover, the ratio of the difference between the load-induced deformation values of the deformation region having high sensitivity to tongue weight and the deformation region having little sensitivity to tongue weight to the larger of the deformation values lies in a reference value range that has higher values in the case of a trailer than with a bicycle carrier, in the case of which the reference value range of this ratio lies below the reference value range for the trailer.

A further advantageous method provides for an analytical method to detect the size of the forces acting on at least one deformation region by comparing the respective load-induced deformation value with at least one loading reference value predetermined for this.

It is particularly advantageous if, with this method, the at least one load-induced deformation value is associated with at least three loading reference values by associating the at least one deformation value with the ranges between each two successive loading reference values.

Preferably in this case, it is provided for an analytical criterion to focus on the absolute value of at least one of the load-induced deformation values relative to the series of at least three loading reference values associated with this deformation value.

A further advantageous method provides, in one analytical method, for a comparison to be made of at least one of the load-induced deformation values with an associated maximum loading reference value.

In this case, it is preferably provided for an analytical criterion to focus on the absolute value of at least one of the load-induced deformation values relative to the maximum loading reference value associated with this at least one load-induced deformation value.

Using these analytical criteria, it is possible to detect the loads on the holding arm, at least in general terms, without the need for a transformation of the deformation values and a subsequent analysis of the forces Fₓ, F_{y} and F_{z}, namely by detecting the association of the load-induced deformation values with a range between two successive ones of the loading reference values or with the exceeding or approaching of the maximum loading reference value.

A further advantageous method provides, in the analytical method, for at least one load-induced deformation value to be detected with time resolution.

Preferably here, it is provided, in this method, for an analytical criterion to focus on a temporal course of at least one of the deformation values.

This temporal course may be for example a brief time-based change in at least one of the deformation values, that is to say an increase in the at least one of the deformation values over time, in order to detect a brief, in particular abrupt action on the coupling element.

A brief, abrupt action on the coupling element of this kind occurs in particular when a braking action of the trailer does not take place in a desired manner, for example if a braking system of the trailer is faulty.

For example, a brief, abrupt action of this kind lies within a time window of less than 0.5 seconds.

In this case, it is in particular provided for an increase behavior by at least one load-induced deformation value to be detected.

In a case of this kind, an analytical criterion focuses in particular on an edge steepness of the increase behavior that it compares with a reference value.

Thus, in the case of an edge steepness greater than the reference value, problematic behavior of the trailer is present.

A further possibility for detecting the time-resolved behavior of the load-induced deformation values provides, as an alternative or in addition, in the analytical method, for a duration of an increase in at least one load-induced deformation value to a maximum value to be determined.

In this case, the analytical criterion focuses on whether the duration exceeds or falls below a reference time, wherein the reference time is preferably less than 0.5 seconds.

Thus, if the duration is less than the reference time, problematic behavior of the trailer is present.

The above analytical criteria for time-resolved detection of at least one of the load-induced deformation values make it possible to identify pulse-like actions of a trailer on the holding arm, in particular on its coupling element, and thus possible problematic behavior of the trailer, for example an overrun brake thereof that is not operating properly.

Another advantageous embodiment of the analytical method provides, in the analytical method, for a temporal course of an oscillation of at least one of the deformation values about a mean value of this oscillating deformation value to be detected, and in particular for an amplitude and/or period duration to be detected.

An advantageous embodiment of the method according to the invention provides for an analytical criterion to evaluate an amplitude of oscillations of the one of the load-induced deformation values about a mean value and to compare it with a reference value.

In addition or as an alternative, a further solution provides for an analytical criterion to focus on a comparison between a period duration of the one of the load-induced deformation values and a reference period duration.

Analysis of the temporal course of oscillations of at least one of the deformation values makes it possible, in particular by analyzing the size of the amplitude and/or the period duration, to decide whether a trailer hitched to the coupling element is performing movements of no relevance or serious, and thus dangerous for the tractor vehicle, swings from side to side, for example in the event of an amplitude above the reference value or a period duration above the reference period duration.

In order to improve the function of the load analysis stage, it is preferably provided for each deformation value that is made use of by the load analysis stage to be corrected by a zero-load correction stage.

A zero-load correction stage of this kind provides for example for a deformation value under zero load to be determined and subtracted from a determined deformation value under load, such that each deformation value under load is corrected by the portion of the deformation value under zero load.

Preferably, in the solution according to the invention it is provided for the zero-load correction stage to be activated before the holding arm is loaded.

Another advantageous solution provides for the zero-load correction stage to be activated after the holding arm has moved into a working position.

Furthermore, it is preferably provided for each deformation value that is made use of by the load analysis stage to be corrected by an inclination correction stage, which corrects the actual orientation of the holding arm on the basis of an inclination of the vehicle in relation to a deformation value when the holding arm is in an orientation with a vehicle standing on a horizontal reference surface.

Preferably in this case, the inclination correction stage provides for the deformation values of the deformation regions to be changed such that with these the influence of the changed orientation of the holding arm in relation to an orientation of the holding arm with a vehicle standing on a horizontal reference surface is taken into account.

For example, in this case it is provided for the inclination correction stage to operate with stored inclination correction values.

Favorably, the inclination correction values are determined experimentally. In particular, the inclination correction values are determined experimentally by detecting them in the case of a loaded and unloaded holding arm with various inclinations.

As an alternative or in addition to the above solutions, the object mentioned in the introduction is achieved according to the invention by a method for detecting the force on a device that is mountable on the rear side of a motor vehicle body, for coupling a trailer and/or a load carrier unit, comprising a holding arm, which during operation is firmly connected at a first end to the motor vehicle body and at a second end is configured for carrying a coupling element, wherein the holding arm is provided with a sensor arrangement, wherein in the case of this method according to the invention the holding arm is provided with at least two deformation sensors which respond in particular in different ways to three forces acting on the coupling element in spatial directions that run transversely to one another, and in that the at least two deformation sensors supply deformation values from which at least one force component acting on the coupling element is determined.

The advantage of the solution according to the invention can be seen in the fact that it provides the possibility of determining, in a simple manner, reliable values for the effective force.

It is particularly advantageous if at least one of the values of the force components running in these spatial directions is determined.

It is particularly favorable if at least the value of the force component running in the direction of gravity is determined.

Further, it is advantageous if at least the value of the force component running in the direction of travel of the motor vehicle is determined.

Further, it is advantageous if at least the value of the force component running transversely, in particular perpendicular, to a vertical longitudinal center plane is determined.

In order to avoid errors in determining deformation values and/or the values of force components on the coupling element, it is preferably provided for a check to be made before determining the deformation values and/or the values of force components of whether a suitable condition for determining the force components on the coupling element is present.

For this purpose, the most diverse criteria may be made use of.

A favorable solution provides for a check to be made, by detecting at least one of the parameters such as power supply, in particular to the deformation sensors, vehicle orientation in space, that is to say a vehicle orientation such that the vehicle is standing substantially on a horizontal plane, and presence of the working position of the holding arm, of whether a suitable condition for determining the deformation values and/or the force component on the coupling element is present.

In order to avoid falsifying the deformation values and/or the values of force components, advantageously at least one of the respective values under zero load is detected before the respective values are determined.

Further, it is advantageous if the respective values under zero load are detected after the holding arm has moved into a working position, such that it is possible to avoid the respective values being determined outside the working position, which would result in erroneous results.

Moreover, as an alternative or in addition to this, an advantageous solution provides for the respective values under zero load to be detected after the coupling element has been mounted on the holding arm, provided the coupling element is not firmly connected to the holding arm, in order likewise to avoid incorrect measurements.

Moreover, it is provided for the respective values under zero load to be stored only if the values fall below predetermined values that rule out the possibility of an external force on the coupling element, such that a plausibility check is made possible in order to rule out the possibility of erroneous detection of zero load.

A further advantageous solution provides for the respective values under zero load to be detected after the fact of approaching an object, in particular a trailer or a load carrier, has been identified.

Finally, it is preferably provided, after the respective values under zero load have been detected, for the values under zero load to be detected again after a predetermined period, in order to ensure that the values under zero load that were detected on one occasion are not retained in the longer term, leading to erroneous measurements.

In order to obtain load-induced values of the force components that are as exact as possible, it is preferably provided, for determining at least one of the load-induced deformation values and/or the values of force components, for the corresponding values that were obtained under zero load to be subtracted from the values delivered when there is a force on the coupling element.

In order likewise to avoid incorrectly determining the force on the coupling element, determination of the force on the coupling element may in particular be performed when it has been ensured to the greatest possible extent that the condition of the motor vehicle and the device according to the invention permits the force on the coupling element to be determined in as error-free a manner as possible.

Thus, for example, it is provided for at least one of the deformation values and/or the values of force components on the coupling element to be determined if an onboard function of the motor vehicle is being performed, that is to say that the motor vehicle is in an operational condition, but not if it is in a standby condition or for example a switched-off condition.

A further advantageous solution provides for at least one of the deformation values and/or the values of force components on the coupling element to be determined if a plug has been plugged into a socket associated with the holding arm.

In this case, the fact that the plug is plugged into the socket associated with the holding arm may be considered as a signal that an object is acting on the holding arm, in particular the coupling element, and thus exerts a force thereon.

A further favorable solution provides for at least one of the deformation values and/or the values of force components on the coupling element to be determined after an object acting on the coupling element, in particular a trailer or a load carrier, has been identified.

This identification of an object acting on the coupling element may be performed for example using a camera system or a sensor arrangement, preferably an ultrasound sensor arrangement, which are usually provided in any case for the purpose of making it easier to reverse the motor vehicle.

A further favorable solution provides for at least one of the deformation values and/or the values of force components on the coupling element to be determined when the speed of the motor vehicle is less than 5 km per hour, in particular when the motor vehicle is stationary, such that the occurrence of dynamic forces can be ruled out and it can be ensured that only static forces acting on the coupling element are detected.

After at least one of the deformation values and/or the values of force components has been determined, it is transmitted in the most diverse ways.

Preferably, it is provided for at least one of the values in the event of a force component acting vertically on the coupling element to be transmitted.

Further, it is advantageous if at least one of the values in the event of a force component acting on the coupling element in the direction of travel and in particular parallel to a vertical longitudinal center plane is transmitted.

Finally, a further favorable solution provides for at least one of the values in the event of a force component acting transversely to a vertical longitudinal center plane of the holding arm, in particular approximately horizontally, to be transmitted.

Moreover, the deformation values and/or the values of the respective force component may be transmitted in the most diverse ways.

One possibility provides for at least one of the deformation values and/or the values of the respective force component and in particular the accuracy of measurement connected therewith to be displayed, that is to say displayed on a presentation unit such as a screen.

This makes it simpler for a user of the motor vehicle to identify the quality of determination of the deformation values and/or the values of the respective force component very rapidly and from this to draw the necessary conclusions for moving the vehicle.

In order to enable rapid assessment of the deformation values and/or the values of the force component, in particular one solution provides for at least one of the values of the respective force component to be displayed qualitatively in order to enable rapid assessment of the forces acting on the device according to the invention without making a close study.

A further advantageous solution provides for the value in the event of a force component acting vertically on the coupling element to be displayed in relation to a predetermined tongue weight for the respective motor vehicle.

Further, an advantageous solution provides for the value in the event of a force component acting in the direction of travel to be displayed in relation to a maximum tensile force, in order likewise to simplify the effect of the forces acting on the vehicle for a user thereof.

A further advantageous solution provides for at least one of the values in the event of force components acting on the coupling element to be transmitted to an electronic stabilization system of the motor vehicle such that this provides the possibility of taking into account the forces applied by the trailer or the load carrier in a simple manner already at the time of electronic stabilization of the vehicle.

Moreover, an advantageous solution provides for the value in the event of force components acting on the coupling element to be transmitted to a chassis control of the motor vehicle.

In the context of the above explanation of the individual variant embodiments of the method according to the invention, the manner in which the values in the event of force components acting on the coupling element are logically related to the deformation values has not been discussed in detail.

Thus, an advantageous solution provides for the values in the event of force components acting on the coupling element to be logically related to the deformation values using transformation coefficients.

A logical relationship of this kind is formed by a simple mathematical solution that takes into account the different ratios.

In particular, it is provided for the deformation values delivered by the deformation sensors to have a logical relationship with the values of the force components in the three spatial directions that run transversely to one another using the transformation coefficients of a transformation matrix.

More detailed statements have not yet been made as regards determining the transformation coefficients of the transformation matrix.

Thus, an advantageous solution provides for the transformation coefficients of the transformation matrix to be determined in the context of a calibration procedure.

A calibration procedure of this kind provides for example, in the case of a defined force component acting on the coupling element, for the deformation values delivered by the deformation sensors to be detected, wherein during the calibration procedure different force components on the coupling element are successively made use of to generate different deformation values.

In particular here, it is provided in the calibration procedure for in each case a defined force component to act on the coupling element in one of the three spatial directions that run transversely to one another, and for the deformation values delivered by the deformation sensors to be detected.

In particular, the calibration may advantageously be performed if, in the calibration procedure, each force component acting in one of the three spatial directions is of the same magnitude, wherein in particular the individual force components act successively on the coupling element in order to obtain the respective deformation values for each of the individual force components.

A particularly simple mathematical model provides for the transformation coefficients to be determined on the assumption of a linear relationship between the values of the force components in the three spatial directions running transversely to one another and the deformation values delivered by the deformation sensors.

As an alternative or in addition thereto, however, it is also conceivable for the transformation coefficients to be determined by other methods, for example using the least-squares method.

A particularly simple procedure provides for the spatial directions running transversely to one another to run perpendicular to one another.

An improved procedure for determining the values of the force components provides for the space around the coupling element to be divided, starting from the coupling element as the center point, into eight octants defined by the three spatial directions running transversely to one another, for force components within the respective octant to act on the coupling element for the purpose of determining the set of transformation coefficients in each of the octants, for the deformation values to be detected, and for octant-based transformation coefficients to be determined for these force components in the respective one of the octants.

In order to be able to use the octant-based transformation coefficients, however, it is preferably provided, for the purpose of determining the values of the force components on the coupling element, for one of the transformation matrices-which may be a non-octant-based transformation matrix or one of the octant-based transformation matrices-to be made use of and for a check subsequently to be made of which of the octants the force components are to be associated with, and then for the values of the force components to be determined again using the transformation matrix associated with this octant.

As an alternative or in addition to the solutions described above, the object is also achieved according to the invention in the case of a device of the type mentioned in the introduction in that during operation forces acting on the coupling element and transmitted from the holding arm to the motor vehicle body are detected by an evaluation unit having a sensor arrangement that has at least three deformation sensors, and in that in particular the at least three deformation sensors of the sensor arrangement are arranged on the same side of a neutral axis of the holding arm which is not deformed during a bending deformation of the holding arm.

The advantage of the solution according to the invention can be seen in the fact that this makes it possible to detect deformations of the holding arm using the sensor arrangement in a simple manner.

Moreover, the object mentioned in the introduction is also achieved by a device as claimed in claims 40 to 79.

As an alternative or in addition to the solutions described above, the object is also achieved according to the invention in the case of a device of the type mentioned in the introduction in that during operation forces acting on the coupling element and transmitted from the holding arm to the motor vehicle body are detected by an evaluation unit having a sensor arrangement that has at least two deformation sensors, and in that in particular the at least two deformation sensors of the sensor arrangement are arranged on the same side of a neutral axis of the holding arm which is not deformed during a bending deformation of the holding arm.

The advantage of the solution according to the invention can be seen in the fact that this makes it possible to detect deformations of the holding arm using the sensor arrangement in a simple manner.

In particular here, it is advantageous if all the sensors of the sensor arrangement are arranged on the same side of the neutral axis of the holding arm which is not deformed during deformation of the holding arm.

The object mentioned in the introduction is further achieved according to the invention in the case of a device of the type mentioned in the introduction in that arranged on one side of the holding arm is a force detection module that comprises a sensor arrangement which during operation detects forces acting on the coupling element and forces transmitted from the holding arm to the motor vehicle body.

A force detection module of this kind provides an advantageous, simple solution for detecting the forces acting on the holding arm.

In particular here, it is provided for the sensor arrangement of the force detection module to have at least three, in particular four, deformation sensors.

More detailed statements have not yet been made here as regards the arrangement of the force detection module.

Thus, an advantageous solution provides for the force detection module not to be arranged, in the operating condition, on a side of the holding arm facing a road, that is to say that the force detection module is arranged only on the sides of the holding arm not facing the road so that the possibility that the force detection module is damaged by contact between the holding arm and objects on a road or the ground is avoided.

Here, it is particularly favorable if the force detection module is arranged, in the operating condition, on a side of the holding arm facing away from a road.

An arrangement of the force detection module of this kind has the advantage that this is the side least prone to damage for the force detection module.

In order on the one hand to be able to arrange the deformation sensors advantageously and on the other to be able advantageously to transmit deformations of the holding arm to the deformation sensors, in a further solution of the object mentioned in the introduction it is preferably provided during operation for forces acting on the coupling element and transmitted from the holding arm to the motor vehicle body to be detected by an evaluation unit having a sensor arrangement that has at least two deformation sensors, in that the deformation sensors are arranged on at least one deformation transmission element which is connected to the holding arm.

Here, the deformation sensors may be arranged on different deformation transmission elements.

In the case of a further solution of the object mentioned in the introduction it is particularly favorable if during operation forces acting on the coupling element and transmitted from the holding arm to the motor vehicle body are detected by an evaluation unit having a sensor arrangement that has at least two deformation sensors, and if all the deformation sensors of the sensor arrangement are arranged on a common deformation transmission element.

Particularly advantageous detection of the forces acting on the holding arm is possible in particular if in the event of one and the same force acting on the coupling element each of the at least two deformation sensors detects different amounts of deformation of the holding arm, since in this way differently oriented forces that may act on the coupling element can be easily separated.

As regards connecting the deformation transmission element to the holding arm, it is preferably provided for the deformation transmission element to be connected to the holding arm in a manner free of relative movement and thus rigidly at at least two securing regions, and for at least one of the deformation sensors to be arranged between the securing regions of the deformation element.

It is even more advantageous if the deformation transmission element is connected to the holding arm by at least three securing regions, and at least one of the deformation sensors is arranged respectively between two of the securing regions.

More detailed statements have not yet been made as regards connecting the securing regions of the deformation transmission element to the holding arm.

Fundamentally, it is conceivable to connect the securing regions directly to the holding arm, for example by welding them to it.

However, a particularly advantageous solution provides for the deformation transmission element to be connected to the holding arm in the securing regions using connection elements.

Such a connection to the holding arm using the connection elements can be achieved particularly favorably if the connection elements are connected on the one hand rigidly to the holding arm and on the other rigidly to the securing regions of the deformation transmission element.

A particularly advantageous solution provides for the connection elements to be integrally formed on the holding arm, in particular in one piece.

When a connection of this kind is provided between the holding arm and the deformation transmission element, it is preferably provided for the connection elements to transmit deformations of the holding arm in deformation regions of the holding arm that respectively lie between the connection elements to the securing regions of the deformation transmission element.

In particular, it is favorable if a deformation region of the holding arm lies in each case between two connection elements.

A solution that is particularly advantageous from a structural point of view provides for the holding arm to have at least two deformation regions, of which deformations are transmitted to securing regions of the deformation transmission element by way of connection elements that are arranged on either side of the respective deformation region, wherein a deformation-affected region of the deformation transmission element lies between the securing regions.

As regards the arrangement of the two deformation regions in the holding arm, it is particularly advantageous if the at least two deformation regions are arranged successively in a direction of extent of the holding arm.

Further, for the purpose of detecting the deformations in the deformation-affected regions, it is favorable if at least one deformation sensor is arranged in one of the deformation-affected regions of the deformation transmission element.

In particular here, at least one deformation sensor is arranged in each of the deformation-affected regions of the deformation transmission element.

Moreover, it is favorably provided for each deformation-affected region to be connected to a deformation-resistant region of the deformation transmission element, and for the securing regions respectively to lie in a deformation-resistant region such that they are comprised within the respective deformation-resistant region.

The term “deformation-resistant region” here is in particular to be understood to mean that it has significantly higher rigidity than a deformation-affected region, that is to say at least a factor of two higher, or better at least a factor of five higher.

This solution has the advantage that as great a proportion as possible of the deformations transmitted from the deformation regions of the holding arm to the deformation transmission element is not distributed over the entire deformation transmission element but has an effect substantially in the deformation-affected regions, in order thus to achieve as great as possible a deformation in these deformation-affected regions, in which in particular the deformation sensors are arranged, and to have as little deformation as possible or none at all in the deformation-resistant regions of the deformation transmission element.

It is particularly favorable if the deformation-affected regions are respectively arranged between two deformation-resistant regions.

Further, for an optimum and maximized transfer of all the deformation that is transmitted to the deformation transmission element to the deformation-affected regions, it is favorable if the deformation-resistant regions and the deformation-affected regions are arranged successively in a deformation direction, that is to say if the deformation-resistant and the deformation-affected regions are arranged successively in the direction in which the substantial deformation is transmitted to the deformation transmission element.

Further, it is advantageous if the deformation-affected regions take the form of deformation concentration regions.

The term “deformation concentration region” is in particular to be understood to mean the region in which the major part, that is to say more than 50%, or better more than 70%, of the deformations transmitted to or acting on the deformation transmission element is formed.

Such a formation of the deformation-affected regions has the advantage that the deformations can be substantially concentrated therein and thus the respective deformation sensors can detect deformations that are as large as possible.

More detailed statements have not yet been made as regards the form taken by the material of the deformation transmission element.

Thus, it is preferably provided for the material of the deformation transmission element outside the deformation-affected regions to take the form of deformation-resistant or deformation-insusceptible material, that is to say that for example less than 30%, or better less than 20%, preferably less than 10%, of the deformations transmitted to or acting on the deformation transmission element are formed outside the deformation-affected regions.

On the other hand, it is preferably provided for the material of the deformation transmission element in the deformation-affected regions to be prone to deformation or suitable for deformation as a result of being given a suitable shape, for example a narrowing in cross section.

In order to be able to compensate for deformations of the deformation transmission element that are not caused by deformations of the holding arm, it is preferably provided for the deformation transmission element to have, next to the respective deformation-affected region, a deformation-free region on which at least one reference deformation sensor is arranged.

In a deformation-free region, as a result of the form and arrangement thereof, there occur substantially no deformations, that is to say in particular less than 20%, or better less than 10% and preferably less than 5% of the deformations transmitted to or acting on the deformation transmission element.

Such a reference deformation sensor in a deformation-free region provides the possibility of detecting material deformations in the deformation transmission element that are brought about by influences other than the deformations transmitted to or acting on the deformation transmission element-material deformations that occur for example as a result of thermal influences-using the reference deformation sensors and then, since they are also detected by the deformation sensor, correcting them thereby.

For this reason, it is preferably provided for the respective deformation-free region to be made from the same material as the deformation-affected region.

Further, it is preferably provided for the respective deformation-free region to be connected on one side to a deformation-resistant region of the deformation transmission element.

A particularly advantageous geometric shape provides for the deformation-free region of the deformation transmission element to be formed in the manner of a tongue.

Moreover, it is preferably provided for the deformation-free region of the deformation transmission element to be made from the same material, in particular with the same material thickness, as the deformation-affected region.

In order to achieve optimum coupling of the effects detected by the reference deformation sensors and the effects detected by the deformation sensors, it is preferably provided for the reference deformation sensors to be thermally coupled to the deformation transmission element.

In particular, this makes it possible for the reference deformation sensors to be thermally coupled to the deformation sensors by way of the deformation transmission element.

In particular if a reference deformation sensor is associated with each deformation sensor, optimum thermal coupling is achieved if, between the respective deformation sensor and the reference deformation sensor associated therewith, each deformation-affected region that is provided with a deformation sensor is thermally coupled to the deformation-free region associated therewith and carrying the associated reference deformation sensor.

Overall, it is advantageous if the deformation-free region carrying the respective reference deformation sensor has the same thermal behavior as the deformation-affected region carrying the corresponding deformation sensor.

In order that, to the greatest possible extent, the same deformations are present in the region of the reference deformation sensor as in the region of the deformation sensor, it is favorably provided for the respective deformation-free region carrying the reference deformation sensor to have a geometric shape that is comparable with, preferably identical to, the deformation-affected region carrying the deformation sensor.

In particular here, it is likewise advantageous if the deformation-free region of the deformation transmission element is made from the same material as the deformation-affected region of the deformation transmission element.

In order to monitor the functionality of the reference deformation sensors, it is preferably provided for at least one temperature sensor to be associated with the reference deformation sensors for the purpose of monitoring function.

It is even better if a temperature sensor is associated with each of the reference deformation sensors for the purpose of monitoring function.

More detailed statements have not yet been made as regards the form taken by the deformation transmission element.

Thus, an advantageous solution provides for the deformation transmission element to take a plate-like form and for each deformation-affected region carrying a deformation sensor to be formed by a narrowing in cross section of the deformation transmission element.

In particular here, it is provided for the narrowing in cross section of the deformation transmission element to be formed by a narrowing of a surface extent of the deformation transmission element.

The deformation sensors and the reference deformation sensors may be sensors taking the most diverse forms, which may detect extensions and/or compressions in the deformation-affected regions.

One possibility provides for the deformation sensors and the reference deformation sensors to take the form of extension sensors, in particular strain gages.

Another possibility provides for the deformation sensors and the reference deformation sensors to take the form of magnetostrictive or indeed optical sensors that detect extensions and compressions.

In particular, for optimum compensation of an extension sensor, it is advantageous if the reference extension sensor associated with this is identical to the associated extension sensor.

The object mentioned in the introduction is in particular also achieved according to the invention in that the holding arm has, between the first end and the second end, a first deformation region and a second deformation region which, when there is a force acting in the longitudinal center plane of the holding arm parallel to the direction of travel, each undergo deformations that differ from the deformations when there is a force acting in the longitudinal center plane and transversely to the direction of travel.

The advantage of the solution according to the invention can be seen in the fact that because the first and the second deformation regions behave differently, that is to say deform to different extents, when there is a force acting in the longitudinal center plane of the holding arm and parallel to the direction of a travel and a force acting in the longitudinal center plane and transversely, in particular perpendicular, to the direction of travel that is the same size, in particular as regards the magnitude thereof, this provides the possibility, as a result of these different deformations of the first deformation region and the second deformation region, of differentiating between a force acting in the longitudinal center plane of the holding arm and parallel to the direction of travel and a force acting in the longitudinal center plane of the holding arm and transversely to the direction of travel when the signals of the deformation sensors are evaluated.

It is even more favorable if, when there is a force acting transversely, in particular perpendicular, to the longitudinal center plane, in particular likewise of the same magnitude as the forces acting in the longitudinal center plane and parallel or transversely to the direction of travel, the first and the second deformation region likewise behave differently, that is to say deform to different extents.

The different behavior of the first and second deformation regions can be achieved by giving them different shapes, in particular by the first and second deformation regions in the holding arm having different cross sections and/or a different course and/or a different length.

In particular here, it is provided for the first and the second deformation region to be arranged successively, as seen in a direction of extent of the holding arm.

More detailed statements have not been made, in the context of the above explanation of the solution according to the invention, as regards processing of the signals of the deformation sensors and the reference deformation sensors.

Thus, an advantageous solution provides for each deformation sensor to be connected up to the associated reference deformation sensor in a Wheatstone bridge.

In this way, effects, in particular thermal effects, not caused by the deformation of one of the deformation regions of the holding arm may be compensated in a simple manner with the direct use of the signals of the deformation sensor and the reference deformation sensor.

Further, an advantageous solution provides for the evaluation unit to have a processor which converts the values corresponding to the deformations in the deformation-affected regions, using transformation values that are determined by calibration and stored in a memory, into the corresponding values of forces acting in three spatial directions running transversely, in particular perpendicular, to one another and on the coupling element.

This provides the possibility of determining the forces acting on the coupling element in three spatial directions running transversely, in particular perpendicular, to one another from the values corresponding to the deformations.

It is particularly favorable here if two of the forces run parallel to and in particular in the longitudinal center plane of the holding arm but transversely, in particular perpendicular, to one another and the third force runs transversely, in particular perpendicular, to the longitudinal center plane of the holding arm.

It is possible to improve conversion of the values corresponding to the deformations if transformation values for combinations of forces acting on the coupling element in different octants are stored in the memory, since these different transformation values permit optimized adaptation to actual conditions.

In particular, an evaluation unit corresponding to the solution according to the invention takes a form such that it detects the values of deformation sensors and in particular where appropriate also reference deformation sensors for the purpose of determining deformations.

In order moreover also to have the possibility of performing a function check of the reference deformation sensors, it is provided for the evaluation unit to comprise values of at least one temperature sensor for the function check of reference deformation sensors.

It is even better if, for the function check of the reference deformation sensors, the evaluation unit detects values of respectively one temperature sensor associated with the respective reference deformation sensor.

Here, the at least one temperature sensor or sensors may be arranged either on a circuit board carrying the evaluation unit or on the deformation transmission element.

More detailed statements have not been made in the above exemplary embodiments of how the holding arm and the coupling element may be connected to one another.

An advantageous solution provides for the holding arm to carry the coupling element at its second end.

In this case, it is particularly favorable if the holding arm and the coupling element form a cohesive part, with the result that it is not possible to separate the holding arm and the coupling element.

In particular in a case of this kind, it is provided for the holding arm to take the form of a ball neck and to carry the coupling element, which comprises a coupling ball, at the second end.

A further advantageous solution provides for the holding arm to comprise a receiving body that is formed for detachably receiving the coupling element.

The coupling element is for example part of a carrier system for coupling it to the holding arm.

The coupling element takes the form for example of a coupling element of a carrier system for goods, in particular baggage or bicycles.

In particular here, the receiving body takes a form such that it has an insertion receptacle that is accessible through an insertion opening.

In the case of an above-mentioned receiving body of the holding arm, it is preferably provided for the coupling element to comprise a carrier arm.

Here, the carrier arm is favorably provided with an insertion portion that is configured to be inserted into the insertion receptacle and fixed therein.

The carrier arm is then for example part of the carrier system.

As an alternative to this, in a further embodiment the carrier arm takes a form such that it carries a coupling ball.

In a further embodiment, the carrier arm is provided with other coupling devices such as a coupling jaw.

For the purpose of fixing the carrier arm precisely, it is favorable if the insertion portion is received in the insertion receptacle transversely to an insertion direction with positive engagement and in the functional condition is fixed in the insertion direction by a positive-engagement body.

Thus, the above description of solutions according to the invention comprises in particular the different combinations of features that are defined by the sequentially numbered embodiments below:

1. A method for operating a device that is mountable on the rear side of a motor vehicle body, for coupling a trailer and/or a load carrier unit (360), comprising a holding arm (30), which during operation is firmly connected at a first end (32) to the motor vehicle body (12) and at a second end carries a coupling element (40) for the trailer (350) and/or the load carrier unit (360), wherein during operation forces acting on the coupling element (40) and transmitted from the holding arm (30) to the motor vehicle body (12) are detected by an evaluation unit (230) using deformation sensors (172, 174, 176, 178), wherein the holding arm (30) has at least two deformation regions (82, 84) of which the deformation behavior in the event of a force acting on the holding arm (30) is detected in each case by at least one deformation sensor (172, 174, 176, 178) that is rigidly coupled to the respective deformation region (82, 84) of the holding arm (30) and as a result detects its deformation behavior, wherein the evaluation unit (230) has a load analysis stage (233) which, taking as a starting point deformation values (D152, D154, D156, D158) of the at least two deformation regions (82, 84) that are determined by the deformation sensors (172, 174, 176, 178), determines at least one load type on the holding arm (30) using analytical methods.

2. The method according to embodiment 1, wherein the load analysis stage (233) uses the deformation values (D152, D154, D156, D158) with no transformation thereof into forces in the vertical direction (F_{z}) and/or in the vehicle longitudinal direction (24) and/or transverse to the vehicle longitudinal center plane (F_{y}).

3. The method according to one of the preceding embodiments, wherein the at least one analytical method is a value comparison method.

4. The method according to one of the preceding embodiments, wherein, in the value comparison method, the deformation values (D) are compared with one another and/or with reference values (RB0, S, RAWB, RFWB, B1 . . . B6, RFS, ZR, RAS, RPS).

5. The method according to embodiment 4, wherein the reference values are reference values (RB0, S, RAWB, RFWB, B1 . . . B6, RFS, ZR, RAS, RPS) that are predetermined, in particular stored.

6. The method according to embodiment 4 or 5, wherein the reference values (RB0, S, RAWB, RFWB, B1 . . . B6, RFS, ZR, RAS, RPS) are determined by tests.

7. The method according to embodiment 6, wherein the reference values are determined by loading tests of a representative holding arm (30).

8. The method according to one of the preceding embodiments, wherein, in at least one analytical method, absolute values of the load-induced deformation values (D) are evaluated.

9. The method according to embodiment 8, wherein in the case of one analytical criterion the focus is on a comparison of the absolute values of the load-induced deformation values (D) with threshold values(S) as reference values.

10. The method according to embodiment 8 or 9, wherein, in the case of at least one analytical criterion, the focus is on a comparison of each of the absolute values of the load-induced deformation values (D) with a stored reference value range (RB0).

11. The method according to one of the preceding embodiments, wherein, in at least one analytical method, at least one deformation value (D) of a deformation region (82) is compared with at least one deformation value (D) of the at least one other deformation region (84).

12. The method according to one of the preceding embodiments, wherein the analytical method is based on a comparison of the behavior of the deformation values (D152, D154) of a deformation region having high sensitivity to tongue weight relative to a deformation region having little sensitivity to tongue weight.

13. The method according to embodiment 11 or 12, wherein, in the analytical method, the difference between the two deformation values (D) is determined.

14. The method according to embodiment 13, wherein, in the analytical method, the ratio of the difference between the two deformation values (D) to the larger of the two deformation values (D) is determined.

15. The method according to one of embodiments 11 to 14, wherein one analytical criterion focuses on a comparison of the behavior of at least one deformation value (D152, D154) of a deformation region (82) having high sensitivity to tongue weight relative to at least one deformation value (D156, D158) of a deformation region (84) having little sensitivity to tongue weight.

16. The method according to embodiment 15, wherein the analytical criterion focuses on the ratio of the difference between the deformation values (D) to the larger of the two deformation values (D) by comparison with stored reference value ranges (RAWB, RFWB).

17. The method according to one of the preceding embodiments, wherein one analytical method is used to determine the size of the load-induced deformation value (D152, D154, D156, D158) determined in the case of at least one deformation region (82, 84) by a comparison of this load-induced deformation value (D152, D154, D156, D158) with at least one loading reference value (B1 . . . B6) predetermined for this deformation value.

18. The method according to embodiment 17, wherein, in the analytical method, the at least one load-induced deformation value (D152, D154, D156, D158) is associated with a plurality of predetermined loading reference values (B1 . . . B6) by associating the at least one load-induced deformation value (D152, D154, D156, D158) with the ranges (BS1, BS2, BS3, BS4, BS5) between each two successive loading reference values (B1 . . . B6).

19. The method according to embodiment 17 or 18, wherein an analytical criterion focuses on the association of the at least one of the deformation values relative to the series of at least three loading reference values (B1 to B6) provided in relation to this deformation value.

20. The method according to one of the preceding embodiments, wherein, in one analytical method, a comparison is made of at least one of the deformation values (D152, D154, D156, D158) with an associated maximum loading reference value (B6).

21. The method according to embodiment 20, wherein an analytical criterion focuses on the association of the load-induced deformation value of at least one of the load-induced deformation values (D152, D154, D156, D158) relative to a maximum loading reference value (B6) associated with the deformation value.

22. The method according to one of the preceding embodiments, wherein one analytical method detects at least one of the load-induced deformation values (D152, D154, D156, D158) with time resolution.

23. The method according to embodiment 22, wherein an analytical criterion focuses on a brief time-based change in at least one of the deformation values (D152, D154, D156, D158).

24. The method according to embodiment 23, wherein, in the analytical method, an increase behavior by at least one of the load-induced deformation values (D152, D154, D156, D158) is detected.

25. The method according to embodiment 24, wherein an analytical criterion compares an edge steepness (FS) of the increase behavior with a stored reference value (RFS).

26. The method according to one of embodiments 22 to 25, wherein, in the analytical method, a duration (Z) of an increase in at least one of the load-induced deformation values (D) to a maximum value is determined.

27. The method according to one of embodiments 22 to 26, wherein an analytical criterion focuses on comparing the duration (Z) with a reference time (RZ).

28. The method according to one of embodiments 22 to 27, wherein an analytical criterion focuses on a temporal course of at least one of the deformation values.

29. The method according to one of embodiments 22 to 28, wherein, in the analytical method, a temporal course of an oscillation of at least one of the deformation values (D152, D154, D156, D158) about a mean value of this oscillating deformation value (D152, D154, D156, D158) is detected.

30. The method according to embodiment 29, wherein an analytical criterion focuses on a comparison of an amplitude (AS) of oscillations of the one of the load-induced deformation values (D152, D154, D156, D158) about the mean value with a reference value (RAS).

31. The method according to embodiment 28 to 30, wherein an analytical criterion focuses on a comparison of a period duration (PS) of the one of the load-induced deformation values with a reference period duration (RPS).

32. The method according to the preamble of embodiment 1 or according to one of the preceding embodiments, wherein each of the deformation values (D) that is made use of by the load analysis stage (233) is corrected by a zero-load correction stage (285).

33. The method according to embodiment 32, wherein the zero-load correction stage (285) determines a deformation value (DI) under zero load and subtracts it from a determined deformation value (D) under load.

34. The method according to embodiment 32 or 33, wherein the zero-load correction stage (285) is activated before the holding arm (30) is loaded.

35. The method according to one of embodiments 32 to 34, wherein the zero-load correction stage (285) is activated after the holding arm (30) has moved into a working position.

36. The method according to one of the preceding embodiments, wherein each deformation value (D) that is made use of by the load analysis stage (233) is corrected by an inclination correction stage (283), which corrects the actual orientation of the holding arm (30) on the basis of an inclination of the vehicle in relation to a deformation value (D) when the holding arm (30) is in an orientation with a vehicle standing on a horizontal reference surface.

37. The method according to embodiment 36, wherein the inclination correction stage (283) changes the deformation values (D) of the deformation regions (152, 154, 156, 158) such that with these the influence of the changed orientation of the holding arm (30) relative to an orientation of the holding arm (30) with a vehicle standing on a horizontal reference surface is taken into account.

38. The method according to embodiment 36 or 37, wherein the inclination correction stage (283) operates with stored inclination correction values.

39. The method according to embodiment 38, wherein the inclination correction stage (283) operates with experimentally determined inclination correction values.

40. A device that is mountable on the rear side of a motor vehicle body, for coupling a trailer and/or a load carrier unit (360), comprising a holding arm (30), which during operation is firmly connected at a first end (32) to the motor vehicle body (12) and at a second end carries a coupling element (40) for the trailer (350) and/or the load carrier unit (360), wherein during operation forces acting on the coupling element (40) and transmitted from the holding arm (30) to the motor vehicle body (12) are detected by an evaluation unit (230) using deformation sensors (172, 174, 176, 178), wherein the holding arm (30) has at least two deformation regions (82, 84) of which the deformation behavior in the event of a force acting on the holding arm (30) is detected in each case by at least one deformation sensor (172, 174, 176, 178) that is rigidly coupled to the respective deformation region (82, 84) of the holding arm (30) and as a result detects its deformation behavior, wherein the evaluation unit (230) has a load analysis stage (233) which, taking as a starting point deformation values (D152, D154, D156, D158) of the at least two deformation regions (82, 84) that are determined by the deformation sensors (172, 174, 176, 178), determines at least one load type on the holding arm (30) using analytical methods.

41. The device according to embodiment 40, wherein the load analysis stage (233) uses the deformation values (D152, D154, D156, D158) with no transformation thereof into forces in the vertical direction (F_{z}) and/or in the vehicle longitudinal direction (24) and/or transverse to the vehicle longitudinal center plane (F_{y}).

42. The device according to one of embodiments 40 to 41, wherein the at least one analytical method is a value comparison method.

43. The device according to one of embodiments 40 to 42, wherein, in the value comparison method, the deformation values (D) are compared with one another and/or with reference values (RB0, S, RAWB, RFWB, B1 . . . B6, RFS, ZR, RAS, RPS).

44. The device according to embodiment 43, wherein the reference values are reference values (RB0, S, RAWB, RFWB, B1 . . . B6, RFS, ZR, RAS, RPS) that are predetermined, in particular stored.

45. The device according to embodiment 43 or 44, wherein the reference values (RB0, S, RAWB, RFWB, B1 . . . B6, RFS, ZR, RAS, RPS) are determined by tests.

46. The device according to embodiment 45, wherein the reference values are determined by loading tests of a representative holding arm (30).

47. The device according to one of embodiments 40 to 46, wherein, in at least one analytical method, absolute values of the load-induced deformation values (D) are evaluated.

48. The device according to embodiment 47, wherein in the case of one analytical criterion the focus is on a comparison of the absolute values of the load-induced deformation values (D) with threshold values(S) as reference values.

49. The device according to embodiment 47 or 48, wherein, in the case of at least one analytical criterion, the focus is on a comparison of each of the absolute values of the load-induced deformation values (D) with a stored reference value range (RB0).

50. The device according to one of embodiments 40 to 49, wherein, in at least one analytical method, at least one deformation value (D) of a deformation region (82) is compared with at least one deformation value (D) of the at least one other deformation region (84).

51. The device according to one of embodiments 40 to 50, wherein the analytical method is based on a comparison of the behavior of the deformation values (D152, D154) of a deformation region having high sensitivity to tongue weight relative to a deformation region having little sensitivity to tongue weight.

52. The device according to embodiment 50 or 51, wherein, in the analytical method, the difference between the two deformation values (D) is determined.

53. The device according to embodiment 52, wherein, in the analytical method, the ratio of the difference between the two deformation values (D) to the larger of the two deformation values (D) is determined.

54. The device according to one of embodiments 50 to 53, wherein one analytical criterion focuses on a comparison of the behavior of at least one deformation value (D152, D154) of a deformation region (82) having high sensitivity to tongue weight relative to at least one deformation value (D156, D158) of a deformation region (84) having little sensitivity to tongue weight.

55. The device according to embodiment 54, wherein the analytical criterion focuses on the ratio of the difference between the deformation values (D) to the larger of the two deformation values (D) by comparison with stored reference value ranges (RAWB, RFWB).

56. The device according to one of embodiments 40 to 55, wherein one analytical method is used to determine the size of the load-induced deformation value (D152, D154, D156, D158) determined in the case of at least one deformation region (82, 84) by a comparison of this load-induced deformation value (D152, D154, D156, D158) with at least one loading reference value (B1 . . . B6) predetermined for this deformation value.

57. The device according to embodiment 56, wherein, in the analytical method, the at least one load-induced deformation value (D152, D154, D156, D158) is associated with a plurality of predetermined loading reference values (B1 . . . B6) by associating the at least one load-induced deformation value (D152, D154, D156, D158) with the ranges (BS1, BS2, BS3, BS4, BS5) between each two successive loading reference values (B1 . . . B6).

58. The device according to embodiment 56 or 57, wherein an analytical criterion focuses on the association of the at least one of the deformation values relative to the series of at least three loading reference values (B1 to B6) provided in relation to this deformation value.

59. The device according to one of embodiments 40 to 58, wherein, in one analytical method, a comparison is made of at least one of the deformation values (D152, D154, D156, D158) with an associated maximum loading reference value (B6).

60. The device according to embodiment 59, wherein an analytical criterion focuses on the association of the load-induced deformation value of at least one of the load-induced deformation values (D152, D154, D156, D158) relative to a maximum loading reference value (B6) associated with the deformation value.

61. The device according to one of embodiments 40 to 60, wherein one analytical method detects at least one of the load-induced deformation values (D152, D154, D156, D158) with time resolution.

62. The device according to embodiment 61, wherein an analytical criterion focuses on a brief time-based change in at least one of the deformation values (D152, D154, D156, D158).

63. The device according to embodiment 62, wherein, in the analytical method, an increase behavior by at least one of the load-induced deformation values (D152, D154, D156, D158) is detected.

64. The device according to embodiment 63, wherein an analytical criterion compares an edge steepness (FS) of the increase behavior with a stored reference value (RFS).

65. The device according to one of embodiments 61 to 64, wherein, in the analytical method, a duration (Z) of an increase of at least one of the load-induced deformation values (D) to a maximum value is determined.

66. The device according to one of embodiments 61 to 65, wherein an analytical criterion focuses on comparing the duration (Z) with a reference time (RZ).

67. The device according to one of embodiments 61 to 66, wherein an analytical criterion focuses on a temporal course of at least one of the deformation values.

68. The device according to one of embodiments 61 to 67, wherein, in the analytical method, a temporal course of an oscillation of at least one of the deformation values (D152, D154, D156, D158) about a mean value of this oscillating deformation value (D152, D154, D156, D158) is detected.

69. The device according to embodiment 68, wherein an analytical criterion focuses on a comparison of an amplitude (AS) of oscillations of the one of the load-induced deformation values (D152, D154, D156, D158) about the mean value with a reference value (RAS).

70. The device according to one of embodiments 67 to 69, wherein an analytical criterion focuses on a comparison of a period duration (PS) of the one of the load-induced deformation values with a reference period duration (RPS).

71. The device according to the preamble of embodiment 40 or according to one of embodiments 40 to 68, wherein deformation value (D) that is made use of by the load analysis stage (233) is corrected by a zero-load correction stage (285).

72. The device according to embodiment 71, wherein the zero-load correction stage (285) determines a deformation value (DI) under zero load and subtracts it from a determined deformation value (D) under load.

73. The device according to embodiment 71 or 72, wherein the zero-load correction stage (285) is activated before the holding arm (30) is loaded.

74. The device according to one of embodiments 71 to 73, wherein the zero-load correction stage (285) is activated after the holding arm (30) has moved into a working position.

75. The device according to one of embodiments 40 to 74, wherein each deformation value (D) that is made use of by the load analysis stage (233) is corrected by an inclination correction stage (283), which corrects the actual orientation of the holding arm (30) on the basis of an inclination of the vehicle in relation to a deformation value (D) when the holding arm (30) is in an orientation with a vehicle standing on a horizontal reference surface.

76. The device according to embodiment 75, wherein the inclination correction stage (283) changes the deformation values (D) of the deformation regions (152, 154, 156, 158) such that with these the influence of the changed orientation of the holding arm (30) relative to an orientation of the holding arm (30) with a vehicle standing on a horizontal reference surface is taken into account.

77. The device according to embodiment 75 or 76, wherein the inclination correction stage (283) operates with stored inclination correction values.

78. The device according to embodiment 77, wherein the inclination correction stage (283) operates with experimentally determined inclination correction values.

79. The device according to the preamble of embodiment 40 or according to one of embodiments 40 to 78, wherein the at least two deformation sensors (172, 174, 176, 178) of the sensor arrangement (170) are arranged on the same side of a neutral axis of the holding arm (30) which is not variable in length during a bending deformation of the holding arm.

80. The device according to embodiment 79, wherein arranged on one side of the holding arm (30, 30′) is a force detection module (100) that comprises a sensor arrangement (170) which during operation detects forces acting on the coupling element (40) and transmitted from the holding arm (30) to the motor vehicle body (12).

81. The device according to embodiment 80, wherein the sensor arrangement has at least three, in particular four, deformation sensors (172, 174, 176).

82. The device according to embodiment 80 or 81, wherein the force detection module (100) is not arranged, in the operating condition, on a side of the holding arm (30, 30′) facing a road (44).

83. The device according to one of embodiments 80 to 82, wherein the force detection module (100) is arranged, in the operating condition, on a side of the holding arm (30, 30′) facing away from a road (44).

84. The device according to the preamble of embodiment 40 or according to one of embodiments 40 to 83, wherein during operation forces acting on the coupling element (40) and transmitted from the holding arm (30) to the motor vehicle body (12) are detected by an evaluation unit (230) having a sensor arrangement (170) that has at least two deformation sensors (172, 174, 176, 178), in that the deformation sensors (172, 174, 176, 178) are arranged on at least one deformation transmission element (102) which is connected to the holding arm (30).

85. The device according to the preamble of embodiment 40 or according to one of embodiments 40 to 84, wherein during operation forces acting on the coupling element (40) and transmitted from the holding arm (30) to the motor vehicle body (12) are detected by an evaluation unit (230) having a sensor arrangement (170) that has at least two deformation sensors (172, 174, 176, 178), in that all the deformation sensors (172, 174, 176, 178) of the sensor arrangement (170) are arranged on a common deformation transmission element (102).

86. The device according to one of embodiments 79 to 85, wherein in the event of one and the same force acting on the coupling element (40) each of the at least two deformation sensors (172, 174, 176, 178) detects different amounts of deformation of the holding arm (30, 30′).

87. The device according to one of embodiments 79 to 86, wherein the deformation transmission element (102) is connected to the holding arm (30) in a manner free of relative movement and thus rigidly at at least two securing regions (104, 106, 108), and in that at least one of the deformation sensors (172, 174, 176, 178) is arranged between the securing regions (104, 106, 108) of the deformation element (102).

88. The device according to one of embodiments 79 to 87, wherein the deformation transmission element (102) is connected to the holding arm (30) by at least three securing regions (104, 106, 108), and in that at least one of the deformation sensors (172, 174, 176, 178) is arranged respectively between two of the securing regions (104, 106, 108).

89. The device according to one of embodiments 79 to 88, wherein the deformation transmission element (102) is connected to the holding arm (30) in the securing regions (104, 106, 108) using connection elements (114, 116, 118).

90. The device according to embodiment 89, wherein the connection elements (114, 116, 118) are connected on the one hand rigidly to the holding arm (30) and on the other rigidly to the securing regions (104, 106, 108) of the deformation transmission element (102).

91. The device according to embodiment 90, wherein the connection elements (114, 116, 118) are integrally formed on the holding arm (30).

92. The device according to one of embodiments 79 to 91, wherein the connection elements (114, 116, 118) transmit deformations of the holding arm (30) in deformation regions (82, 84) of the holding arm (30) that respectively lie between the connection elements (114, 116, 118) to the securing regions (104, 106, 108) of the deformation transmission element (102).

93. The device according to one of embodiments 89 to 92, wherein a deformation region (82, 84) of the holding arm (30) lies in each case between two connection elements (114, 116, 118).

94. The device according to one of embodiments 79 to 93, wherein the holding arm (30) has at least two deformation regions (82, 84), of which deformations are transmitted to securing regions (104, 106, 108) of the deformation transmission element (102) by way of connection elements (114, 116, 118) that are arranged on either side of the respective deformation region (82, 84), wherein a deformation-affected region (152, 154, 156) of the deformation transmission element (102) lies between the securing regions (104, 106, 108).

95. The device according to embodiment 94, wherein the at least two deformation regions (82, 84) are arranged successively in a direction of extent of the holding arm (30).

96. The device according to one of embodiments 79 to 95, wherein at least one deformation sensor (172, 174, 176, 178) is arranged in one of the deformation-affected regions (152, 154, 156, 158) of the deformation transmission element (102).

97. The device according to one of embodiments 94 to 96, wherein each deformation-affected region (152, 154, 156, 158) is connected to a deformation-resistant region (144, 146, 148) of the deformation transmission element (102), and in that the securing regions (104, 106, 108) respectively lie in a deformation-resistant region (144, 146, 148).

98. The device according to embodiment 97, wherein the deformation-affected regions (152, 154, 156, 158) are respectively arranged between two deformation-resistant regions (144, 146, 148).

99. The device according to embodiment 97 or 98, wherein the deformation-resistant regions (144, 146, 148) and the deformation-affected regions (152, 154, 156, 158) are arranged successively in a deformation direction.

100. The device according to one of embodiments 94 to 99, wherein the deformation-affected regions (152, 154, 156, 158) take the form of deformation concentration regions.

101. The device according to one of embodiments 79 to 100, wherein the material of the deformation transmission element (102) outside the deformation-affected regions (152, 154, 156, 158) takes the form of deformation-resistant or deformation-insusceptible material.

102. The device according to one of embodiments 79 to 101, wherein the material of the deformation transmission element (102) in the deformation-affected regions (152, 154, 156, 158) is prone to deformation as a result of being given a shape, for example a narrowing in cross section.

103. The device according to one of embodiments 79 to 102, wherein the deformation transmission element (102) has, next to the respective deformation-affected region (152, 154, 156, 158), a deformation-free region (192, 194, 196, 198) on which at least one reference deformation sensor (182, 184, 186, 188) is arranged.

104. The device according to embodiment 103, wherein the respective deformation-free region (192, 194, 196, 198) is made from the same material as the deformation-affected region (152, 154, 156, 158).

105. The device according to embodiment 103 or 104, wherein the respective deformation-free region (192, 194, 196, 198) is connected on one side to a deformation-resistant region (144, 146, 148) of the deformation transmission element (102).

106. The device according to one of embodiments 103 to 105, wherein the deformation-free region (192, 194, 196, 198) of the deformation transmission element (102) is formed in the manner of a tongue.

107. The device according to one of embodiments 103 to 106, wherein the deformation-free region (192, 194, 196, 198) of the deformation transmission element (102) is made from the same material, in particular with the same material thickness, as the deformation-affected region (152, 154, 156, 158).

108. The device according to one of embodiments 103 to 107, wherein the reference deformation sensors (182, 184, 186, 188) are thermally coupled to the deformation transmission element (102).

109. The device according to embodiment 108, wherein the reference deformation sensors (182, 184, 186, 188) are thermally coupled to the deformation sensors (172, 174, 176, 178) by way of the deformation transmission element (102).

110. The device according to embodiment 109, wherein, for the purpose of optimum thermal coupling, between the respective deformation sensor (172, 174, 176, 178) and the reference deformation sensor (182, 184, 186, 188) associated therewith, each deformation-affected region (152, 154, 156, 158) that is provided with a deformation sensor (172, 174, 176, 178) is thermally coupled to the deformation-free region (192, 194, 196, 198) associated therewith and carrying the associated reference deformation sensor (182, 184, 186, 188).

111. The device according to one of embodiments 103 to 110, wherein the deformation-free region (192, 194, 196, 198) carrying the respective reference deformation sensor (182, 184, 186, 188) has the same thermal behavior as the deformation-affected region (152, 154, 156, 158) carrying the corresponding deformation sensor (172, 174, 176, 178).

112. The device according to one of embodiments 103 to 111, wherein the respective deformation-free region (192, 194, 196, 198) carrying the reference deformation sensor (182, 184, 186, 188) has a geometric shape that is comparable with the deformation-affected region (152, 154, 156, 158) carrying the deformation sensor (172, 174, 176, 178).

113. The device according to one of embodiments 103 to 112, wherein the deformation-free region (192, 194, 196, 198) of the deformation transmission element (102) is made from the same material as the deformation-affected region (152, 154, 156, 158) of the deformation transmission element (102).

114. The device according to one of embodiments 103 to 113, wherein at least one temperature sensor (252, 254, 256, 258) is associated with the reference deformation sensors (182, 184, 186, 188) for the purpose of monitoring function.

115. The device according to one of embodiments 79 to 114, wherein the deformation transmission element (102) takes a plate-like form and each deformation-affected region (152, 154, 156, 158) carrying a deformation sensor (172, 174, 176, 178) is formed by a narrowing in cross section of the deformation transmission element (102).

116. The device according to embodiment 115, wherein the narrowing in cross section of the deformation transmission element (102) is formed by a narrowing of a surface extent of the deformation transmission element (102).

117. The device according to one of embodiments 79 to 116, wherein the deformation sensors and the reference deformation sensors take the form of extension sensors, in particular strain gages.

118. The device according to one of embodiments 79 to 117, wherein the deformation sensors and the reference deformation sensors take the form of magnetostrictive or optical sensors.

119. The device according to the preamble of embodiment 40 or according to one of embodiments 40 to 118, wherein the holding arm (30) has, between the first end (32) and the second end (34), a first deformation region (82) and a second deformation region (84) which, when there is a force (Fx) acting in the longitudinal center plane (18) of the holding arm (30) parallel to the direction of travel (24), each undergo deformations that differ from the deformations when there is a force (F_{z}) acting in the longitudinal center plane (18) and transversely to the direction of travel (24).

120. The device according to embodiment 119, wherein, when there is a force (F_{y}) acting transversely, in particular perpendicular, to the longitudinal center plane (18), the first and the second deformation region (82, 84) each undergo deformations that differ from the deformations when there is a force Fₓ, F2) acting in the longitudinal center plane (18) parallel and/or transversely to the direction of travel (24).

121. The device according to embodiment 119 or 120, wherein the first and the second deformation region (82, 84) are arranged successively, as seen in a direction of extent of the holding arm (30).

122. The device according to one of embodiments 40 to 121, wherein each deformation sensor (172, 174, 176, 178) is connected up to the associated reference deformation sensor (182, 184, 186, 188) in a Wheatstone bridge (212, 214, 216, 218).

123. The device according to one of embodiments 40 to 122, wherein the evaluation unit (230) has a processor (234) which converts the values corresponding to the deformations in the deformation-affected regions (152, 154, 156, 158), using transformation values that are determined by calibration and stored in a memory (236), into the corresponding values (WF_{X}, WF_{Y}, WF_{Z}) of forces (Fₓ, F_{y}, F_{z}) acting three spatial directions running transversely, in particular perpendicular, to one another and on the coupling element (40).

124. The device according to one of embodiments 40 to 122, wherein two of the forces (Fₓ, F_{z}) run parallel to and in particular in the longitudinal center plane (18) of the holding arm (30) but transversely, in particular perpendicular, to one another, and in that the third force (F_{y}) runs transversely, in particular perpendicular, to the longitudinal center plane (18) of the holding arm (30).

125. The device according to embodiment 123 or 124, wherein transformation values for combinations of forces acting on the coupling element (40) in different octants are stored in the memory (236).

126. The device according to one of embodiments 40 to 125, wherein the evaluation unit (230) detects values of deformation sensors (172, 174, 176, 178) and in particular reference deformation sensors (182, 184, 186, 188) for the purpose of determining deformations.

127. The device according to embodiment 126, wherein the evaluation unit (230) detects values of at least one temperature sensor (252, 254, 256, 258) for the function check of the reference deformation sensors (182, 184, 186, 188).

128. The device according to embodiment 127, wherein the evaluation unit (230) detects values of respectively one temperature sensor associated with the respective reference deformation sensor.

129. The device according to one of embodiments 40 to 128, wherein the holding arm (30) carries the coupling element (40) at its second end (34).

130. The device according to embodiment 129, wherein the holding arm (30) and the coupling element (40) form a cohesive part.

131. The device according to embodiment 129 or 130, wherein the holding arm (30) takes the form of a ball neck and carries the coupling element (40), which comprises a coupling ball (43), at the second end (34).

132. The device according to one of embodiments 40 to 131, wherein the holding arm (30′) comprises a receiving body (31′) that is formed for detachably receiving the coupling element (40′).

133. The device according to embodiment 132, wherein the receiving body (31′) has an insertion receptacle (33′) that is accessible through an insertion opening (35′).

134. The device according to embodiment 132 or 133, wherein the coupling element (40′) comprises a carrier arm (42′).

135. The device according to one of embodiments 132 to 134, wherein the carrier arm (42′) is configured to be inserted into the insertion receptacle (33′) and fixed therein with an insertion portion (45′).

136. The device according to one of embodiments 132 to 135, wherein the carrier arm (42′) carries a coupling ball (43).

137. The device according to embodiment 135 or 136, wherein the insertion portion (45′) is received in the insertion receptacle (33′) transversely, in an insertion direction (E), with positive engagement and in the functional condition is fixed in the insertion direction by a positive-engagement body (41).

138. The device according to the preamble of embodiment 40 or according to one of embodiments 40 to 137, wherein the holding arm (30) is provided with at least three deformation sensors (172, 174, 176, 178) which respond in particular in different ways to three forces acting on the coupling element (40) in spatial directions that run transversely to one another, and in that the at least three deformation sensors (172, 174, 176, 178) deliver sensor values (M) from which at least one force component acting on the coupling element (40) is determined using an evaluation unit (270).

139. The device according to one of embodiments 40 to 138, wherein the (230) determines at least one of the values (WFₓ, WF_{y}, WF_{z}) of its force component running in the evaluation unit spatial directions (x, y, z).

140. The device according to one of embodiments 40 to 139, wherein the evaluation unit (270) determines the value (WF_{z}) of its force component running in the direction of gravity (Z).

141. The device according to one of embodiments 40 to 140, wherein the evaluation unit (230) determines the value (Fₓ) of its force component running in the direction of travel of the motor vehicle (10).

142. The device according to one of embodiments 40 to 141, wherein the evaluation unit (230) determines the value (F_{y}) of its force component running transversely, in particular perpendicular, to a vertical longitudinal center plane (18).

Further features and advantages of the solution according to the invention form the subject matter of the description below and the representation in the drawing of some exemplary embodiments.

### BRIEF DESCRIPTION OF THE DRAWINGS

FIG. 1 shows a side view of a motor vehicle body, partly cut away to the rear, according to a first exemplary embodiment of a device according to the invention for coupling a trailer;

FIG. 2 shows a rear view of the motor vehicle body as seen in the direction of the arrow X in FIG. 1;

FIG. 3 is an illustration of the first exemplary embodiment of the device for coupling a trailer or a load carrier unit, in its working position, corresponding to FIG. 2;

FIG. 4 is an illustration of the first exemplary embodiment of the device for coupling a trailer or a load carrier unit, in a rest position R;

FIG. 5 shows a side view of the holding arm of the first exemplary embodiment, illustrating the load on the coupling element having a force Fₓ;

FIG. 6 shows a plan view of the holding arm as seen in the direction of the arrow D in FIG. 5;

FIG. 7 shows a side view of the holding arm under the action of a force F_{z};

FIG. 8 shows a plan view of the holding arm corresponding to FIG. 6, under the action of the force F_{z};

FIG. 9 shows a side view of a holding arm under the action of a force F_{y};

FIG. 10 shows a plan view similar to FIG. 6, under the action of the force F_{y};

FIG. 11 shows a section along the line 11-11 in FIG. 5;

FIG. 12 shows an enlarged plan view of the holding arm with the deformation transmission element under the action of the force Fₓ according to FIGS. 5 and 6;

FIG. 13 shows a plan view corresponding to FIG. 12, under the action of the force F_{z} according to FIGS. 7 and 8;

FIG. 14 shows a plan view similar to FIG. 12, under the action of a force F_{y} corresponding to FIGS. 9 and 10;

FIG. 15 shows an enlarged plan view of the deformation transmission element according to a first exemplary embodiment, with the deformation sensors and reference deformation sensors arranged thereon;

FIG. 16 is an illustration of a Wheatstone bridge for connecting up a first deformation sensor and a first reference deformation sensor;

FIG. 17 is an illustration of the Wheatstone bridge corresponding to FIG. 16, for connecting up a second deformation sensor and a second reference deformation sensor;

FIG. 18 is an illustration of a Wheatstone bridge corresponding to FIG. 16, for connecting up a third deformation sensor and a third reference deformation sensor;

FIG. 19 is an illustration of a Wheatstone bridge corresponding to FIG. 16, for connecting up a fourth deformation sensor and a fourth reference deformation sensor;

FIG. 20 is an illustration of an evaluation circuit for processing the voltages measured in the Wheatstone bridges according to FIG. 16 to FIG. 19;

FIG. 21 is an illustration of a coupling element 40 and the forces acting on the coupling element 40, which are determined by the evaluation circuit;

FIG. 22 is an illustration of a side view of the first exemplary embodiment, illustrating a circuit board carrying the evaluation circuit;

FIG. 23 is an illustration of a unit comprising the circuit board carrying the evaluation circuit and the deformation transmission element with deformation sensors and reference deformation sensors, in side view;

FIG. 24 is an illustration of a second exemplary embodiment of a device according to the invention in a reversed arrangement of the unit comprising the deformation transmission element, the extension sensors, the reference extension sensors, and the evaluation unit;

FIG. 25 is an illustration of a third exemplary embodiment of a device according to the invention similar to FIG. 23, illustrating the additional temperature sensors arranged on the circuit board;

FIG. 26 is an illustration of a fourth exemplary embodiment of a device according to the invention, illustrating the deformation transmission element and additional temperature sensors arranged on this;

FIG. 27 is an illustration of the evaluation unit according to the third or fourth exemplary embodiment, similar to FIG. 20;

FIG. 28 shows a side view, similar to FIG. 1, of a fifth exemplary embodiment of a device according to the invention;

FIG. 29 is a perspective illustration of the fifth exemplary embodiment of the device according to the invention, in the working position;

FIG. 30 shows a view of the fifth exemplary embodiment as seen in the direction of the arrow X′ in FIG. 28, in the working position;

FIG. 31 shows a section along the line 31-31 in FIG. 30;

FIG. 32 shows a section along the line 32-32 in FIG. 30;

FIG. 33 shows a section, similar to FIG. 31, of the exemplary embodiment in the rest position;

FIG. 34 is a perspective illustration of the fifth exemplary embodiment in the rest position, as seen in the direction of the arrow Y′ in FIG. 33;

FIG. 35 shows a side view of the holding arm of the fifth exemplary embodiment, illustrating the load on the coupling element having a force Fₓ;

FIG. 36 shows a plan view of the holding arm as seen in the direction of the arrow D′ in FIG. 35;

FIG. 37 shows a side view of the holding arm of the fifth exemplary embodiment under the action of a force F_{z};

FIG. 38 shows a plan view of the holding arm corresponding to FIG. 36, under the action of the force F_{z};

FIG. 39 shows a side view of a holding arm of the fifth exemplary embodiment under the action of a force F_{y};

FIG. 40 shows a plan view, similar to FIG. 36, under the action of the force F_{y};

FIG. 41 is an illustration of a first possibility of a mathematical relationship between the values of the force components and the sensor values;

FIG. 42 is a schematic illustration of the procedure when calibrating a holding arm;

FIG. 43 is an illustration of a second possibility of a mathematical relationship between the values of the force components and the sensor values;

FIG. 44 is an illustration of calibration on the basis of force components in octants, with the coupling element as the center point;

FIG. 45 is a schematic illustration of an evaluation unit and its cooperation with further components;

FIG. 46 is an exemplary illustration of a motor vehicle having a trailer;

FIG. 47 is an illustration of a motor vehicle having a bicycle carrier;

FIG. 48 is an illustration of deformation values measured in the case of a trailer, with in each case two deformation sensors, arranged on opposite sides of a longitudinal center plane, for each deformation region;

FIG. 49 is an illustration of deformation values measured in the case of a bicycle carrier, with in each case two deformation sensors, arranged on opposite sides of a longitudinal center plane, for each deformation region;

FIG. 50 is an illustration of mean deformation values measured in the case of a trailer, for each deformation region;

FIG. 51 is an illustration of mean deformation values measured in the case of a bicycle carrier, for each deformation region;

FIG. 52 is an illustration of deformation values detected with time resolution with in each case two deformation sensors, arranged on opposite sides of a longitudinal center plane, for each deformation region, in the case of a pulse-like action of the trailer; and

FIG. 53 is an illustration of deformation values detected with time resolution with in each case two deformation sensors, arranged on opposite sides of a longitudinal center plane, for each deformation region, in the case of a side-to-side swinging movement of the trailer.

### DETAILED DESCRIPTION OF THE INVENTION

A motor vehicle, designated 10 as a whole, comprises a motor vehicle body 12, which in a rear region 14, close to a vehicle floor 16, is provided with a carrier unit 20 that has for example a transverse carrier 22 connected to the rear region 14 close to the vehicle floor 16.

The connection between the transverse carrier 22 and the rear region 14 may be made for example by way of mounting flanges abutting against the rear region 14, or for example by side carriers 26 that extend in a vehicle longitudinal direction 24 and abut against vehicle body portions 28 likewise extending in the vehicle longitudinal direction 24.

A holding arm, in particular a ball neck, that is designated 30 as a whole is connected to the carrier unit 20 such that a first end 32 of the holding arm 30 is held on the carrier unit 20, preferably the transverse carrier 22, either directly or by way of a bearing unit 36.

At a second, opposite end 34 to the first end 32, the holding arm 30 carries a coupling element 40 that is provided for example for the purpose of hitching a trailer or for fixing a load carrier unit.

For example, a coupling element 40 of this kind takes the form of a coupling ball 43 that enables a widely used connection to a coupling head of a trailer.

However, the coupling ball 43 also enables simple mounting of a load carrier unit, since widely used load carrier units likewise take a form such that they are mountable on a coupling ball and where applicable additionally supportable on the holding arm 30.

The coupling element 40 is seated for example on a carrier 42 that is connected to the second end region 34 of the holding arm 30 and extends from a side of the carrier 42 remote from a road 44 in the direction of a center axis 46, which extends approximately vertically if the road 44 is horizontal, and in the case of the coupling ball 43 runs through a ball center point 48.

For the purpose of improving the esthetic effect, preferably the transverse carrier 22 is arranged below a rear bumper unit 50 of the motor vehicle body 12, wherein the bumper unit 50 covers for example the transverse carrier 22 and the first end 32 of the holding arm 30.

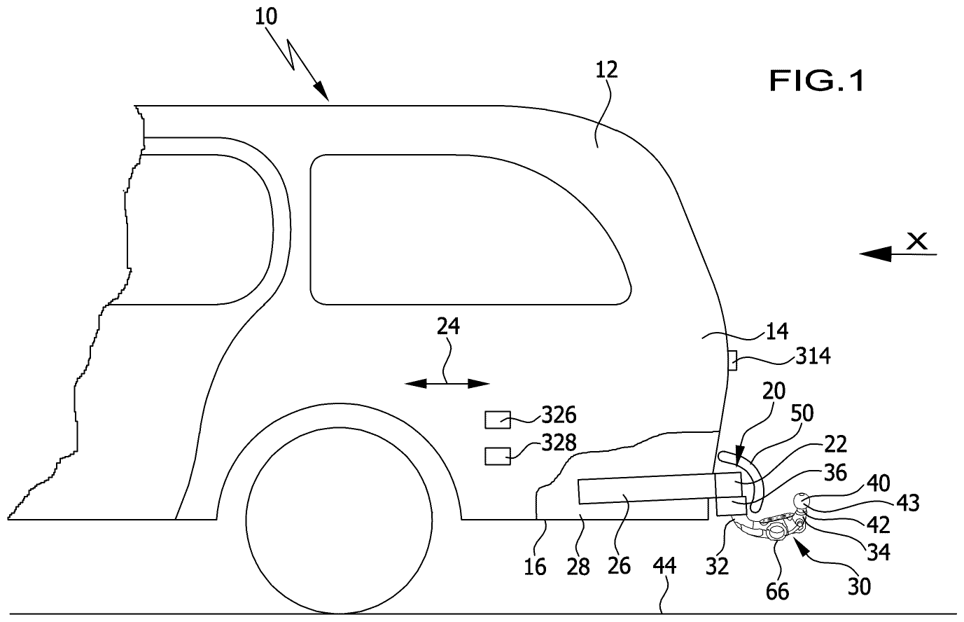

The holding arm 30 carries, in particular in the case of the illustrated exemplary embodiment, the coupling element 40 that takes the form of a coupling ball, wherein, as illustrated in particular in FIGS. 1 to 3, the holding arm 30 extends from the pivot bearing unit 36 to which the holding arm 30 is connected at its first end region 32, wherein a pivot bearing body 52 of the pivot bearing unit 36 is integrally formed for example on the first end region 32.

The pivot bearing body 52 of the pivot bearing unit 36 is mounted, such that it is pivotal about a pivot axis 54 that runs in particular obliquely to a vertical vehicle longitudinal center plane 18, on a pivot bearing receptacle 56 that on the one hand guides the pivot bearing body 52 such that it is rotatable about the pivot axis 54 and on the other comprises a locking unit (not illustrated in the drawing) that enables the holding arm 30 to be immobilized in the working position and the rest position to prevent rotation, such that it cannot perform pivotal movements about the pivot axis 54.

The pivot bearing receptacle 56 is in that case for its part firmly connected to the transverse carrier 22 by way of a pivot bearing base 58.

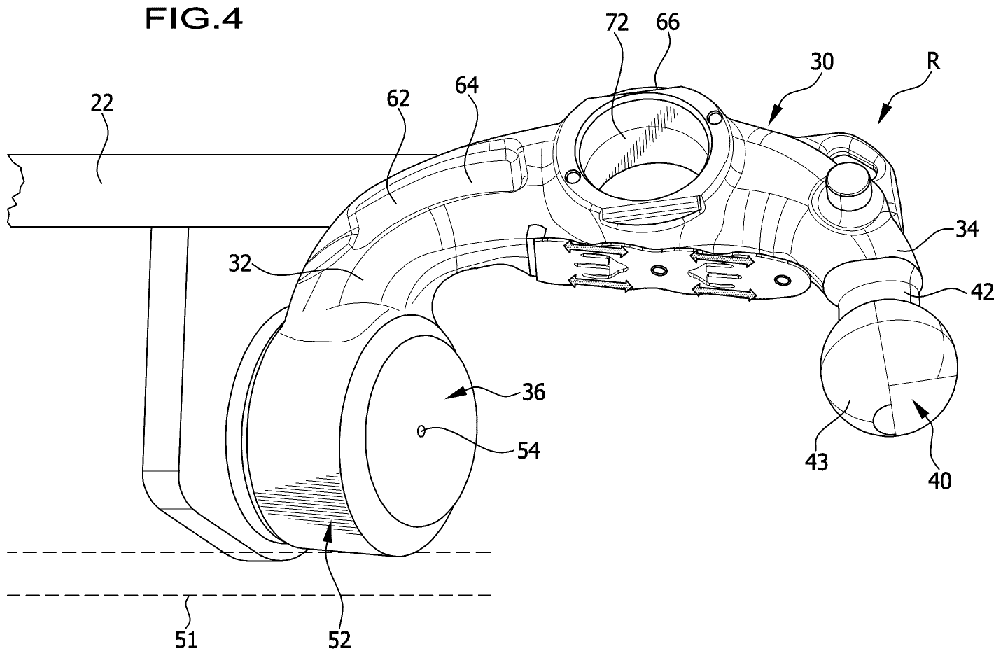

As illustrated in FIGS. 1 to 4, in this exemplary embodiment the holding arm 30 is pivotal from a working position A illustrated in FIGS. 1 to 3, in which the coupling element taking the form of a coupling ball 40 is upright such that it stands behind the bumper unit 50 on a side remote from a road 44, into a rest position R illustrated in FIG. 4, in which the coupling element 40 is arranged facing the road 44.

Here, the coupling element 40 is movable through below a lower edge 51 of the bumper unit 50.

In particular here, in the working position A the holding arm 30 extends substantially in the vertical vehicle longitudinal center plane 18, wherein this vehicle longitudinal center plane 18 intersects the coupling element 40 centrally in cases where this takes the form of a coupling ball, such that in the working position A a vertical ball center axis 48 lies in the longitudinal center plane 18.

In the illustrated exemplary embodiment, from the first end region 32 the holding arm 30 extends with a first arcuate piece 62 as far as an intermediate piece 64, which extends as far as an annular body 66 that on an opposite side to the intermediate piece 64 and the arcuate piece 62 is adjoined by a second arcuate piece 68 which for its part carries the coupling element 40 taking the form of a coupling ball, wherein the ball attachment 42 is moreover provided between the coupling element 40 taking the form of a coupling ball and the second arcuate piece 68.

The second arcuate piece 68 then forms the end region 34 of the holding arm 30, which then carries for example the ball attachment 42 that is adjoined by the coupling element 40 taking the form of a coupling ball.

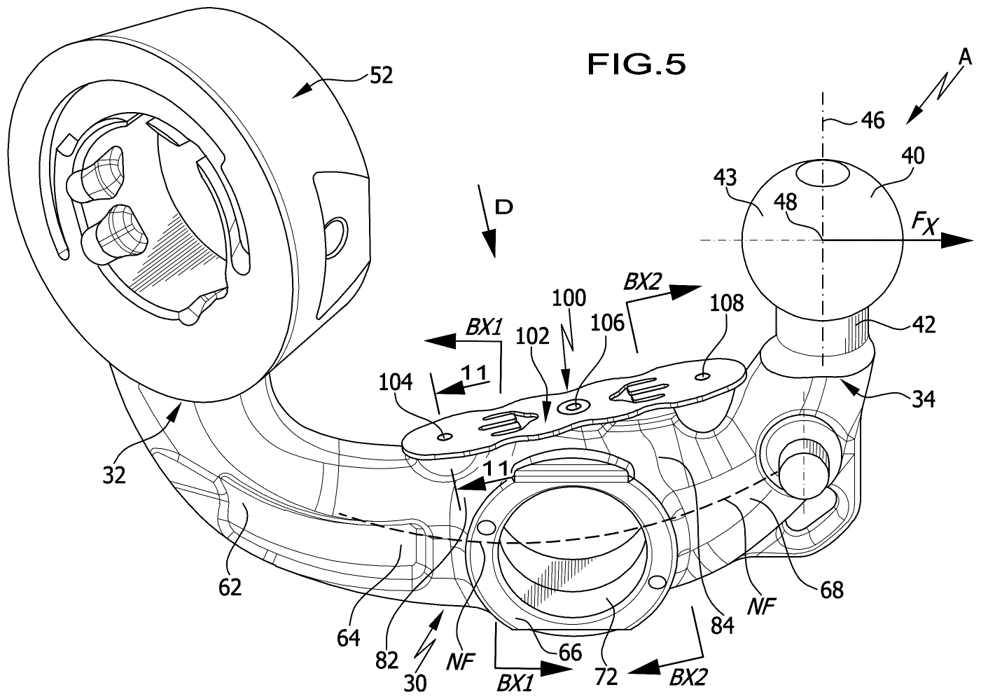

As illustrated in particular in FIGS. 4 and 5, for easy mounting of a contact unit on the holding arm 30, arranged adjoining the intermediate piece 64 is the annular body 66, which surrounds an aperture 72 in which a contact unit is mountable.

Preferably in this case, the annular body 66 is arranged such that adjoining the annular body 66 is a transition to the second arcuate piece 68.

As a result of the first arcuate piece 62, the intermediate piece 64 and the second arcuate piece 68, a holding arm 30 taking this form is approximately U-shaped in form, and in the working position A, in which loads on the coupling element 40 arise and are to be detected, it is configured such that the forces acting on the coupling element 40, in particular the ball center point 46, are transmitted through the approximately U-shaped form taken by the holding arm 30 to the pivot bearing body 52 of the pivot bearing unit 36, wherein the pivot axis 54 forms a center point of the take-up of force through the pivot bearing unit 36.

As illustrated in FIGS. 1 to 8, the forces acting on the coupling element 40 are transmitted through the holding arm 30 to the bearing unit 36 and from there to the carrier unit 20, which then introduces these forces into the rear region 14 of the motor vehicle body 12, wherein for the purpose of detecting the forces acting on the coupling element 40 different regions of the holding arm 30 are made use of.

In the exemplary embodiment described above, by way of example a first deformation region 82 of the holding arm 30 is made use of, comprising a portion of the intermediate piece 64 and the annular body 66, and a second deformation region of the holding arm 30 is made use of, comprising a portion of the annular body 66 and the second arcuate piece 68.

Further, in this exemplary embodiment the assumption is made that the annular region 66 has a high level of stability in relation to bending forces running in the longitudinal center plane 18 and also transversely thereto, and in particular is also sufficiently rigid in relation to tensile loads.

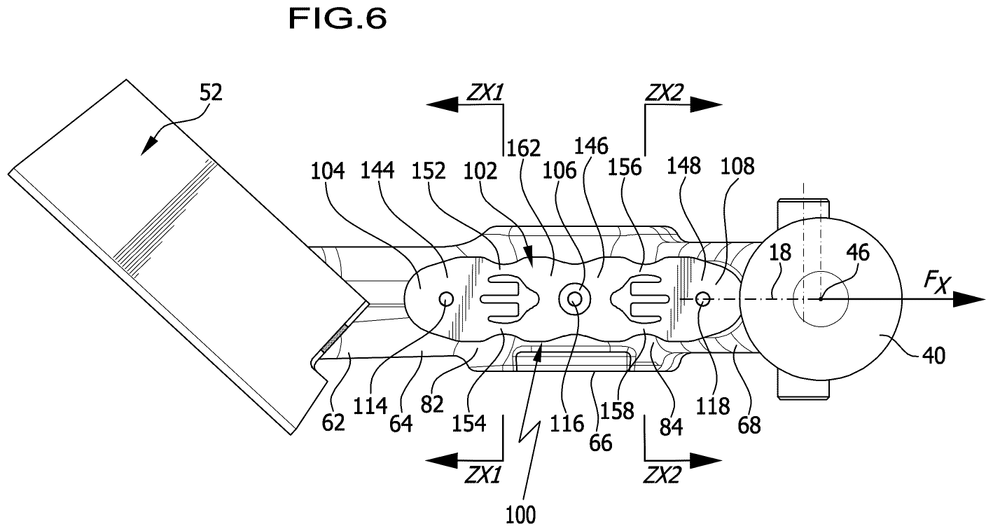

Thus, for example, the force Fₓ that is illustrated in FIGS. 5 and 6, which runs in the longitudinal center plane 18 in particular in the vehicle longitudinal direction and is directed for example perpendicular to the center axis 46 and away from the pivot bearing body 52, results on the one hand in tensile forces ZX1 and ZX2 (FIG. 6) occurring in the deformation regions 82 and 84, and/or also in bending forces BX1 and BX2 (FIG. 5), which may also be superimposed, wherein these forces act in the direction of the longitudinal center plane 18, and in particular in the longitudinal center plane 18, of the holding arm 30.

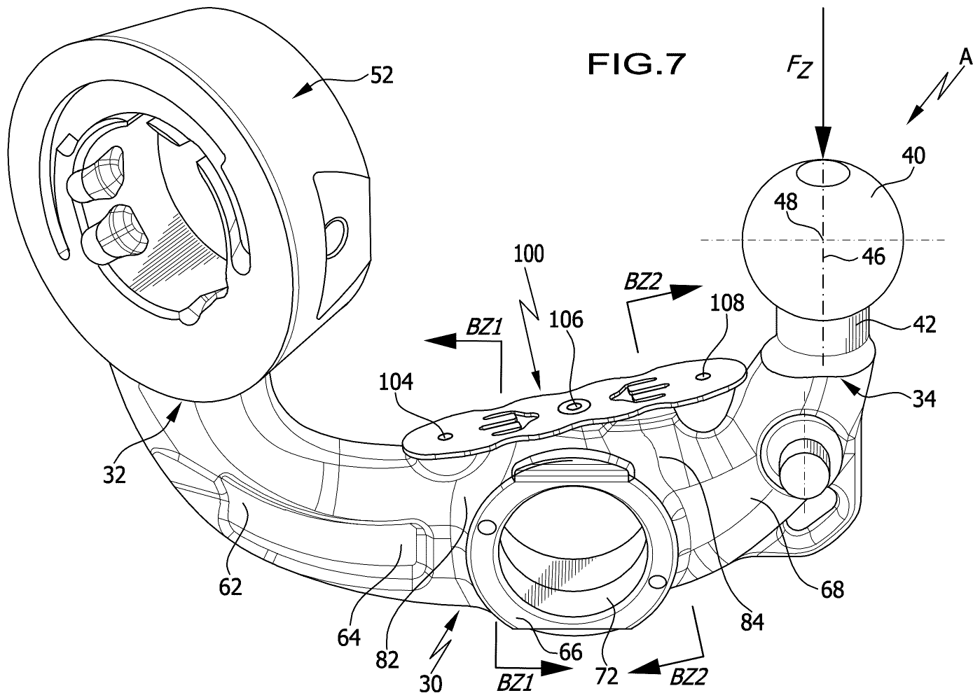

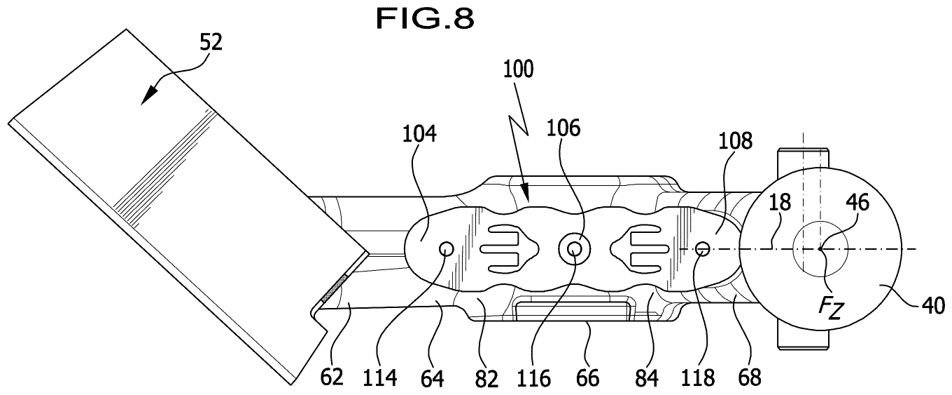

Further, there arise in the deformation regions 82 and 84, as illustrated in FIGS. 7 and 8, in the event of a load on the coupling element 40 by a force F_{z} acting in the vertical direction, in particular in the direction of gravity, which in the case of a vehicle on an approximately horizontal plane also acts for example in the direction of the center axis 46, there arise in the deformation regions 82 and 84 substantially bending forces BZ1 and BZ2, wherein these forces act in a direction parallel to the longitudinal center plane 18, in particular in the longitudinal center plane 18, of the holding arm 30, and thus in relation to a so-called neutral axis NF of invariable length exert mutually opposed actions on mutually opposing sides.

Preferably, the deformation regions 82 and 84 are arranged on the holding arm 30 and/or the holding arm 30 is formed in the deformation regions 82, 84 such that different amounts of deformation arise in the holding arm 30 in the event of a force F_{z} acting in the direction of gravity or in opposition thereto.

It is particularly favorable—as explained in detail below—if the force F_{z} acting in the vertical direction generates significantly less deformation in the deformation region 84 than in the deformation region 82, and if, with a combined force of approximately equally sized force components Fₓ+F_{z}, the deformations in both deformation regions 82 and 84 are of approximately similar size.

For this reason, the deformation region 82 has high sensitivity to tongue weight, and the deformation region 84 has little sensitivity to tongue weight.

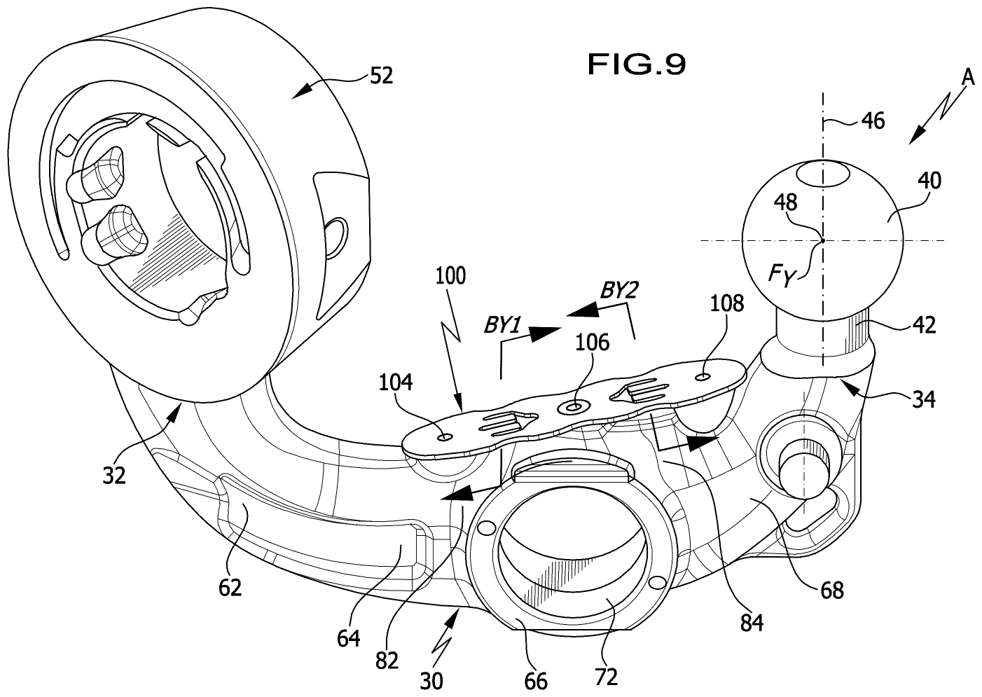

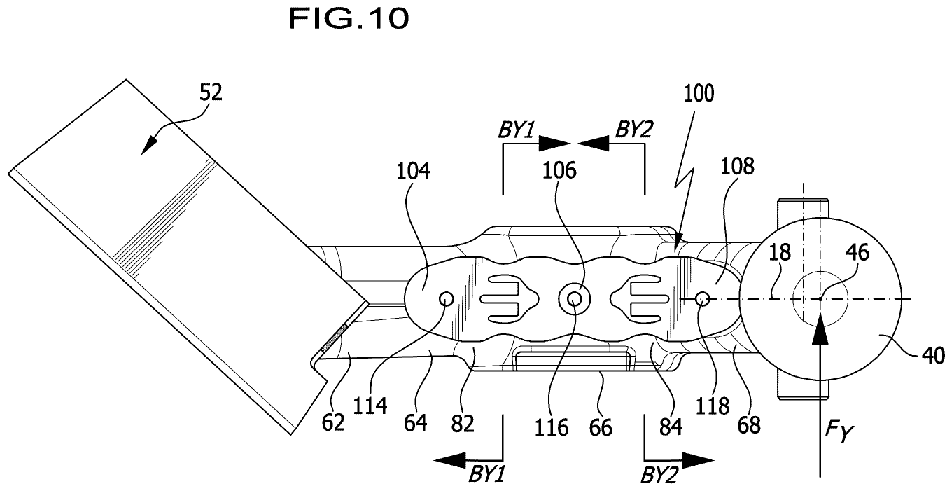

Moreover, as illustrated in FIGS. 9 and 10, a force F_{y} that acts on the coupling element 40 and is directed perpendicular to the longitudinal center plane 18 and perpendicular to the center axis 46 results in bending forces BY1 and BY2 acting on either side of the longitudinal center plane 18 but on different sides thereof, in opposition to one another.

For the purpose of detecting these tensile forces ZX1 and ZX2 and bending forces BX1 and BX2, BZ1 and BZ2, and BY1 and BY2, a force detection module that is designated 100 as a whole is arranged on the holding arm 30.

This force detection module 100 comprises a deformation transmission element 102, which is rigidly connected to the holding arm 30 at three securing regions 104, 106 and 108, wherein the securing region 104 lies on a side facing the first end 32 and is rigidly connected to an attachment 114 of the holding arm 30 seated for example on the center piece 64, the securing region 106 is arranged approximately centrally between the securing regions 104 and 108 and is connected for example to a holding attachment 116 seated on the annular body 66, in particular seated centrally thereon, and the securing region 108 is connected to an attachment 118 of the holding arm 30 that is arranged on the arcuate piece 68, for example arranged in a central region of the arcuate piece 68 between the annular body 66 and the end 34.

Here, the respective connection elements 114, 116 and 118 of the holding arm 30 are connected rigidly and without play, preferably by a weld or adhesion that does not permit any resilience of movement between the deformation transmission element 102 and the connection elements 114, 116 and 118.

Preferably, the connection elements 114, 116 and 118 are likewise rigidly connected to the holding arm, in particular integrally formed thereon.

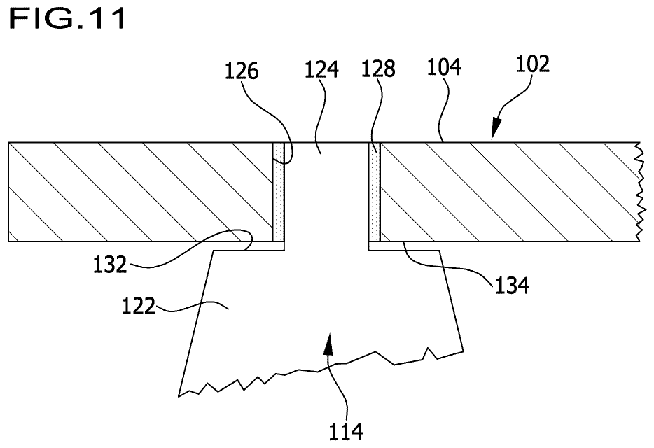

Preferably, as illustrated by way of example in FIG. 11 using the example of the attachment 114, the connection elements 114, 116 and 118 of the holding arm 30 take a form such that they have a foot region 122, which extends from the holding arm 30 and forms a fixing pin 124 that passes through an aperture 126 arranged in the respective securing region, in this case the securing region 104 of the deformation transmission element 102.

Preferably, the shape of the fixing pin 124 and the aperture 126 are adapted such that they are rigidly connectable to one another by a weld seam 128.

Moreover, preferably the foot region 122 takes a form such that it has a shoulder 132 which runs peripherally around the fixing pin 124, and on which the deformation transmission element 102 abuts with a contact surface 134 of the securing region 104 surrounding the aperture 126 and is thus supported for example when the weld seam 128 is applied.

Further, the deformation transmission element 102 takes a form such that it has deformation-resistant regions 144, 146 and 148 which in particular also comprise the securing region 104, and such that deformation-affected regions 152, 154, 156, 158 are respectively arranged between the deformation-resistant regions 144, 146, 148, wherein for example the deformation-affected regions 152 and 154 are located between the deformation-resistant regions 144 and 146 and are preferably arranged at the same spacing from the longitudinal center plane 18 but on opposite sides, and the deformation-affected regions 156 and 158 are located between the deformation-resistant regions 146 and 148 and are likewise arranged on respectively opposite sides of the longitudinal center plane 18 but preferably at the same spacing therefrom.

Preferably here, the deformation-affected regions 152 to 158 take the form of deformation concentration regions, that is to say that in these deformation concentration regions 152, 154, 156, 158 a deformation acting on the deformation transmission element 102 acts substantially more forcefully than in the deformation-resistant regions 144, 146 and 148.

In the simplest case, a deformation concentration region of this kind can be formed in that the material in the deformation concentration regions 152 to 158 has less rigidity than in the deformation-resistant regions 144, 146 and 148.

A variation in rigidity of this kind may be achieved for example as a result of a change in the material in the region of the deformation concentration regions 152, 154, 156, 158, or indeed as a result of a change in the effective material cross section.

In the exemplary embodiments illustrated in FIGS. 6, 8 and 10, the deformation concentration regions 152, 154, 156 and 158 take the form of narrow webs of a plate 162 forming the deformation transmission element 102, whereas the deformation-resistant regions 144, 146 and 148 are formed by broad regions of the plate 162.

In summary, a formation of this kind for the deformation transmission element 102 has the consequence that a deformation of the deformation region 82 of the holding arm 30 results in a relative movement of the connection elements 114 and 116 that are rigidly connected to the holding arm 30, which are transmitted to the securing regions 104 and 106 and from there to the deformation-resistant regions 144 and 146 of the deformation transmission element 102, wherein the deformation-resistant regions 144 and 146 of the deformation transmission element 102 undergo substantially no deformation and thus transmit all of the deformations occurring in the deformation region 82 to the deformation-affected regions 152 and 154, which because they also take the form of deformation concentration regions undergo all of the deformation occurring between the connection elements 114 and 116 in the deformation region 82, in a concentrated manner.

This means that the deformation concentration regions 152 and 154 undergo not only deformations resulting from the bending forces BX1 active in the longitudinal center plane 18 but also deformations resulting from the tensile forces ZX1 and also deformations resulting from the forces BZ1 and BZ2, wherein, because these deformations are all based on forces acting substantially in the longitudinal center plane 18, if the holding arm 30 is formed symmetrically relative to the longitudinal center plane 18, the two deformation concentration regions 152 and 154 undergo approximately the same deformation.

The case is different with the bending forces BY1 illustrated in FIGS. 9 and 10, which act on different sides of the longitudinal center plane 18 and in different directions, such that for example starting from the bending forces BY1 illustrated in FIGS. 9 and 10 the deformation concentration region 152 undergoes a deformation based on compressive loading, whereas the deformation concentration region 154 undergoes a deformation based on tensile loading.

Analogously, deformations of the deformation region 84 of the holding arm are transmitted through the connection elements 116 and 118 to the securing regions 106 and 108, which are part of the deformation-resistant regions 146 and 148 and thus transmit the deformations of the deformation region 84 to the deformation-affected regions 156 and 158, which likewise take the form of deformation concentration regions and thus undergo all the deformation of the deformation region 84.

This likewise results in that the forces BX2, ZX2 and BZ2, which all act substantially in the longitudinal center plane 18, if the holding arm 30 is formed symmetrically relative to the longitudinal center plane 18, acting on the deformation concentration regions 156 and 158 in the same way, whereas the forces BY2 result in opposing deformations in the deformation regions 156 and 158, such that for example the deformation in the deformation concentration region 156 is based on compressive loading, whereas the deformation in the deformation concentration region 158 is based on tensile loading.

Because the deformation regions 82 and 84 of the holding arm undergo a different deformation when the coupling element 40 is put under load by the force Fₓ than when the coupling element 40 is put under load by the force F_{z}, the different deformation of the deformation regions 82 and 84 provides the possibility of identifying, from the different deformations occurring in the deformation concentration regions 152 and 154 or 156 and 158, whether a force Fₓ or a force F_{z} is acting on the coupling element 40, as explained in detail below.

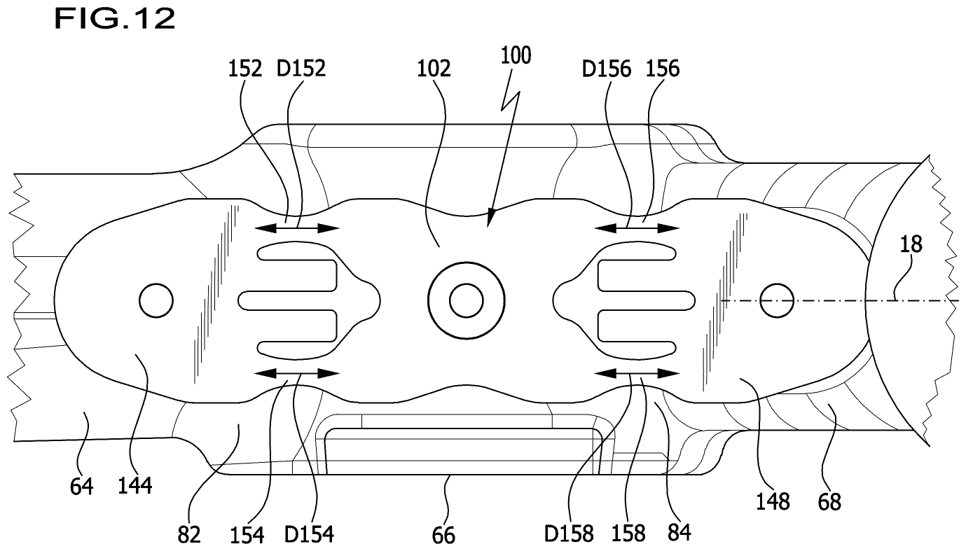

For the purpose of simplified explanation, in this regard it may for example be assumed that, as illustrated in FIG. 12, the deformation D152 in the deformation concentration region 152, the deformation D154 in the deformation concentration region 154, the deformation D156 in the deformation concentration region 156 and the deformation D158 in the deformation concentration region 158 are of substantially the same size if the deformation regions 82 and 84 behave in substantially the same way when bending forces BX1 and BX2 occur in combination with an occurrence of tensile forces ZX1 and ZX2.

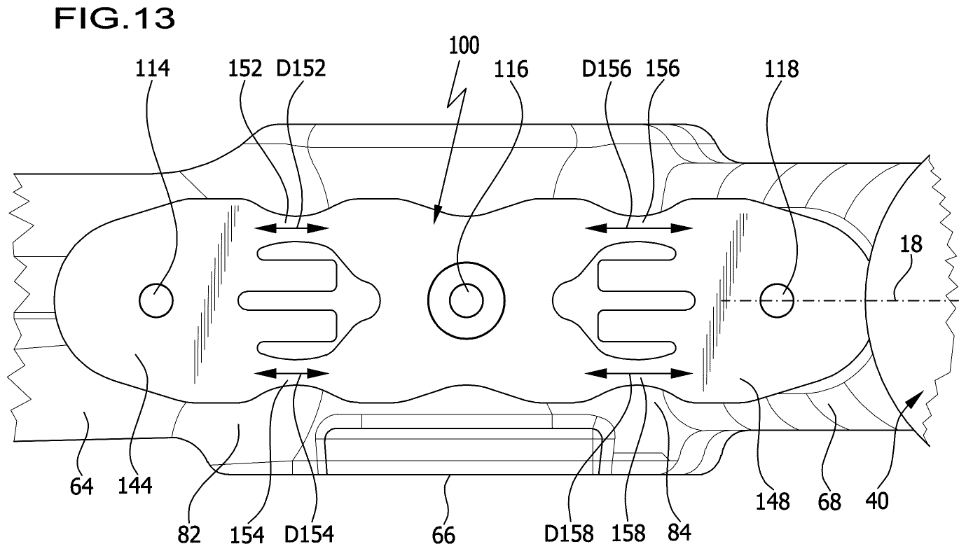

Further, the behavior of the deformations in the deformation regions 82 and 84 may change if the force F_{z} occurs such that, as illustrated by way of example in FIG. 13, the deformations D152 and D154 in the deformation concentration regions 152 and 154 may be significantly smaller than the deformations D156 and D158 in the deformation concentration regions 156 and 158.

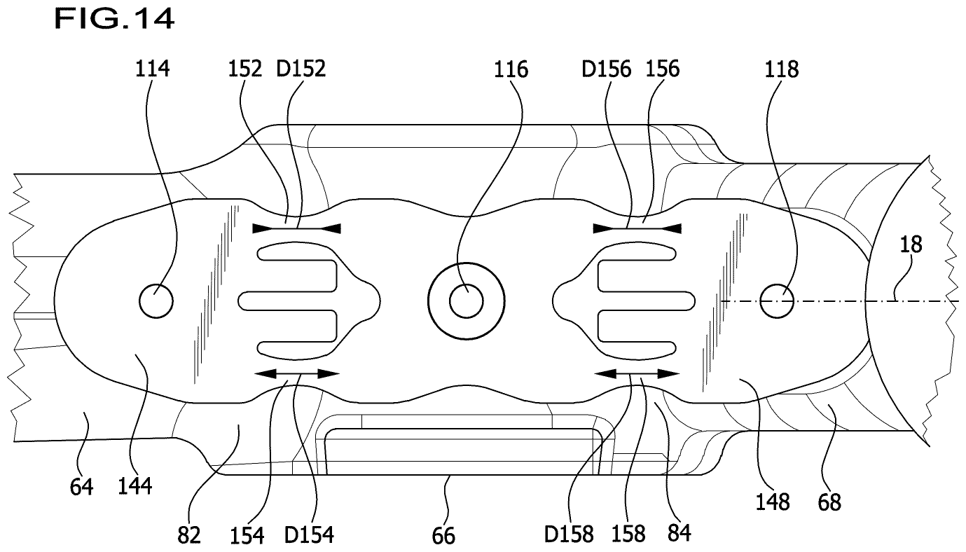

The situation is in turn different in the event of action by the force F_{y}, as illustrated in FIG. 14.

In this case, in the deformation concentration regions 152 and 156 the deformations D152 and D156 occur as a compression, whereas a respective extension occurs in the deformation concentration regions 154 and 158 as the deformations D154 and D158.

Here, the deformations D152 and D156 based on compressions may be the same or different, and in the same way the deformations D154 and D158 based on extensions may also be the same or different.

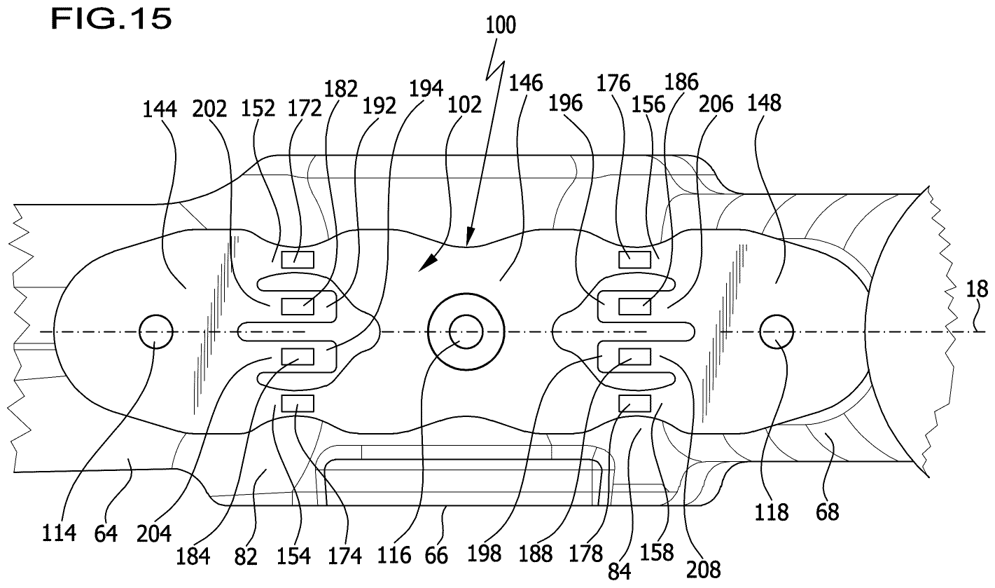

For the purpose of detecting the extensions or compressions occurring as a result of forces Fₓ and/or F_{z} and/or F_{y} in the deformation concentration regions 152, 154, 156 and 158, arranged in the deformation concentration regions 152, 154, 156 and 158 as illustrated in FIG. 15 is a respective deformation sensor 172, 174, 176 and 178, and these provide the possibility of detecting the extensions and compressions as deformations in the respective deformation concentration regions 152, 154, 156 and 158.

Since not only extensions and compressions caused by the deformation regions 82 and 84 of the holding arm 30 occur in the deformation concentration regions 152, 154, 156 and 158 but the occurrence of extensions and compressions occurring as a result of thermal expansion of the material in the deformation concentration regions 152, 154, 156 and 158 is also possible, associated with the deformation sensors 172, 174, 176 and 178 are reference deformation sensors 182, 184, 186 and 188 which are arranged on unloaded reference regions 192, 194, 196 and 198 of the deformation transmission element 102, wherein these unloaded reference regions 192, 194, 196 and 198 are preferably formed as tongues 202, 204, 206 and 208 that are arranged as close as possible to the deformation concentration regions 152, 154, 156, 158 and extend for example from the deformation-free regions 144 and 148 substantially parallel to the deformation concentration regions 152, 154, 156 and 158 but not in contact therewith or with the deformation-free region 146, wherein preferably the unloaded reference regions 192, 194, 196 and 198 have substantially the same material cross section in the region in which they carry the reference deformation sensors 182, 184, 186 and 188, with the same material cross sectional shape as the deformation concentration regions 152, 154, 156 and 158, and moreover the reference deformation sensors 182, 184, 186, 188 are preferably also identical in form to the deformation sensors 172, 174, 176 and 178.

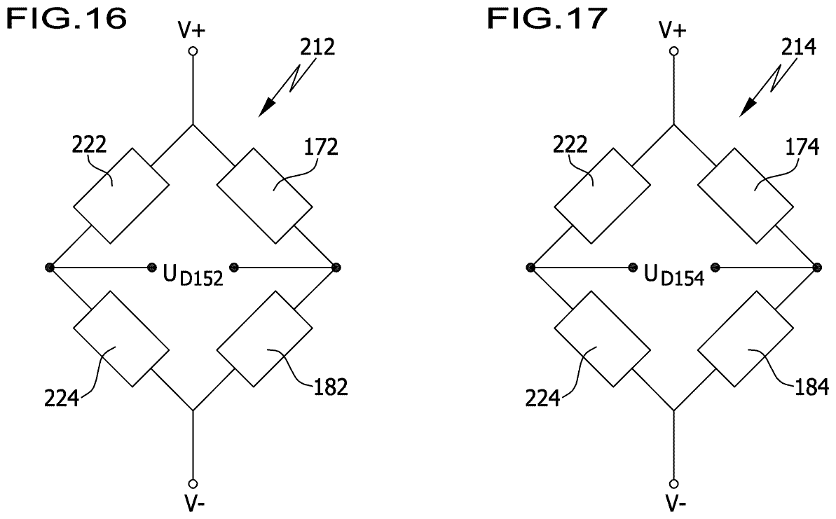

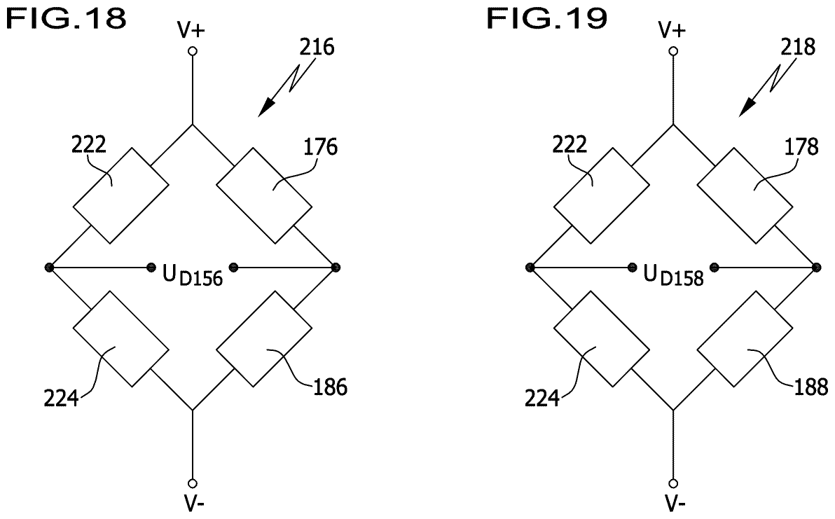

For the purpose of electronically detecting the deformations in the form of extensions and compressions in the deformation concentration regions 152, 154, 156 and 158, the deformation sensors 172, 174, 176 and 178 arranged therein are each arranged in Wheatstone bridges 212, 214, 216 and 218, wherein the respective Wheatstone bridges 212, 214, 216 and 218 are located between supply connectors V+ and V−, as illustrated in FIGS. 16 to 19.

Further, in the Wheatstone bridges 212, 214, 216, 218, the deformation sensors 172, 174, 176 and 178 are connected between the supply connectors V+ and V-in series with the reference deformation sensors 182, 184, 186 and 188 respectively associated therewith, and in order to form the Wheatstone bridges 212, 214, 216, 218 resistors 222 and 224 are connected in parallel with this series connection of the deformation sensors 172, 174, 176 and 178 and the reference deformation sensors 182, 184, 186 and 188, wherein the resistors 222 and 224 have the same fixed values.

Thus, in the respective Wheatstone bridges 212, 214, 216 and 218 it is possible, at the center taps between the deformation sensors 172, 174, 176 and 178 and the reference deformation sensors 182, 184, 186 and 188 and the center taps between the resistors 222 and 224, to tap a respective voltage U that corresponds substantially to the deformations, that is to say the extensions and compressions, occurring in the deformation concentration regions 152, 154, 156 and 158, wherein by providing the reference deformation sensors 182, 184, 186, 188 thermal effects and in particular also thermal expansions in the deformation concentration regions 152, 154, 156 and 158 are largely compensated, which is in particular possible if the reference deformation sensors 182, 184, 186 and 188 are identical sensors to the deformation sensors 172, 174, 176 and 178.

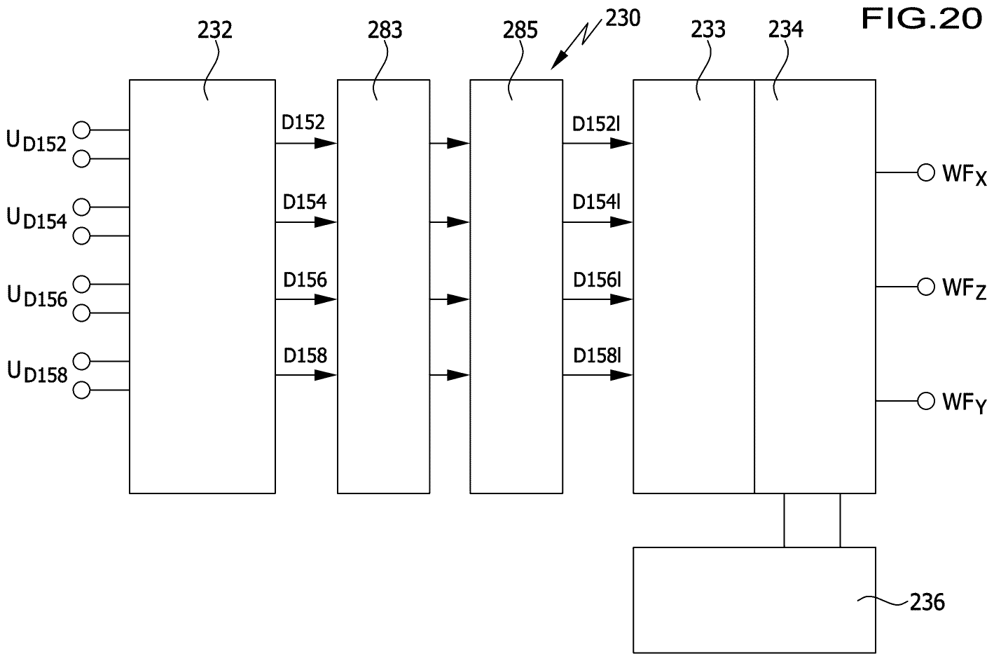

As illustrated in FIG. 20, the voltages UD152, UD154, UD156 and UD158 that are tapped in the Wheatstone bridges 212, 214, 216, 218 and which correspond to the deformations in the deformation concentration regions 152, 154, 156 and 158 are supplied to an A/D converter 232 of an evaluation unit 230 that comprises it.

From the sensor values UD152, UD154, UD156 and UD158, the A/D converter 232 determines digital deformation values D152, D154, D156, D158 which are transmitted to a load analysis stage 233 that is described in detail below.

Moreover, in particular in parallel with the load analysis stage 233, the deformation values D152, D154, D156 and D158 are transmitted to a force analysis stage 234 which, by way of program code and a processor, compares the digital deformation values D152, D154, D156 and D158 with transformation values for the deformation values D152, D154, D156 and D158 that are determined in the course of a calibration procedure and stored in a memory 236, and from these outputs, for example at corresponding outputs, values WFₓ, WF_{z} and WF_{y} that are associated with the forces Fₓ, F_{z} and F_{y}.

In the simplest case, stored in the memory 236 is a transformation matrix T that is valid for all spatial directions and by which the digital deformation values D152, D154, D156 and D158 can be converted into values WFₓ and WF_{z} and WF_{y} for the forces acting on the coupling element 40.

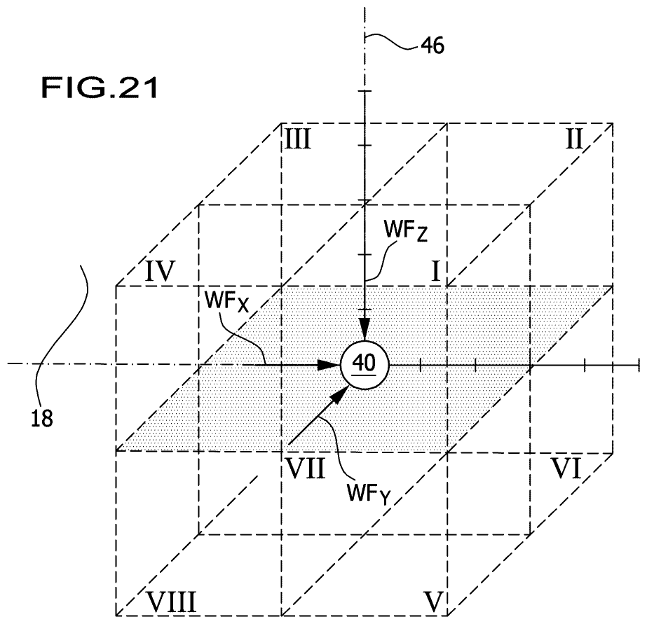

The quality of the values WFₓ, WF_{z} and WF_{y} can be improved if the calibration of paired values WFₓ, WF_{z} and WF_{y} located in each of the octants I to VIII around the coupling element 40, according to FIG. 21, is performed such that it is also possible to incorporate into the calibration non-linear correlation between the forces Fₓ, F_{z}, F_{y} acting on the coupling element 40 and the digital deformation values D152, D154, D156 and D158 and thus to incorporate transformation of these deformation values D152, D154, D156 and D158 into the values WFₓ, WF_{z} and WF_{y} for the forces acting on the coupling element 40.

As a result, the accuracy of the determined values WFₓ, WF_{z} and WF_{y} is significantly improved.

The most diverse possibilities are conceivable as regards the arrangement of the evaluation unit 230, which comprises in particular the A/D converter 232, the load analysis stage 233, the force analysis stage 234 and the memory 236.

For example, it is conceivable to arrange the evaluation unit 230 directly on the deformation transmission element 102.

However, it is particularly favorable if the evaluation unit 230 is arranged on a circuit board 240 that is coupled to the deformation transmission element 102 but arranged separately therefrom.

On this circuit board 240 there may then be arranged not only the evaluation unit 230 but also the resistors 222 and 224 of the respective Wheatstone bridges 212, 214, 216 and 218.

A particularly advantageous embodiment here provides for the deformation sensors 172, 174, 176 and 178 and the reference deformation sensors 182, 184, 186 and 188 to be arranged on one side of the deformation transmission element 102, namely a side facing the circuit board 240, whereas the evaluation unit 230, in particular with the A/D converter 232, the load analysis stage 233, the force analysis stage 234 and the memory 236, are arranged on the circuit board 240 on a side likewise facing the deformation transmission element 102.

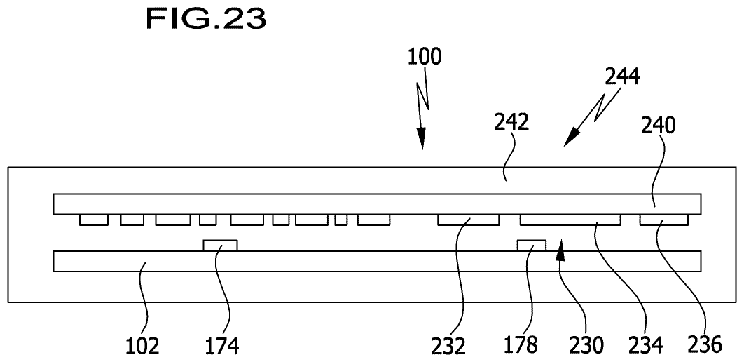

Preferably, the deformation transmission element 102 and the circuit board 240 are moreover enclosed or encapsulated in a coating material 242 such that the deformation transmission element 102, the circuit board 240 and the coating material 242 form a common unit 244 (FIG. 23).

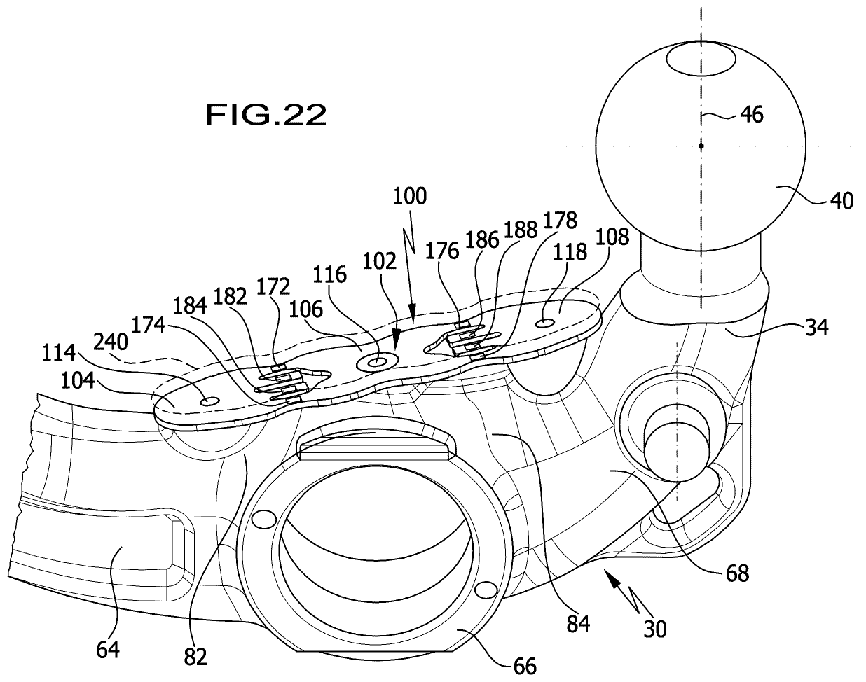

This unit 244 may be mounted on the connection elements 114, 116 and 118 such that the circuit board 240 lies on a side of the deformation transmission element 102 remote from the holding arm 30, as illustrated for example in FIG. 22.

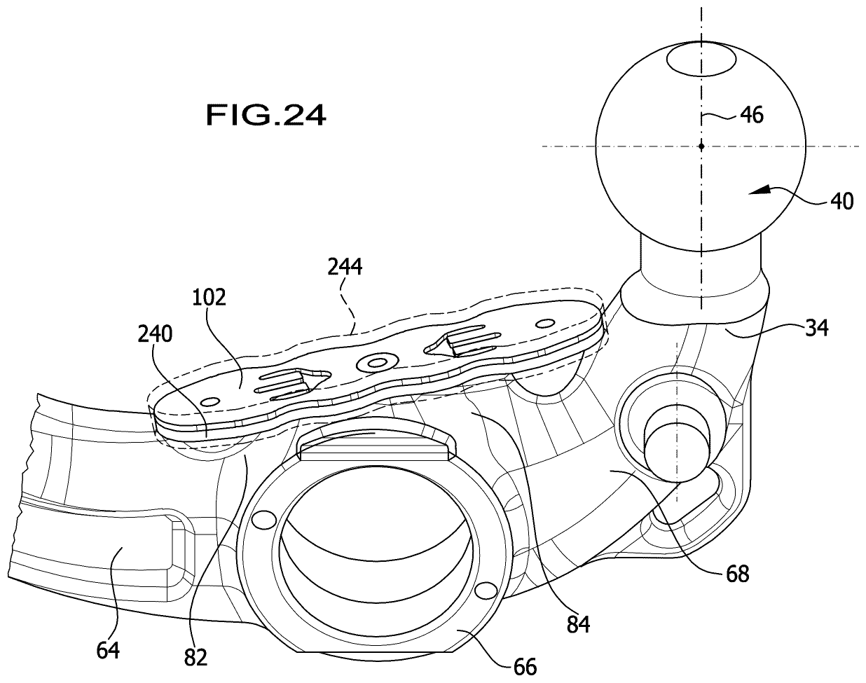

However, it is also possible, in a second exemplary embodiment, to arrange the unit 244 such that the circuit board 240 lies on a side of the deformation transmission element facing the holding arm 30, as illustrated for example in FIG. 24.

In a third exemplary embodiment, for the purpose of ensuring the functions of the reference deformation sensors 182, 184, 186 and 188, associated for example with each of the reference deformation sensors 182, 184, 186, 188 is a respective separate temperature sensor 252, 254, 256 and 258.

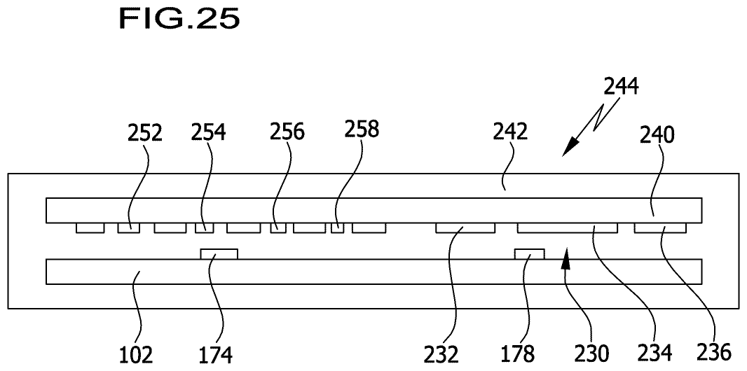

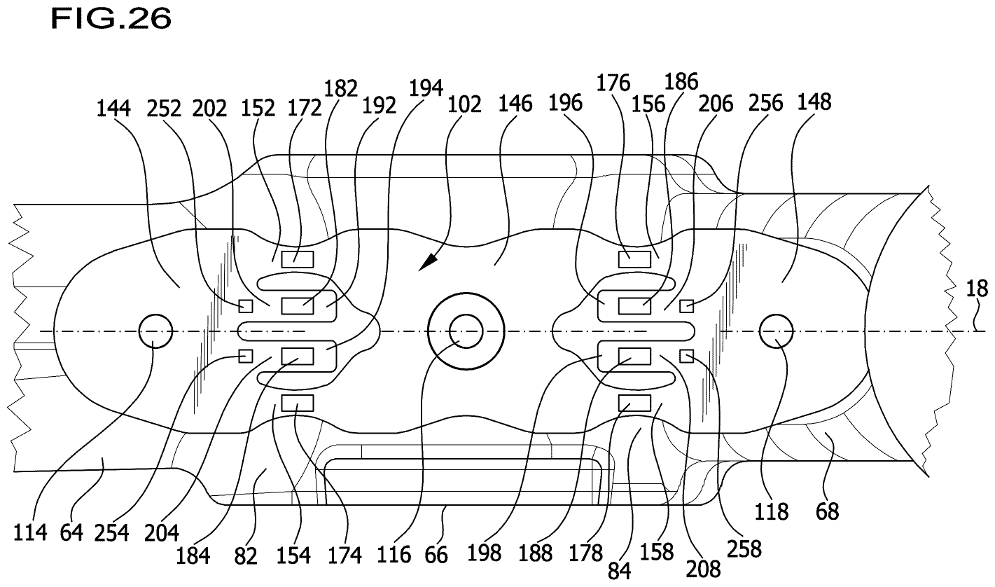

The separate temperature sensors 252, 254, 256, 258 may be arranged either on the circuit board 240 as illustrated in FIG. 25 or, as in a fourth exemplary embodiment as illustrated in FIG. 26, on the deformation transmission element 102.

An additional temperature sensor 252, 254, 256, 258 of this kind opens up the possibility of performing an additional temperature measurement in order to check whether the reference deformation sensors 182, 184, 186 and 188 are fully functional or whether, as a result of restrictions in function or function failures of these reference deformation sensors 182, 184, 186, 188, measurements of the voltages UD152, UD154, UD156 and UD158 could be erroneous.

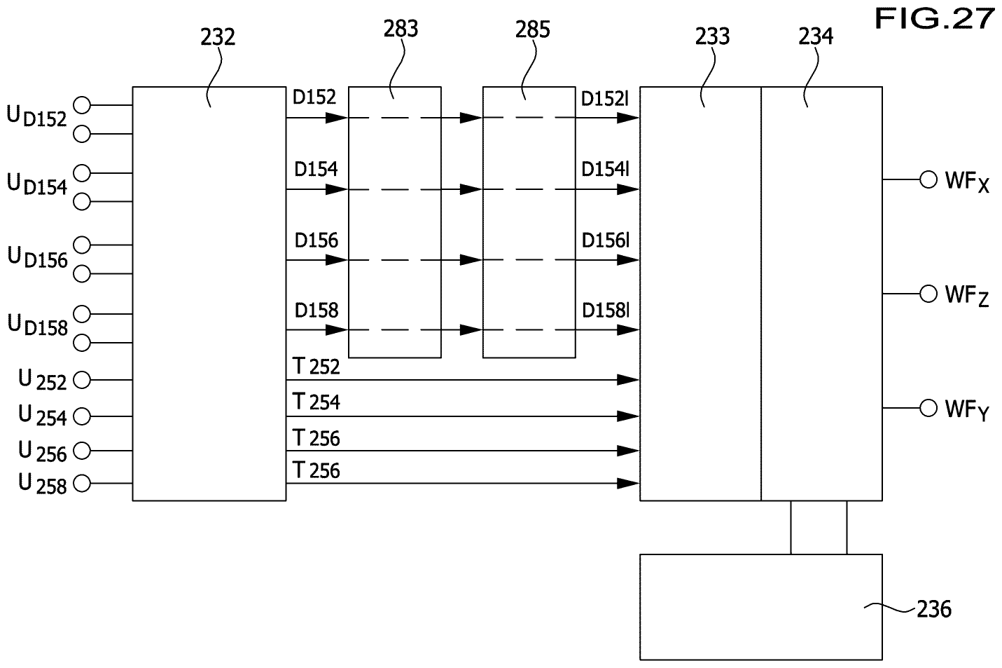

Regardless of whether the arrangement is on the circuit board 240 (FIG. 25) or on the deformation transmission element 102 (FIG. 26), the voltages UD252, UD254, UD256 and UD258 that are measured for example at these temperature sensors 252, 254, 256 and 258 are likewise supplied to the A/D converter 232, as illustrated in FIG. 27, and there converted into the values T252, T254, T256, T258 and supplied to the load analysis stage 233 and/or the force analysis stage 234 and then checked by the load analysis stage 233 and/or the force analysis stage 234 before evaluation of the corresponding digital deformation values D152, D154, D156, D158 is carried out.

In a fifth exemplary embodiment, a holding arm, designated 30′ as a whole, is connected to the carrier unit 20 in that the first end 32′ of the holding arm 30′ is held on the carrier unit 20, preferably the transverse carrier 22, either directly or by way of a bearing unit 36′

The holding arm 30′ comprises a receiving body 31′ and is arranged to the first end 32′ and the second end 34′ and is configured to receive a coupling element 40′ that is provided for example for the purpose of hitching a trailer or for fixing a load carrier unit.

For example, a coupling element 40′ of this kind takes the form of a coupling ball 43′ that is held on a carrier arm 42′ and enables a widely used connection to a coupling head of a trailer, wherein, by way of an insertion portion 45′, the carrier arm 42′ is configured to be inserted into an insertion receptacle 33′ of the receiving body 31′ through an insertion opening 35′ which in the working position A is to the rear as seen in the direction of travel, and to be fixed therein.

The coupling element 40′ is connected to the holding arm 30′ for example by way of the carrier arm 42′ such that the coupling ball 43 extends from a side of the carrier arm 42′ remote from a road 44 in the direction of a center axis 46, which with extends approximately vertically if the road 44 is horizontal, and in the case of the coupling ball 43′ runs through a ball center point 48.

In particular, the insertion receptacle 33′ takes a form such that it receives the insertion portion 45 detachably and with positive engagement, transversely to an insertion direction E, and ensures that movement is prevented in the insertion direction E by a positive-engagement element 41.

In particular, the insertion portion 45 of the carrier arm 42′ is detachably fixed in the receiving body 31 by a fixing bolt 41 that runs transversely to the vehicle longitudinal center plane 18 and passes through both the receiving body 31 and the carrier arm 42′.

However, a coupling element 40′ that takes a form of this kind also enables simple mounting of a load carrier unit, since widely used load carrier units likewise take a form such that they are mountable on the coupling ball 43 and where appropriate are also additionally supportable on the holding arm 30.

As an alternative to this, however, only one carrier arm 42 that is held on the load carrier unit and has an insertion portion 45 that is suitable for insertion into the insertion receptacle 33′ is also usable as the coupling element 40′.

For the purpose of improving the esthetic effect, preferably the transverse carrier 22 is arranged below a rear bumper unit 50 of the motor vehicle body 12, wherein the bumper unit 50 covers for example the transverse carrier 22 and part of the first end 32′ of the holding arm 30′.

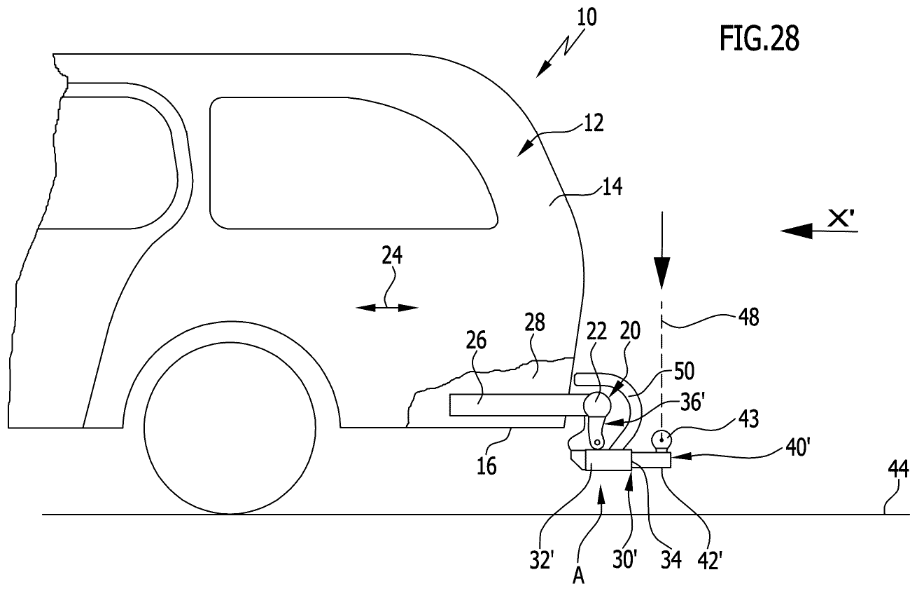

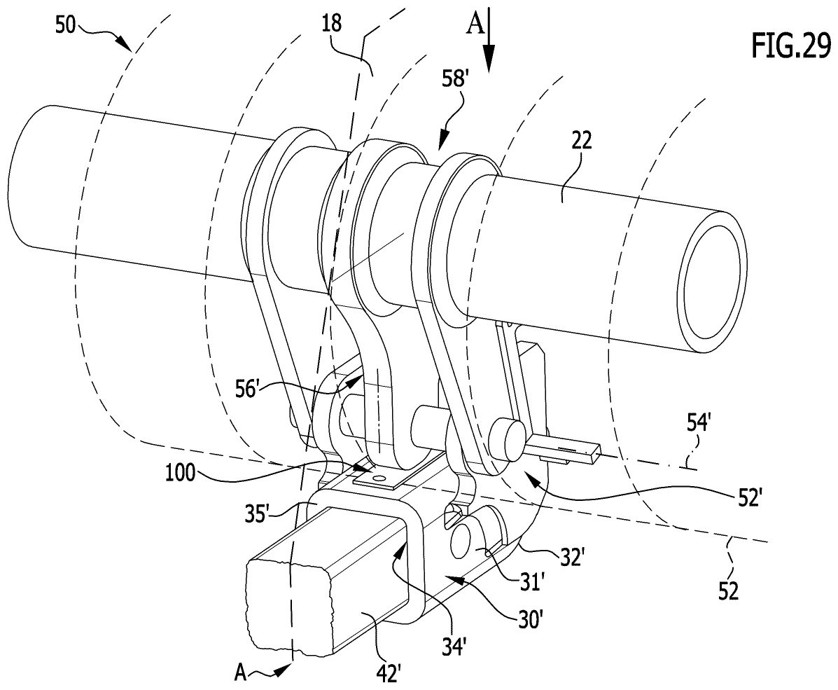

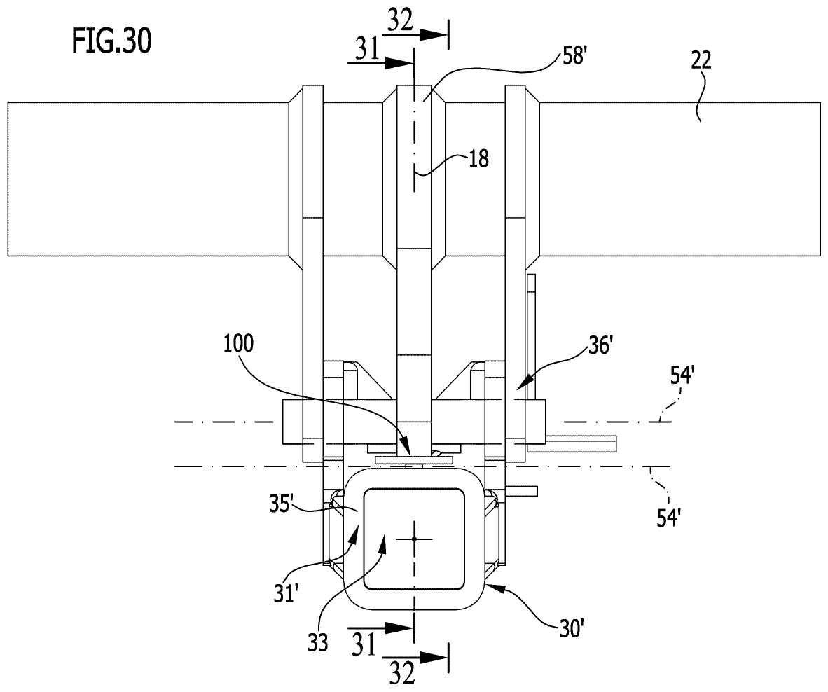

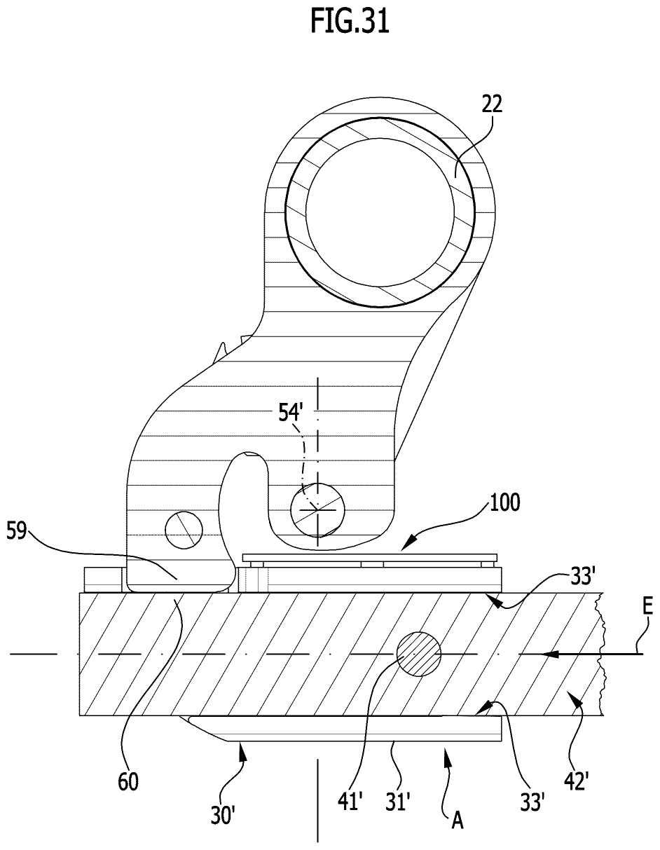

In particular in the case of the illustrated fifth exemplary embodiment, as a result of the insertion portion 45 that is inserted into the insertion receptacle 33′, the holding arm 30′ carries the coupling element 40′ comprising the coupling ball 43, wherein the holding arm 30′, as illustrated in particular in FIGS. 28 to 32, extends from the pivot bearing unit 36′, to which the holding arm 30′ is connected at its first end region 32′, wherein a pivot bearing body 52′ of the pivot bearing unit 36′ is integrally formed for example on the first end region 32′.

In the fifth exemplary embodiment, the pivot bearing body 52′ of the pivot bearing unit 36′ is mounted such that it is pivotal about a pivot axis 54′ that runs in particular transversely to the vertical vehicle longitudinal center plane 18, on a pivot bearing receptacle 56′ that on the one hand guides the pivot bearing body 52′ such that it is rotatable about the pivot axis 54′ and on the other comprises locking that enables the holding arm 30′ to be immobilized in the working position A and the rest position R to prevent rotation, such that it cannot perform pivotal movements about the pivot axis 54′.

As regards the form taken by the pivot bearing unit 36′ and the respective locking of the pivot bearing body 52′ relative to the pivot bearing receptacle 56′, reference is made to the entire content of DE 10 2016 107 302 A1.

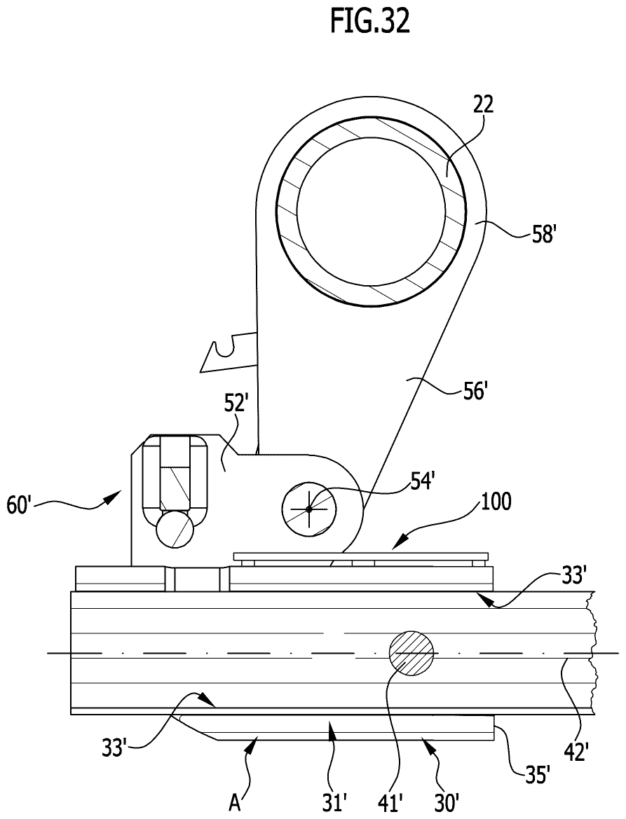

In particular, for the purpose of locking the pivot bearing body 52′ in the working position A, an abutment element 59′ illustrated in FIG. 31 is provided, which passes through an aperture in the holding arm 30′ and is supported on an end, arranged remote from the insertion opening 35, of the insertion portion 45 of the carrier arm 42′ that is inserted into the insertion receptacle 33′, and as a result blocks a pivotal movement of the holding arm 30′ with the receiving body 31′ about the pivot axis 54′ at the same time as cooperating with an abutment unit 60′ (FIG. 32) that comprises abutment elements arranged on the pivot bearing body 52′ and the pivot bearing receptacle 56′.

Moreover, the pivot bearing body 52′ is locked in the rest position R by a latching device 61, illustrated in FIG. 34.

In that case, the pivot bearing receptacle 56′ is for its part firmly connected to the transverse carrier 22 by way of a pivot bearing base 58′.

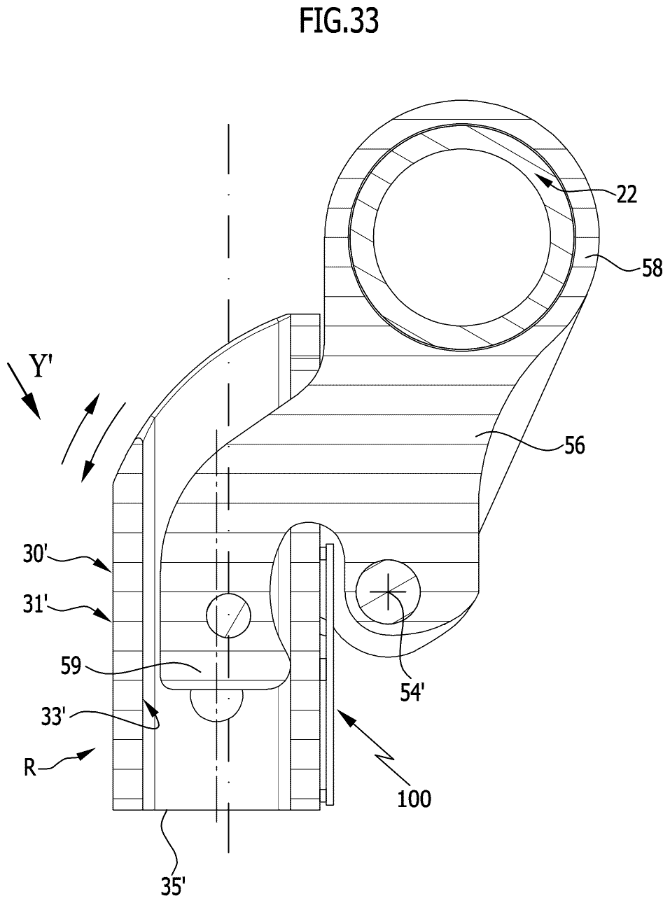

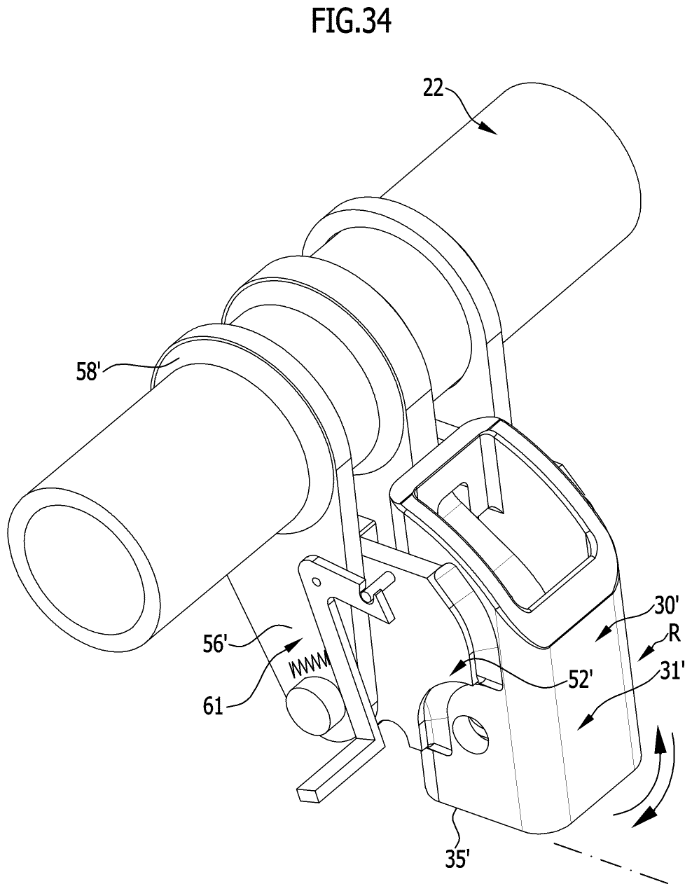

As illustrated in FIGS. 28 to 34, in this fifth exemplary embodiment the holding arm 30′ is pivotal from a working position A illustrated in FIGS. 28 to 32, in which the coupling element 40′ having the coupling ball 43 is disposed such that it is located behind the bumper unit 50 on a side remote from a road 44, into a rest position R illustrated in FIGS. 33 and 34, in which, with the coupling element 40′ demounted, an insertion opening 35 in the insertion receptacle 33 is arranged facing the road 44.

In particular here, in the working position A the holding arm 30′ extends substantially in the vertical vehicle longitudinal center plane 18, wherein this plane intersects the coupling element 40′ centrally in cases where this takes the form of a coupling ball 43 provided with the carrier arm 42, such that in the working position A a vertical ball center axis 48 lies in the longitudinal center plane 18.

In the illustrated exemplary embodiment, from the first end region 32′, the receiving body 31′ of the holding arm 30′ extends by an attachment piece 62′ as far as an intermediate piece 64′ which extends as far as an intermediate body 66 adjoined on an opposite side to the intermediate piece 64 and the attachment piece 62 by an end piece 68 beyond which the coupling element 40′ extends by the carrier arm 42, which is arranged between the coupling ball 43 and the end piece 68.

In this arrangement, the end piece 68 forms the end region 34′ of the holding arm 30′, wherein the holding arm 30′, through the insertion receptacle 33′, takes up the force transmitted thereto from the insertion portion 45 of the carrier arm 42′.

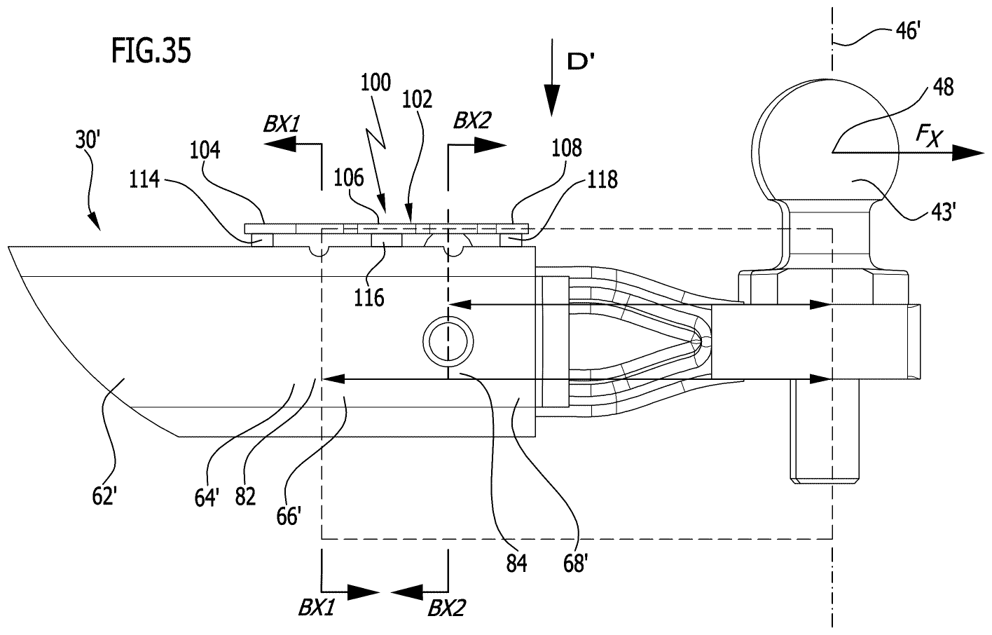

As illustrated in FIGS. 35 to 40, a holding arm 30′ that takes a form of this kind and takes up the forces transmitted by the insertion portion 45 takes an approximately rectilinear form through the attachment piece 62′, the intermediate piece 64′ of the intermediate body 66, and the end piece 68, and in the working position A, in which loads on the coupling element 40′ occur and are to be detected, the holding arm 30′ is configured such that the forces acting on the coupling element 40′, in particular the ball center point 46, are transmitted by way of the the holding arm 30′ to the pivot bearing body 52′ of the pivot bearing unit 36′, wherein the pivot axis 54′ forms a center point for the taking up of forces by the pivot bearing unit 36′.

As illustrated in FIGS. 28 to 32, the forces acting on the coupling element 40 are transmitted through the holding arm 30′ to the bearing unit 36′ and from there to the carrier unit 20, which then introduces these forces into the rear region 14 of the motor vehicle body 12, wherein for the purpose of detecting the forces acting on the coupling element 40 different regions of the holding arm 30′ are made use of.

In the exemplary embodiment described above, by way of example a first deformation region 82 of the holding arm 30′ is made use of, which is formed for example by a transition region from the intermediate piece 64′ to the intermediate body 66′, and a second deformation region of the holding arm 30′ is made use of, formed by a transition region from the intermediate body 66′ to the end piece 68′.

Further, in this exemplary embodiment the assumption is made that the intermediate body 66′ has a high level of stability in relation to bending forces running in the longitudinal center plane 18 and also transversely thereto, and in particular primarily responds to tensile loads.

The first and second deformation regions 82, 84 are formed for example by a region given a deliberate shape, for example by thinning or thickening of the material, wherein in the simplest case the material may be thinned by making a variation in its cross section.

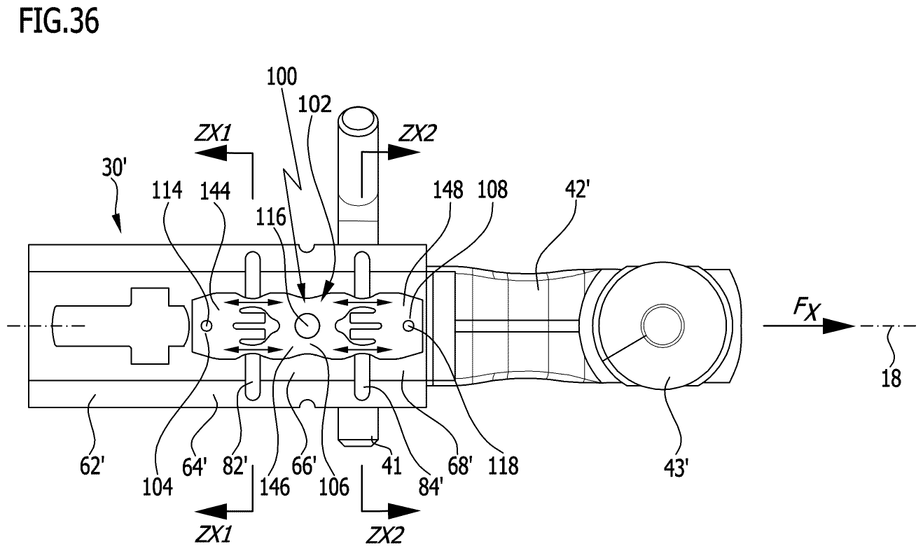

Thus, for example, the force Fₓ that is illustrated in FIGS. 35 and 36, which is directed in the longitudinal center plane 18 and perpendicular to the center axis 46 and away from the pivot bearing body 52, results on the one hand in tensile forces ZX1 and ZX2 (FIG. 36) occurring in the deformation regions 82 and 84, and on the other, at least when the coupling ball 43′ is at a spacing from the carrier arm 42′ in the operating position on a side remote from the road 44, additionally in bending forces BX1 and BX2 (FIG. 35), which are superimposed on these tensile forces ZX1 and ZX2, wherein these forces act in the direction of the longitudinal center plane 18, and in particular in the longitudinal center plane 18, of the holding arm 30′.

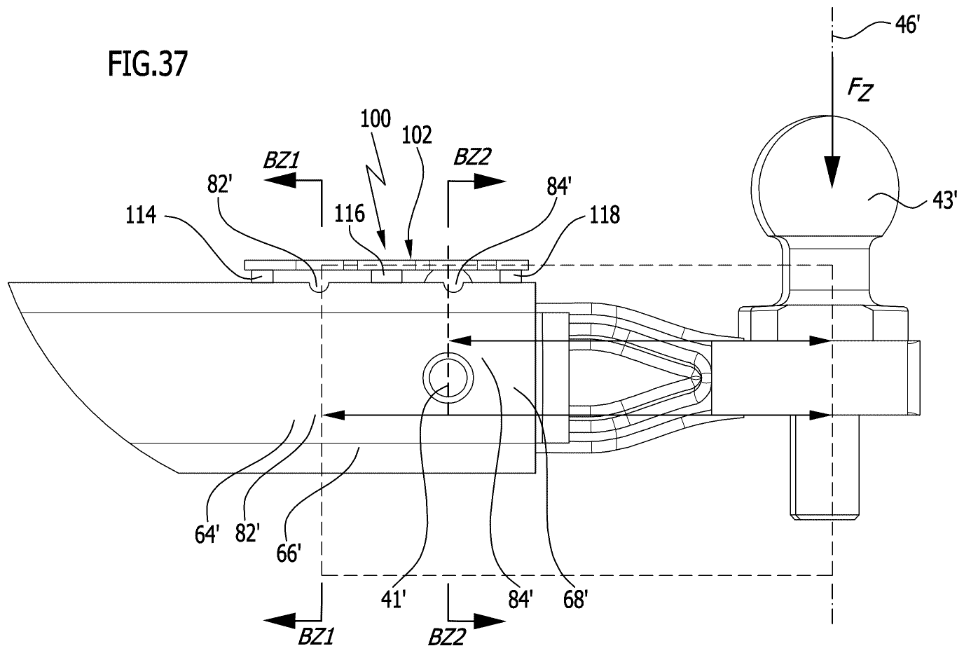

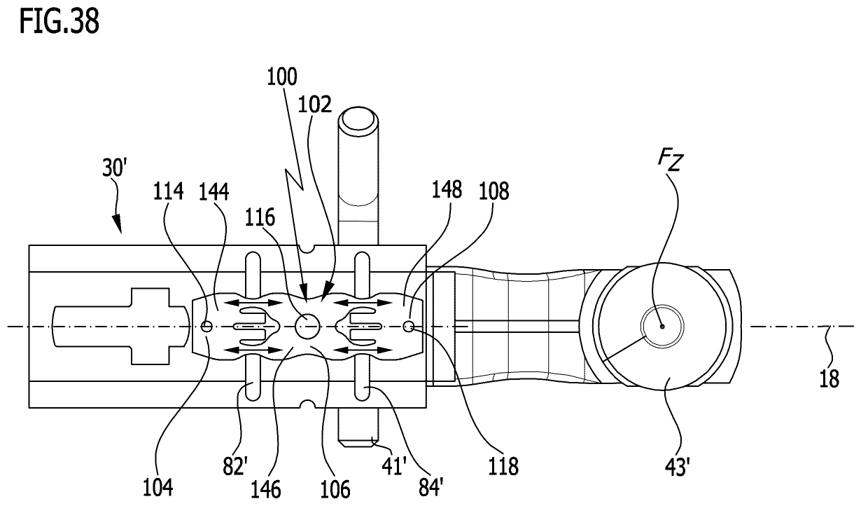

Further, there arise, as illustrated in FIGS. 37 and 38, in the event of a load on the coupling element 40 by a force F_{z} acting in the direction of the center axis 46, there arise in the deformation regions 82 and 84 substantially bending forces BZ1 and BZ2, wherein these forces act in the direction of the longitudinal center plane 18, in particular in the longitudinal center plane 18, of the holding arm 30, and thus in relation to a so-called neutral axis NF of invariable length exert mutually opposed actions on mutually opposing sides.

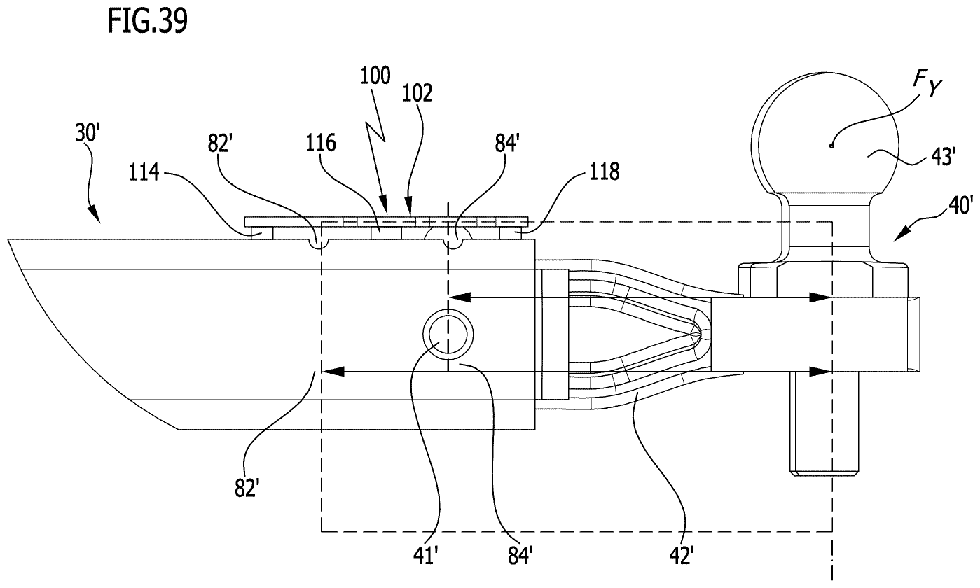

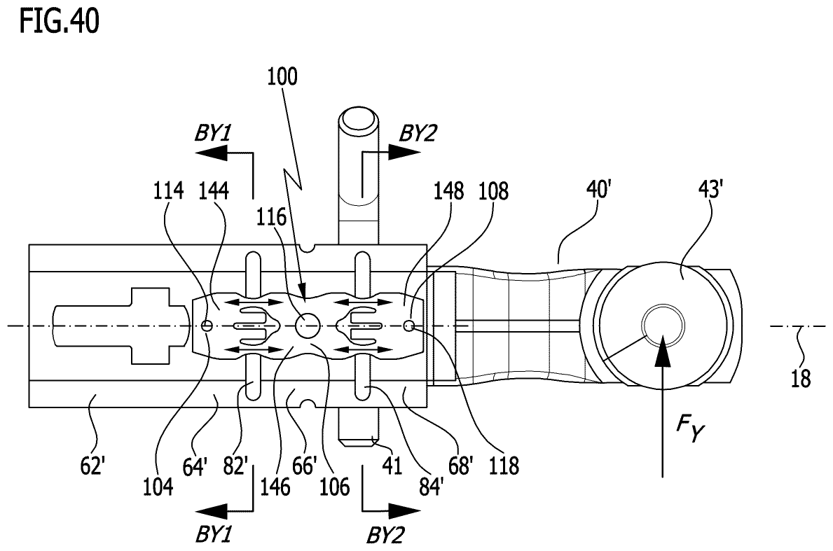

Moreover, as illustrated in FIGS. 39 and 40, a force F_{y} that acts on the coupling element 40 and is directed perpendicular to the longitudinal center plane 18 and perpendicular to the center axis 46 results in bending forces BY1 and BY2 acting on either side of the longitudinal center plane 18 but on different sides thereof, in opposition to one another.

In particular, the deformation regions 82 and 84 take a form such that they respond to the tensile forces Z and the bending forces B with different amounts of deformation, for example the deformation region 82 with high sensitivity to tongue weight and the deformation region 84 with little sensitivity to tongue weight.

For the purpose of detecting these tensile forces ZX1 and ZX2 and bending forces BX1 and BX2, BZ1 and BZ2, and BY1 and BY2, a force detection module that is designated 100 as a whole is arranged on the holding arm 30′.

This force detection module 100 comprises a deformation transmission element 102, which is rigidly connected to the holding arm 30′ at three securing regions 104, 106 and 108, wherein the securing region 104 lies on a side facing the first end 32 and is rigidly connected to an attachment 114 of the holding arm 30′ seated for example on the center piece 64, the securing region 106 is arranged approximately centrally between the securing regions 104 and 108 and is connected for example to a holding attachment 116 seated on the intermediate body 66, in particular seated centrally thereon, and the securing region 108 is connected to an attachment 118 of the holding arm 30 that is arranged on the end piece 68, for example arranged in a central region of the end piece 68 between the intermediate body 66 and the end 34.

Here, the respective connection elements 114, 116 and 118 of the holding arm 30′ are connected rigidly and without play, preferably by a weld or adhesion that does not permit any resilience of movement between the deformation transmission element 102 and the connection elements 114, 116 and 118.

Preferably, the connection elements 114, 116 and 118 are likewise rigidly connected to the holding arm 30′, in particular integrally formed thereon.

The force detection module 100, the deformation transmission element 102, the connection elements 114, 116, 118, the deformation sensors 172, 174, 176, 178, the reference deformation sensors 182, 184, 186, 188, the Wheatstone bridges 212, 214, 216, 218, the evaluation unit 230 and the circuit board 240 having the coating material 242 and the temperature sensors 252, 254, 256, 258 take the same form in the fifth exemplary embodiment as described in the first to fourth exemplary embodiments, and also operate in the same way.

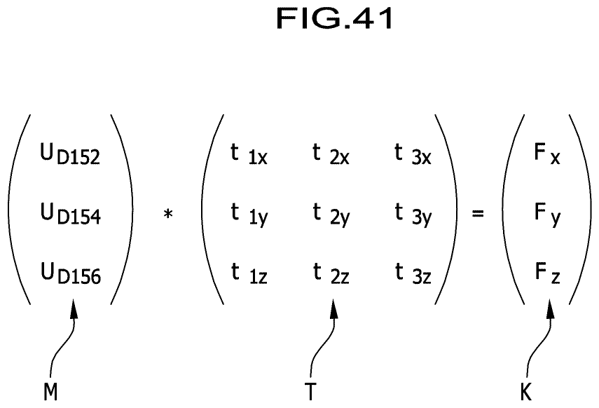

In all the exemplary embodiments that are described above, a calibration is carried out for the purpose of determining a relationship between a measured value vector M for the sensor values, which represents the deformation values D152, D154, D156, D158 corresponding to the measured voltages UD152, UD154, UD156 and UD158, and a vector K which represents the values WFₓ, WF_{y} and WF_{z} generated by the evaluation unit 230 or 230′ for the force components is established by a transformation matrix T, as illustrated in FIG. 41.

Since the force vector K has the three force components with the values WFₓ, WF_{y} and WF_{z}, for example only three of the deformation values from the sensor values UD152, UD154, UD156 and UD158, for example the deformation values D152, D154 and D156, are made use of for the purpose of forming the measured value vector M.

A measured value vector M of this kind then has to be multiplied using the transformation matrix T in order to obtain the individual values WFₓ, WF_{z} and WF_{y} of the force components of the force vector K, as illustrated in FIG. 41.

In this case, the transformation matrix T has nine transformation coefficients tix, t₂ₓ, t₃ₓ, t_{1y}, t_{2y}, t_{3y}, t_{1z}, t_{2z}, t_{3z}.

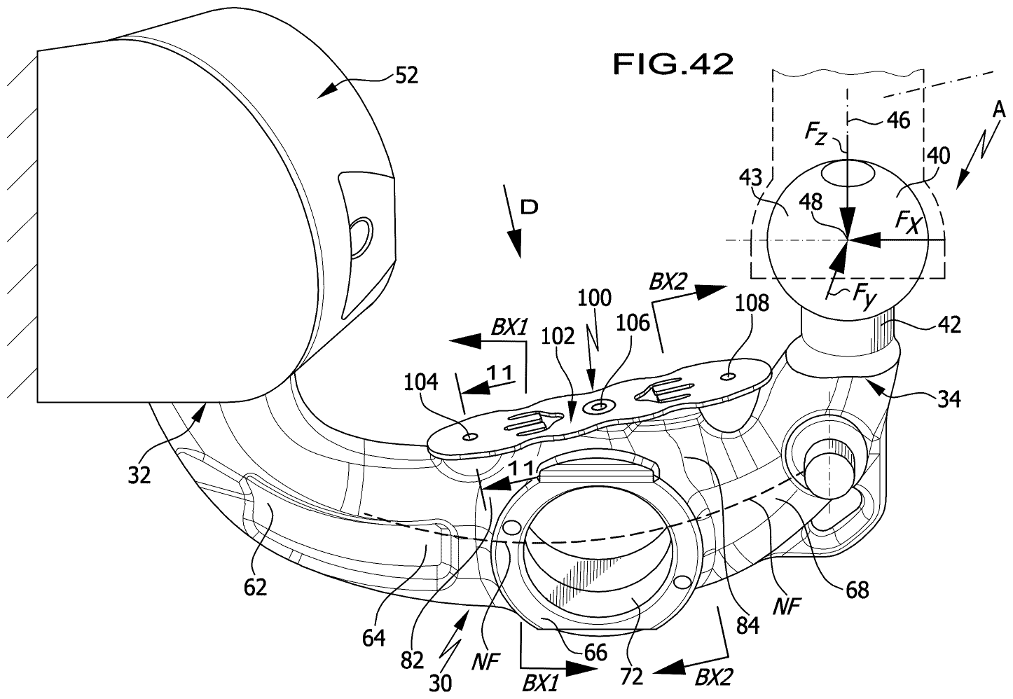

For the purpose of determining these transformation coefficients t₁ₓ to t_{3z}, as illustrated in FIG. 42 the holding arm 40 is fixed in place on a test bench for example using the pivot bearing body 52, acted on the coupling element 30 by an arm KA urged by different forces in different spatial directions.

For example, the arm KA exerts a force Fₓ in the X direction and/or a force F_{z} in the Z direction and/or a force F_{y} in the Y direction, or one or more combinations of these forces.

As mentioned above, in the simplest case a transformation matrix T that is valid for all spatial directions x, y, z is stored in the memory 236 and is used to convert the deformation values D152, D154, D156 into values WFₓ and WF_{z} and WF_{y} for all the force components acting on the coupling element 40.

During a calibration of this kind (FIG. 41), three calibration procedures are carried out successively, and for example during the first calibration procedure there is action on the coupling element 40 only by the force component Fₓ, and during the third calibration procedure only by the force component F_{y} or only by the force component F_{z}, and the deformation values D152, D154 and D156 are then detected during each calibration procedure.

Since during each of the three calibration procedures mentioned the other force components F_{y} and F_{z}, or Fₓ and F_{z}, or Fₓ and F_{y}, are zero, after all three calibration procedures an equation system comprising nine equations is obtained for determining the total of nine unknown transformation coefficients t₁ₓ to t_{3z}.

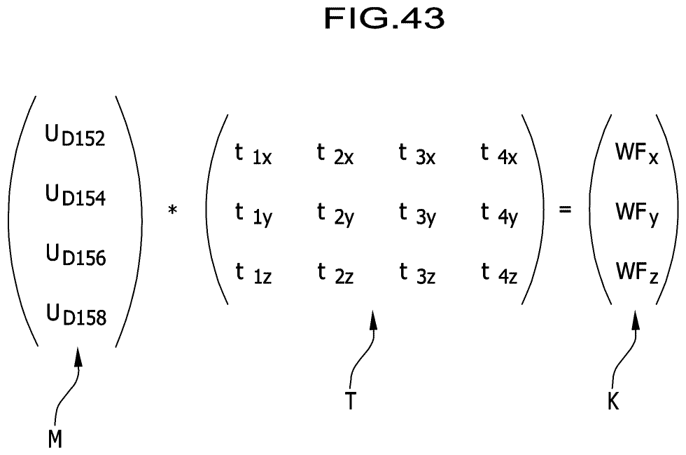

However, there is also the possibility of working with the deformation values D152, D154, D156, D158 from all four sensor values UD152, UD154, UD156 and UD158, as illustrated in FIG. 43, and in this case a total of four calibration procedures has to be carried out to determine the total of twelve transformation coefficients t₁ₓ to t_{4z} in order to obtain a total of twelve equations for the twelve unknown transformation coefficients t₁ₓ to t_{4z}.

During calibration, preferably the force F_{z} acts in the direction of gravity when the holding arm 30 is oriented as in the case of a motor vehicle 10 standing on a substantially horizontal plane.

The force Fₓ likewise, when the holding arm 30 is oriented as in the case of a motor vehicle 10 standing on a substantially horizontal surface, acts in the substantially horizontal direction, in particular in a vertical vehicle longitudinal center plane 18 and thus also in the vertical longitudinal center plane 18 of the holding arm 30.

Further, the force F_{y} acts transversely, in particular perpendicular to the vertical longitudinal center plane 18, and perpendicular to the force Fₓ and the force F_{z}.

The physical relationship that is assumed here between the exerted forces Fₓ, F_{y}, F_{z} and the arising deformations represents the simplest possible assumption.

The quality of the results for the values WFₓ, WF_{z} and WF_{y} can be improved if the calibration of paired values WFₓ, WF_{z} and WF_{y} located in each of the octants I to VIII in space around the coupling element 40, according to FIG. 21 to FIG. 44, is performed such that it is also possible to incorporate into the calibration non-linear spatial correlations between the forces Fₓ, F_{z}, F_{y} acting on the coupling element 40 and the digital deformation values of the voltages UD152, UD154, UD156 and UD158 and thus to incorporate transformation of these deformation values D152, D154, D156 and D158 into the values WFₓ, WF_{z} and WF_{y} for the forces acting on the coupling element 40.

As a result, the accuracy of the determined values WFₓ, WF_{z} and WF_{y} is significantly improved.

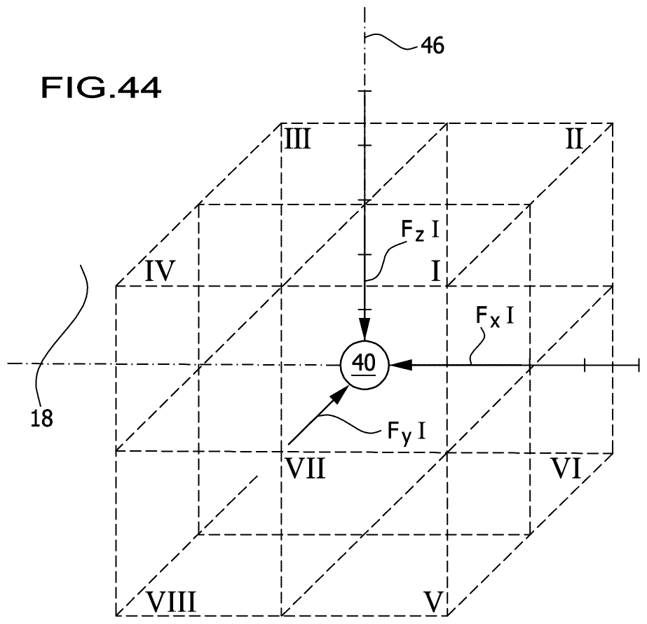

For the purpose of calibration in relation to the octants I to VIII, illustrated in FIG. 44, during the calibration for determining an octant-specific transformation matrix T, the forces Fₓ, F_{y} and F_{z} are each selected such that they are located within the respective octant, and in particular all act in the direction of the same point on the coupling element 40.

For example, for the purpose of determining the transformation matrix TI for the octant I, only forces with force components FₓI, F_{z}I and F_{y}I located within this are used.

This allows values WFₓ, WF_{z} and WF_{y} of the force components that are determined for the space within the respective octant I to VIII to be determined even more exactly.

Because, during determination of an unknown force on the coupling element 40, its orientation and thus also its association with one of the octants is unknown, a determination of the components WFₓ, WF_{z} and WF_{y} thereof is for example performed, either using the transformation matrix T that was determined for all spatial directions, or using one of the transformation matrices TI to TVIII, and then, using the values WFₓ, WF_{z} and WF_{y}, the evaluation unit 230 or 230′ checks which of the octants, for example the octant III, the force is to be associated with, and thereafter a new determination of the values WFₓ, WF_{y}, WF_{z} is performed using the transformation matrix that was determined for this octant, for example the transformation matrix TIII.

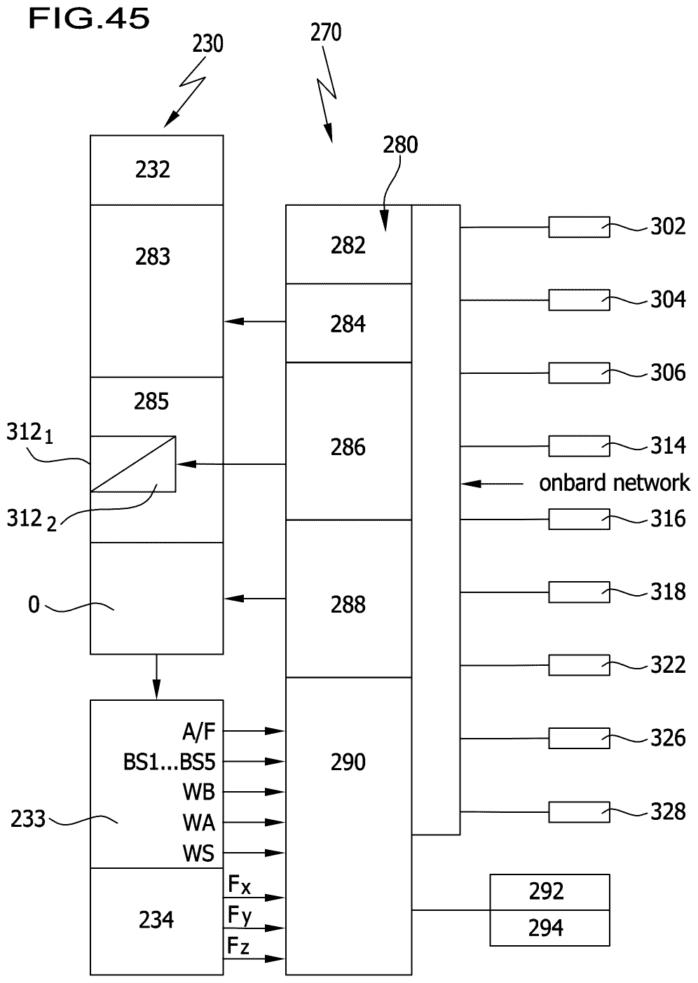

In order to carry out a load analysis on the basis of the deformation values D152, D154, D156, D158 using the load analysis stage 233 and/or to determine load-induced forces Fₓ, F_{y}, F_{z} on the coupling element 40, there is provided, as illustrated in FIG. 45, a condition evaluation unit 270 which cooperates with the evaluation unit 230 and in particular has a sequence controller 280.

First, in a condition detection stage 282, the sequence controller 280 checks whether a voltage supply to the evaluation unit 230 is sufficient.

Here, the condition detection stage 282 uses for example a voltage sensor 302 to check the battery voltage of the vehicle, in particular the voltage at the deformation sensors 182, 184, 186, 188 and where appropriate the temperature sensors 252, 254, 256, 258 and the evaluation unit 230.

In particular, the condition detection stage 282 also checks whether the motor vehicle 10 is in a condition in which detecting the forces on the holding arm is permitted, that is to say whether the vehicle is standing substantially on a horizontal plane, wherein a substantially horizontal plane is one in which the deviation from an exactly horizontal plane is at most ±2°, or better ±1°, in each direction of the plane.

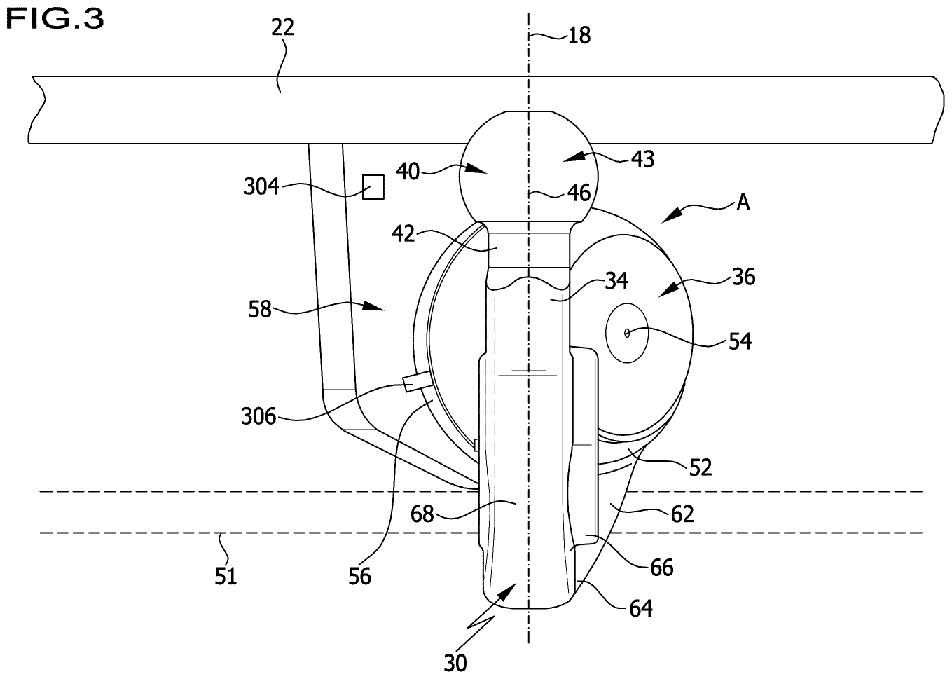

For this purpose, the condition detection stage 282 uses one or more inclination sensors 304 (FIG. 3 and FIG. 45) to check the orientation of the vehicle that has the device according to the invention in relation to an orientation of the vehicle on a predetermined horizontal plane, wherein the inclination sensor 304 may be provided for example in the sequence controller 280 or in the motor vehicle 10 or on the carrier unit 20 and may be interrogated by the condition detection stage 282.

In the event of a substantial discrepancy between the orientation of the vehicle and an orientation on the predetermined horizontal plane, the condition detection stage 270 is for example deactivated, in the event of large discrepancies.

Further, there is performed in the condition detection stage 282 a check on the position of the holding arm 30, of whether it is in or outside its working position.

For this purpose, the condition detection stage 282 uses a sensor set 306 (FIG. 3 and FIG. 45) to check the working position and/or further positions of the holding arm 30, wherein at least one check is made on the working position, and if this is not the case this check is assessed as negative.

If the condition detection stage 282 establishes on the one hand that there is sufficient voltage supply and on the other that a correction of the inclination of the motor vehicle 10 is not necessary or has to be performed and moreover that the holding arm 30 is in the working position, then in an activation stage 284 that is then employed the evaluation unit 230 is activated such that it determines the deformation values D152, D154, D156, D158 for the condition at that moment of the motor vehicle 10 with the holding arm 30.

In the course of activating the evaluation unit 230, an inclination correction stage 283 is also activated.

As a result of activating the inclination correction stage 283 of the evaluation unit 230, in the event of discrepancies that are capable of compensation the deformation values D152, D154, D156, D158 are corrected, for the purpose of being used in the load analysis stage 233 and/or in the force analysis stage 234, using stored inclination correction data that has been determined for example by a calibration procedure.

Once the condition detection stage 282 has identified a condition in which detection of the forces on the holding arm 30, in particular on the coupling element 40 thereof, is permitted, and once the activation stage 284 has activated the evaluation circuit 230 together with where appropriate the inclination correction stage 283, preferably the next step is to employ a zero-load detection control stage 286.

In the zero-load detection control stage 286, first a check is made of whether it is indeed possible to detect detection of the in the event of zero load—that is to say no load—on the holding arm 30, in particular the load if there is no external force acting on the coupling element 40 of the holding arm 30.

The zero-load detection control stage 286 activates for example a zero-load value memory 312₁ of a zero-load correction stage 285, wherein the zero-load value memory 312₁ takes over the deformation values D152, D154, D156, D158 that were converted at the time of activating the A/D converter 232 and where appropriate were corrected by the inclination correction stage 283, and stores them as deformation values D₀152, D₀154, D₀156, D₀158 that were determined without the action of an external force, that is to say under zero load.

These values that are stored in the zero-load value memory 312₁ of the zero-load correction stage 285 are where appropriate then compared with stored reference values D_{R}152, D_{R}154, D_{R}156, D_{R}158 in a zero-load reference memory 312₂ for a condition of the holding arm 30, in particular of the coupling element 40, under zero load, in order to carry out a plausibility check of whether a load on the holding arm 30, in particular on the coupling element 40, by an external force can be ruled out.

These values stored in the zero-load reference memory 312₂ are detected for example by previous or factory determinations of the corresponding deformation values under zero load.

Moreover, the zero-load detection control stage 286 checks how much time has passed since the last time the holding arm 30 moved into the working position.

If for example it is established that the holding arm 30 and the coupling element 40 have moved into the working position only a few seconds before, the assumption may be made that there is not yet any external force acting on the coupling element 40, and hence zero load can be determined.

Another possibility is that the zero-load detection control stage 286 activates a camera system 314 on the motor vehicle 10 (FIG. 1, FIG. 45), which is for example integrated into the reversing camera system of the motor vehicle 10 or comprised therein and is able to optically detect whether an object, in particular a coupling head or a load carrier, is effectively acting on the coupling element 40 and thus on the holding arm 30 or not.

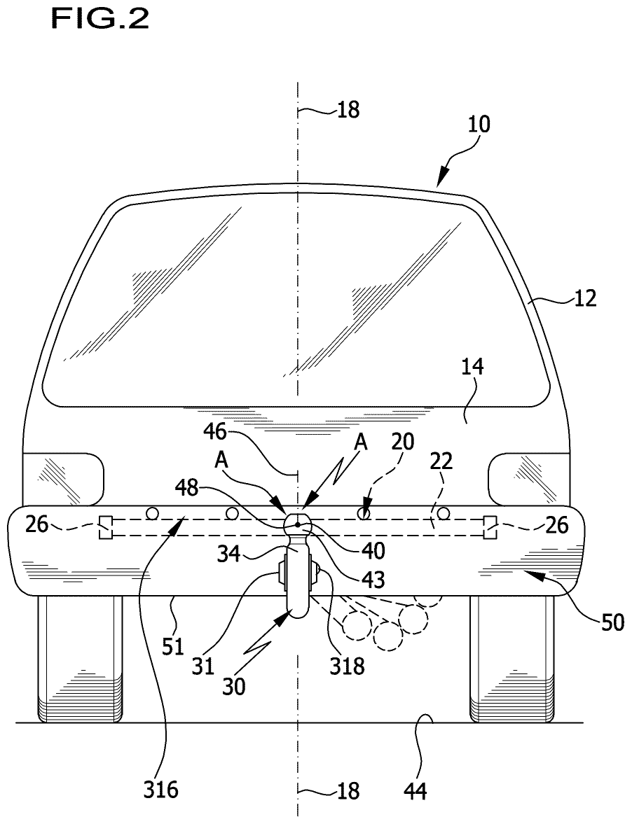

A further possibility is that the zero-load detection control stage 286 activates a sensor system 316 (FIG. 2, FIG. 45), for example comprising a set of ultrasound sensors that are in particular integrated into the rear bumper unit 50 and are likewise able to identify whether an object is acting on the holding arm 30 and the coupling element 40 or not.

A further possibility for checking whether there is no object acting on the coupling element 40 and thus on the holding arm 30 provides for the zero-load detection control stage 286 to check whether a socket 31 which is associated with the device and is for supplying electricity to a trailer or a load carrier unit is active, that is to say whether a supply plug has been plugged into this socket 31 (FIG. 2, FIG. 45).

If a sensor 318 associated with the socket 31 identifies a supply plug plugged into the socket 31, it must be assumed that an object is acting on the coupling element 40 and/or the holding arm 30, so detection of a zero load is not possible.

On the basis of one or more of the items of information explained above, the zero-load memory 312 of the zero-load correction stage 285 is then activated in order to store as deformation values D₀152, D₀154, D₀156, D₀158 under zero load the deformation values delivered by the evaluation unit 230, which correspond to a condition of the holding arm 30 and the coupling element 40 without the action of an external force.

If, however, the zero-load detection control stage 286 does not establish a condition in which it is possible to detect a zero-load condition, then for example the deformation values that were stored during the last detection of zero load in the zero-load memory 312₂ are not replaced by the values just stored in the zero-load memory 312₁ but are used again, and the values stored in the zero-load memory 312₁ are deleted.

A zero-load correction is then carried out using the deformation values D₀152, D₀154, D₀156 and D₀158 that are in the zero-load memory 312₂ of the zero-load correction stage 283.

Once the zero-load detection control stage 286 has been run, a load detection control stage 288 is activated.

The load detection control stage 288 serves to operate the zero-load correction stage 285 such that this only detects deformation values of the force components that are acting on the coupling element 40 and the holding arm 30 in a manner induced by load.

For this purpose, the load detection control stage 288 preferably checks whether an onboard function of the motor vehicle 10 has been activated, that is to say for example whether operation of all the electrical components has been activated. This is done for example by interrogating a suitable onboard supply voltage by way of the sensor 302.

Further, by accessing the sensor 318, the load detection control stage 288 checks whether a socket 31 associated with the device has been activated, the activation of which makes it possible to infer that there is an external force acting on the coupling element 40, whether through a trailer or a load carrier unit (FIG. 45).

Further, the load detection control stage 288 checks, using a sensor 322 or interrogation of a vehicle controller, whether the vehicle is stationary or is moving at a speed of less than 5 km/h or is moving more rapidly, such that at less than 5 km/h a motor vehicle 10 can be assumed to be fundamentally stationary for the detection of load (FIG. 45).

Moreover, the load detection control stage 288 checks, for example likewise using the camera system 314, whether an external object such as a trailer or a load carrier unit is acting on the coupling element 40, and/or the load detection control stage 288 checks, using the camera system 314 and/or the sensor system 316, whether an external object such as a trailer or a load carrier unit are acting on the holding arm 30 and the coupling element 40.

Where appropriate, the load detection control stage 288 also additionally checks, using the sensor 306, whether the holding arm 30 with the coupling element 40 is in the working position in which it is at all possible for a trailer to be hitched or a load carrier unit to be mounted.

If the load detection control stage 288 identifies that an external object is acting on the coupling element 40 and the holding arm 30, then the load detection control stage 288 on the one hand causes the deformation values D152, D154, D156, D158 to be taken over by the zero-load correction stage 285, and on the other causes the values D₀152, D₀154, D₀156, D₀158 to be taken over by the zero-load memory 312₂ and these values to be subtracted from the values D152, D154, D156, D158 (FIG. 45), resulting in the deformation values D152l, D154l, D156l, D158l, which represent the load-induced deformation values for the external force components Fₓ, F_{z}, F_{y} acting on the holding element 30 and coupling element 40.

On the basis of the load-induced deformation values D152l, D154l, D156l, D158l that are then present, and by applying one or more analytical methods, the evaluation unit 230 makes a determination using the load analysis stage 233, using program code and a processor, or various load conditions of the holding arm 30 without the need to determine the force components Fₓ. F_{y}, F_{z} by the described transformations.

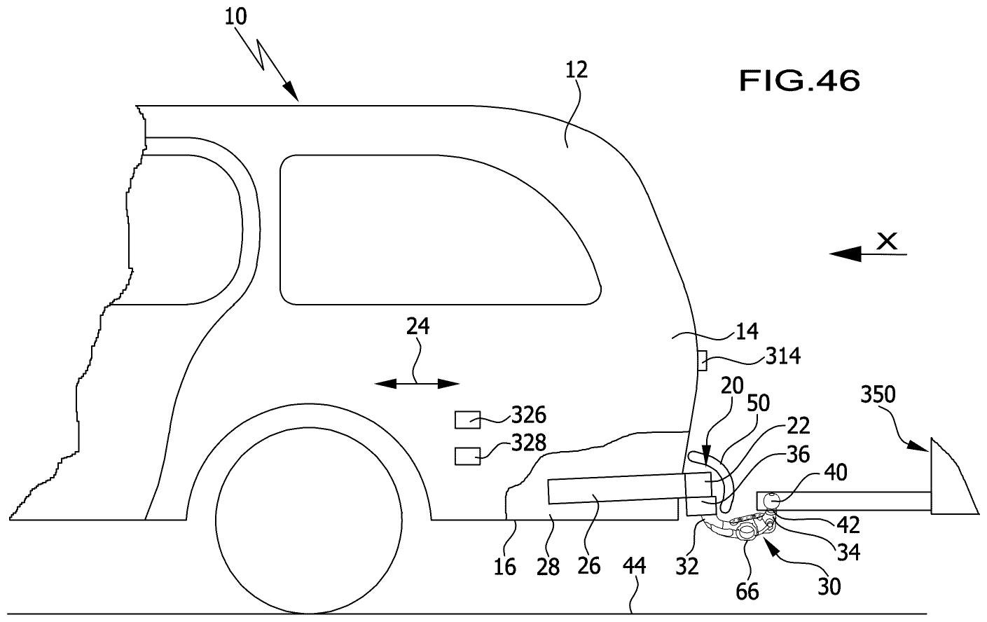

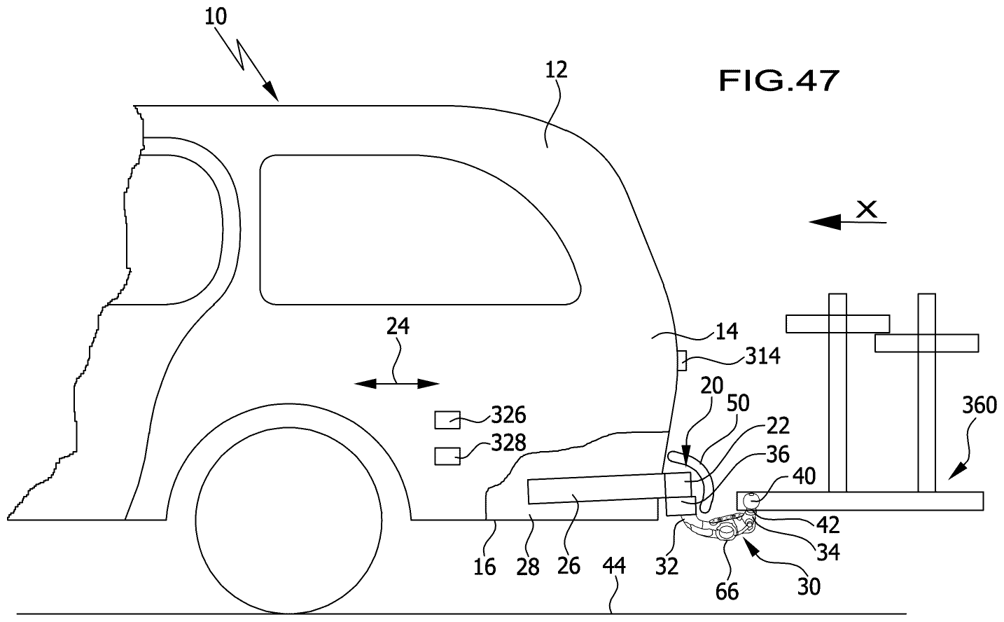

A possible load condition relates for example to identifying whether a bicycle carrier 350 is acting on the coupling element 40 of the holding arm 30 as illustrated in FIG. 47, or whether a trailer 360 is acting on the coupling element 40 as illustrated in FIG. 46.

The analytical methods applied for this purpose make the assumption for example that the bicycle carrier 350 acts on the holding arm 30 and in particular the deformation regions 82 and 84 such that both the deformation region 82 and the deformation region 84 undergo significant bending forces BX and BZ that arise as a result of the bicycle carrier 350, whereas the proportion of purely tensile forces ZX is small, with the result that both deformation regions respond with similar deformations.

If, however, a trailer 360 is hitched to the coupling element 40, then on the one hand the trailer 360 lies on the coupling element 40 with a tongue weight resulting in a force FZ, and on the other the trailer 360 acts on the coupling element 40 with a force FX depending on its mass when the vehicle is accelerating, but not when the vehicle is stationary or is moving at negligible speed.

Thus, if the analytical method carried out by the load analysis stage 233 is carried out when the vehicle is stationary or is at a negligible speed (less than 5 km/h), then the tensile forces ZX on the load regions 82 and 84 are small or even negligible unless the vehicle is standing on an inclined surface, wherein this can be—at least partly—compensated by the inclination correction stage 283.

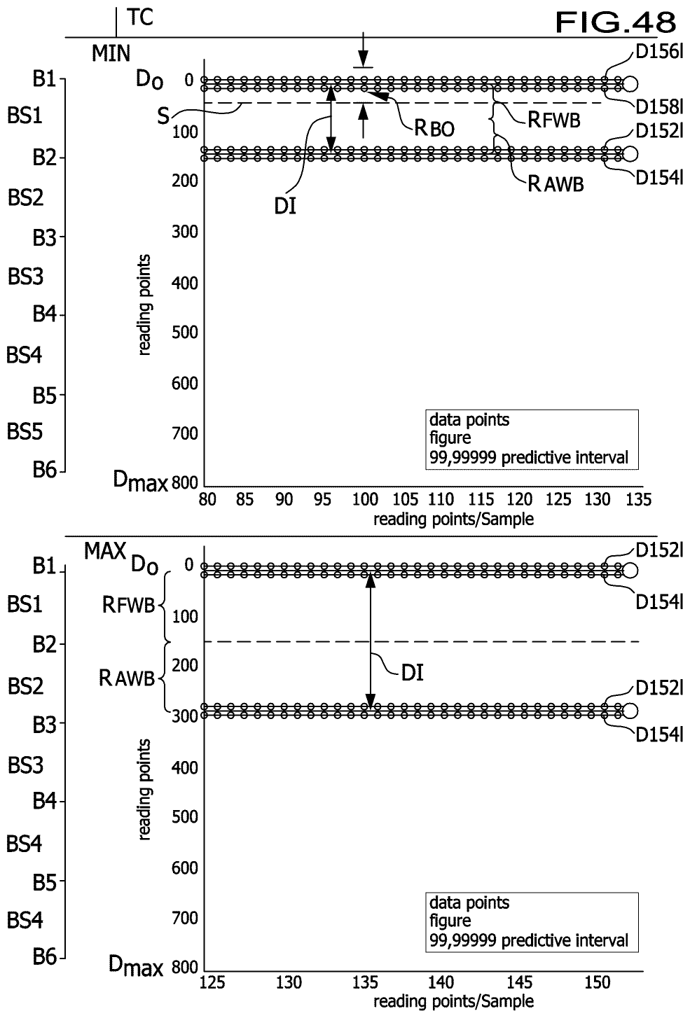

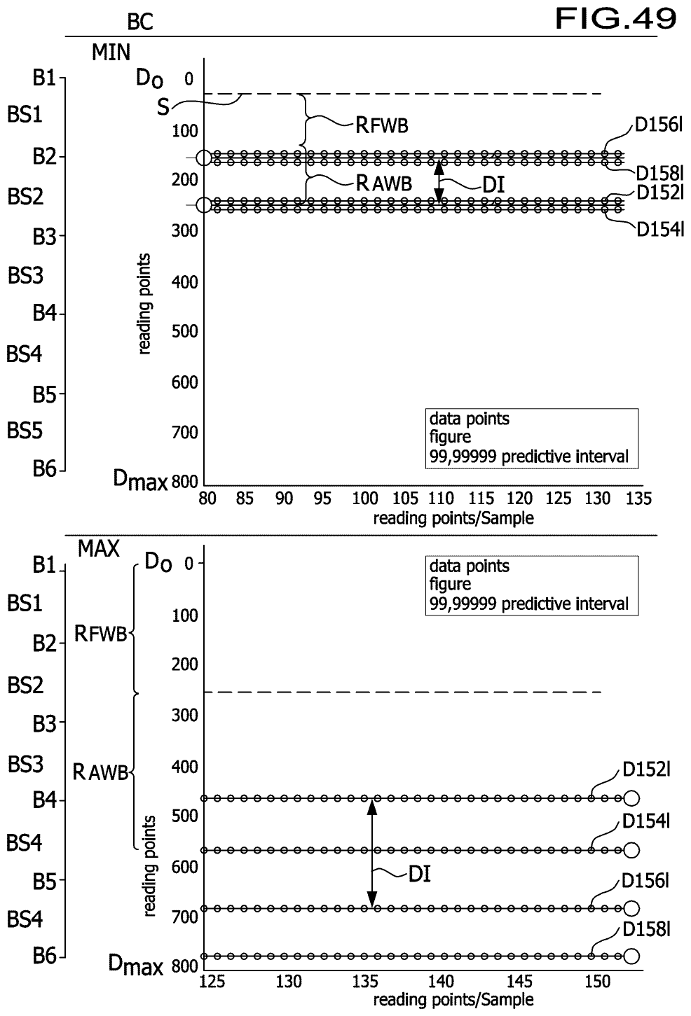

FIGS. 48 and 49 illustrate, by way of example, measured deformation values D152/l, D154/l for the deformation region 82 having high sensitivity to tongue weight and D156/l, D158/l for the deformation region 84 having little sensitivity to tongue weight, with a trailer 350 and a bicycle carrier 360, wherein in each case a small load on the holding arm 30 labeled MIN in the Figures and a maximum load labeled MAX in the Figures are illustrated.

For example, in the case of the trailer 350 illustrated in FIG. 46, the extension values D156l and D158l of the deformation region 84 having little sensitivity to tongue weight are close to zero, whereas under the minimum load the deformation values D152l and D154l of the deformation region 82 having high sensitivity to tongue weight are of approximately the same size and have higher values than the deformation values D156l and D158l. (FIG. 48)

Under maximum load from the trailer 350, the deformation values D156l and D158l of the deformation region 84 having little sensitivity to tongue weight remain close to zero as before, whereas the deformation values D152l and D154l of the deformation region 82 having high sensitivity to tongue weight are greater than under minimum tongue weight.

This results from the fact that the bending moments BZ in the deformation region 84 that are induced by the tongue weight FZ cause very small, and in some cases negligible, deformations, whereas in the deformation region 82, which is further away from the coupling element 40, the deformations D152l and D154l caused by the bending moments BZ are always larger and consequently are also larger under maximum tongue weight FZ than under minimum tongue weight FZ.

By contrast, the deformation values in the case of a bicycle carrier 360, which is illustrated in FIG. 47, behave differently. (FIG. 49)

For example, the deformation values D156l and D158l differ significantly from zero, and under minimum load they have values which, although smaller than the deformation values D152l and D154l, are qualitatively of a similar order of magnitude.

This is because significant bending forces BX and BZ occur as a result of the bicycle carrier 360, which exert a significant effect on both the deformation region 82 and the deformation region 84, wherein—as shown by FIG. 49—the effects on the deformation region 84 are smaller than on the deformation region 82.

However, if a maximum load on the coupling element 40 by the bicycle carrier 360 is reached, then FIG. 49 shows that the deformation values D156l and D158l are even larger and in some cases differ to a greater extent than under small load, and the sizes of the deformation values D156l and D158l are close to the maximum permitted deformation values.

The differences between the deformation values D156l and D158l, and D152l and D154l, which are measured on different sides of the longitudinal center plane, under maximum load by the bicycle carrier 360 result to a certain extent for example on the one hand from a force FY, which is caused by uneven loading of the bicycle carrier on respectively different sides of the coupling element 40, or indeed by asymmetry of the holding arm 30, which is for example already caused by the fact that the holding arm 30 and the pivot axis 54 that runs obliquely to the longitudinal center plane 18 are mounted pivotally.

The load analysis stage 233 can differentiate between a trailer 350 acting on the coupling element 40 and a bicycle carrier 360 acting on the coupling element 40 by different analytical methods.

First, each of the analytical methods described below checks whether the deformation values D152l, D154l, D156l and D158l are in a permitted value range between the values D0 and Dmax. If so, the further analysis is begun.

The first and simplest analytical method provides for a check, by a first analytical criterion, of whether deformation values, namely the deformation values D156l and D158l of the deformation region 84 having little sensitivity to tongue weight, are close to D0, in contrast to the deformation values D152l and D154l of the deformation region 82 having high sensitivity to tongue weight.

In particular, by the first analytical criterion, a comparison is made between the deformation values D156l and D158l and a predetermined first reference value range RB0 that comprises the value D0 and for example comprises the value D0 plus/minus 5% of Dmax.

If the deformation values D156l and D158l are within this first reference value range RB0, then a first criterion for the presence of a trailer 350 on the coupling element 40 is met.

Thus, there is already a result using the first analytical criterion for differentiating between a trailer 350 acting on the coupling element 40 and a bicycle carrier 360 acting on the coupling element 40.

Further, when applying a second analytical method, a second analytical criterion consists in all the deformation values D156l, D158l, D152l and D154l being significantly different from D0 with the bicycle carrier 360.

The second analytical criterion provides for example as the second reference value a threshold value S for the deformation values D156l, D158l, D152l and D154l which is for example 5%, or for example also 10%, of Dmax and which, if all the deformation values D156l, D158l, D152l and D154l are above this threshold value S, makes the assumption that there is a bicycle carrier 360 acting on the holding element 40. (FIG. 49)

With this second analytical criterion, in particular in combination with the first analytical criterion, it is possible to differentiate the action of a trailer 350 from the action of a bicycle carrier 360 on the coupling element 40.

A third analytical criterion that is used in a third analytical method provides for determining the difference DI between the deformation value D152l of the deformation region 82 that has high sensitivity to tongue weight and the deformation value D156l, of which the position corresponds to the longitudinal center plane 18, of the deformation region that has little sensitivity to tongue weight, and/or between the deformation value D154l of the deformation region 82 that has high sensitivity to tongue weight and the deformation value D158l, of which the position corresponds to the longitudinal center plane 18, of the deformation region 84 that has little sensitivity to tongue weight, and for comparing them with the respective absolute values of the deformation values D152l and D154l or D156l or D158l. (FIG. 48, FIG. 49)

As FIG. 48 clearly shows, the above-mentioned difference in the case of a trailer 350 lies approximately in the order of magnitude of the absolute values of the deformation values D152l and D154l of the deformation region 82 that has high sensitivity to tongue weight, whereas—as shown in FIG. 49—the above-mentioned difference in the case of a bicycle carrier 360 is merely a fraction of the deformation values D152l and D154l.

The third analytical criterion provides for example as the predetermined reference values a trailer reference value band RAWB, which lies between the largest of the deformation values D152l and D154l of the deformation region 82 that has high sensitivity to tongue weight and 50% of the largest of the deformation values D152l and D154l of the deformation region 82 that has high sensitivity to tongue weight, and a bicycle carrier reference value band RFWB, which lies between 50% of the largest of the deformation values D152l and D154l of the deformation region 82 that has high sensitivity to tongue weight and D0, and, depending on whether the difference DI is in the trailer reference value band RAWB or the bicycle carrier reference value band RFWB, makes it possible to differentiate between a trailer 350 and a bicycle carrier 360.

Thus, this third analytical criterion also enables differentiation between a trailer 350 acting on the coupling element 40 and a bicycle carrier 360 acting on the coupling element 40.

Thus, the load analysis stage 233 is able to transmit to a communication stage 290 of the condition evaluation unit 270 either a signal for a trailer 350 acting on the coupling element 40, for example the signal A, or a signal for a bicycle carrier 360 acting on the coupling element 40, for example the signal F.

The communication stage 290 is further able to communicate with the vehicle, in particular the vehicle electronics, and to transmit these signals for example to a speed monitor 322 of the vehicle or to a stabilization system 326 or to a chassis control 328 of the motor vehicle, in order to be able to adapt the speed, chassis stabilization and chassis adjustment according to whether operation is with a trailer 350 or a bicycle carrier 360.

Furthermore, the communication stage 290 can also cooperate with a presentation stage 292, which displays for example the fact that operation is with a trailer 350 or with a bicycle carrier 360 to the driver on a screen 294.

However, it is also possible to even further simplify the mode of operation of the load analysis stage 233.

A further simplified mode of operation provides, of the deformation values D152l and D154l and D156l and D158l, for only one of the deformation values to be used in each case for the analytical criteria, for example the deformation values D152l and the deformation values D156l or D154l and D158l, in other words in each case the deformation values that are detected by the sensors 152 and 156 or 154 and 158 and lie on the same side of the longitudinal center plane 18.

These deformation values D152l and D156l or D154l and D158l can also be used to identify the different behavior of the deformation regions 82 and 84 with a trailer 350 or bicycle carrier 360 when applying the three analytical criteria that are described above, and thus may be used to identify a trailer or a bicycle carrier.

The load analysis stage 233 can also operate with a simplified mode of operation.

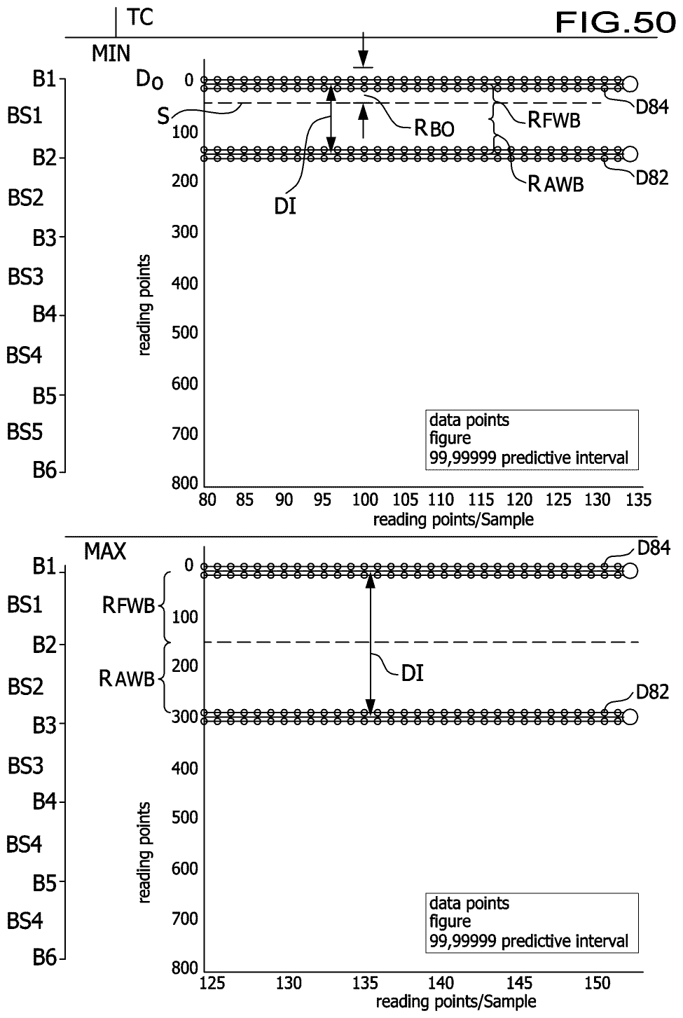

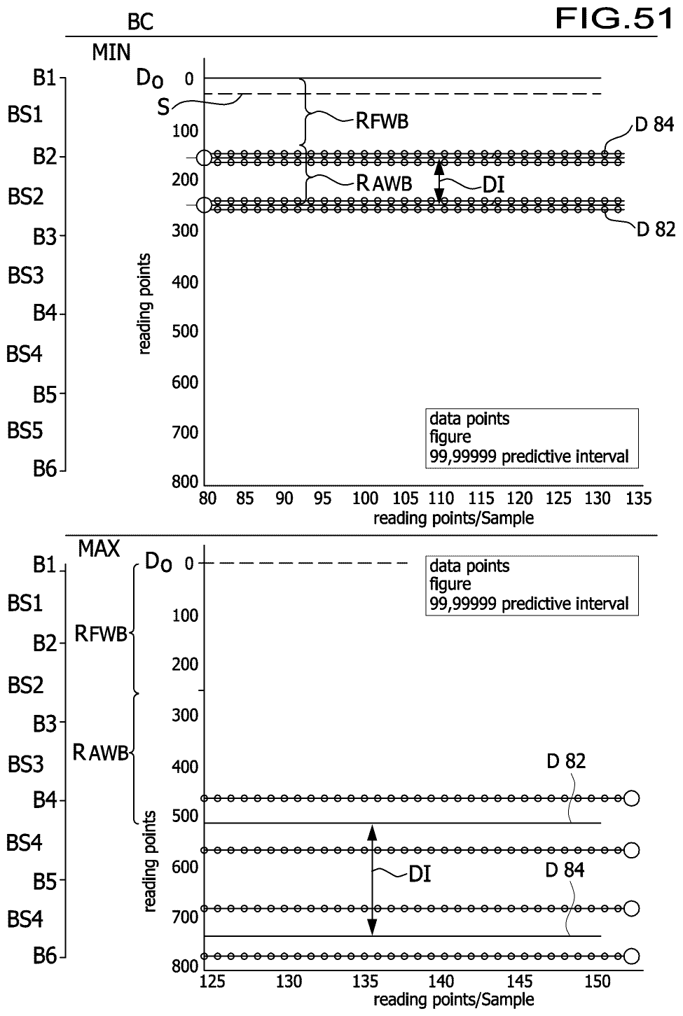

A simplified mode of operation provides, of the deformation values D152l and D154l for the deformation region 82 that has high sensitivity to tongue weight and D156l and D158l for the deformation region 84 that has little sensitivity to tongue weight, for in each case a deformation mean value D821 and D841 to be formed, and for this to be evaluated using the evaluation method, as illustrated in FIGS. 50 and 51.

It is also possible analogously to apply to these deformation mean values D821 and D841 both the first analytical criterion and the second and third analytical criteria, since the different behavior of the deformation regions 82 and 84 is also reflected in the deformation mean values D82, formed from D152l and D154l, and D84, formed from D156l and D158l, namely in that with the trailer 350 the deformation mean value D84 is close to D0 and it is substantially only the deformation mean value D82 that is significantly different from D0, whereas with a bicycle carrier 360 the deformation mean values D82 and D84 are significantly different from D0.

If the three force components Fₓ, F_{y} and F_{z} are not moreover determined, the force detection module 100 according to the invention may also have only two deformation concentration regions, namely one to which the deformations in the deformation region 82 that has high sensitivity to tongue weight are transmitted and one to which the deformations in the deformation region 84 that has little sensitivity to tongue weight are transmitted, which are then detected by these associated deformation sensors.

Preferably, in the case of an embodiment that is simplified in this way, the respective deformation concentration regions lie close to or in the longitudinal center plane 18 of the holding arm 30.

The load detection control stage 288 may also at the same time activate the force analysis stage 234 in the evaluation circuit 230 or 230′, and this then determines the values WFxl, WFzl and WFyl and may thus determine the load-induced forces on the holding element 30 and the coupling element 40, which represent the external force components Fₓ, F_{z} and F_{y} acting on the holding element 30 and the coupling element 40.

These force components Fₓ, F_{z} and F_{y} may also be transmitted to the communication stage 290, which also transmits these force components to the speed controller 322 and the stabilization system 326 and the chassis control 328.

Similarly, the communication stage 290 for example transmits these values to the presentation stage 292, which then displays these forces for example on the screen 294.

A further possible load condition, namely a rough estimate of the size of the total load without determining the forces Fₓ, F_{y} or F_{z}, is performed by a fourth analytical method.

With the fourth analytical method, the size of one or both of the deformation values D152l and D154l that have a high sensitivity to tongue weight, or of the deformation mean value D82 of the deformation region 82 that has a sensitivity to tongue weight, is determined if a trailer 350 is identified by one or more of the first to third analytical criteria, or the size of one or both of the deformation values D156l, D158l that have little sensitivity to tongue weight, or of the deformation mean value D84 of the deformation region 84 that has little sensitivity to tongue weight, is determined in order to identify how large the forces acting on the coupling element 40 are in the case of a bicycle carrier 360.

The load on the coupling element 40 is determined using the load reference values B1 to B6, as perceptible in FIGS. 48 to 51, by establishing which of the load reference values B1, B2, B3, B4, B5, B6 the respective deformation values D152l, D154l, D156l and D158l or deformation mean values D82 or D84 lie between, resulting in for example five load segments BS1 to BS5 into which the deformation values or deformation mean values can be classified and which can be forwarded as load segments BS1 to BS5 from the load analysis stage 233 by way of the communication stage 290 in the manner already described above (FIG. 45).

This may for example take place using one or more predetermined load reference values B1 . . . B6, and the order of magnitude of the total forces acting on the coupling element 40 is to be determined at least qualitatively without the need to determine the size of the forces in absolute terms.

Further, in a fifth analytical method using a fifth analytical criterion, it is possible to establish, by an exclusive comparison with a maximum load reference value B6 in FIGS. 48 to 51, the extent to which there is overloading, that is to say that the load reference value B6 has been exceeded, the extent to which there is a risk of overloading, that is to say that the load reference value B6 is about to be directly reached, and this information is likewise forwarded as a warning signal WB by the communication stage 290 (FIG. 45).

Further possible load conditions relate to the behavior of a trailer 350, in particular its dynamic behavior during travel.

Here, a precondition for determining these load conditions is that it is established that a trailer 350 is acting on the coupling element 40, according to one or more of the first to third analytical methods.

In a sixth analytical method using a sixth analytical criterion, the individual deformation values D152l, D154l, D156l and D158l are detected with time resolution while the vehicle is traveling, in order to identify sudden changes thereto.

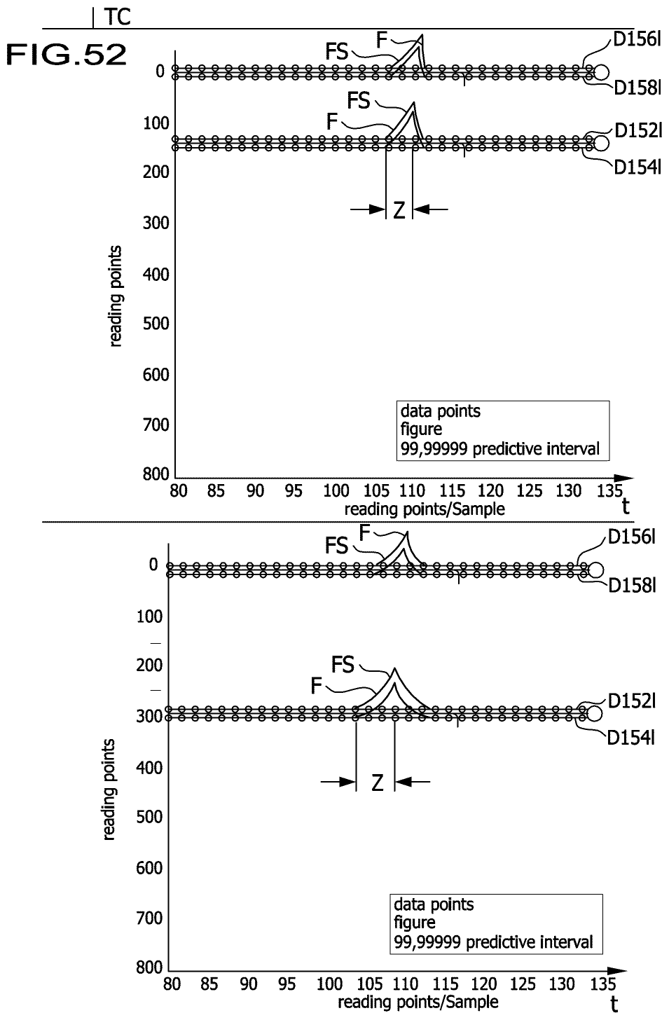

This is the case for example if all the deformation values show a brief change in the deformation values D152l, D154l, D156l and D158l in the case of a hitched trailer 350 that has been identified as such by the first three analytical criteria, as illustrated in FIG. 52, and at the same time all the deformation values D show an increase or a decrease in the values.

In this case, an additional evaluation is performed of the steepness FS of the edges F of the brief changes and/or a duration Z of an increase in the respective deformation value D from a previous starting value to a maximum value, and from these it is possible to draw conclusions on the functioning of a brake of the trailer 350 or problematic behavior of the trailer 350 in another area that results in a sudden change in the deformation values D to a maximum value, in particular in both deformation regions 82 and 84, and for example takes place over durations Z shorter than a reference duration ZR of for example less than 0.5 seconds.

If for example an overrun brake of the trailer 350 is functioning correctly, a small edge steepness FS or a long duration Z is identified; or if the overrun brake is not functioning correctly, the fact that a predetermined reference value RFS for the edge steepness FS is exceeded and/or that a duration Z is shorter than a stored reference duration RZ is identified, and then a warning signal WA is generated and forwarded by the communication unit 290 (FIG. 45).

Further analytical methods for evaluating the dynamic behavior of a trailer 350 are represented by the seventh and eighth analytical methods, which are described below.

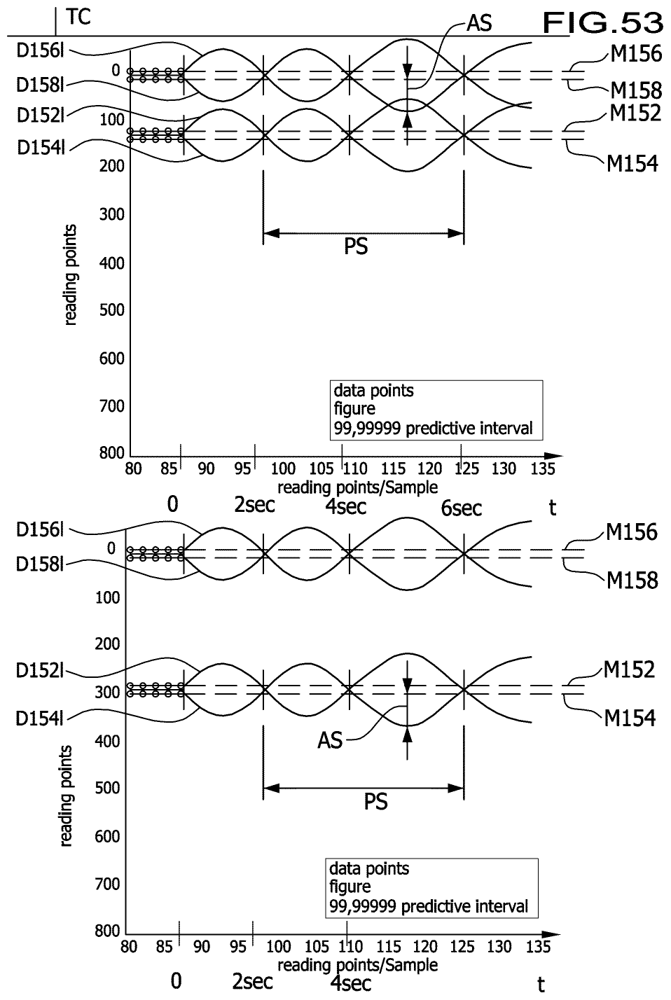

In the seventh and eighth analytical methods, illustrated in FIG. 53, once a trailer 350 acting on the coupling element 40 has been identified, and while the vehicle is traveling, variations, corresponding to oscillations in opposite phases, in the deformation values D152l, D154l of the deformation portion 82 that are detected on mutually opposing sides of the longitudinal center plane 18 and in the deformation values D156l and D158l of the deformation portion 84 that are detected on mutually opposing sides of the longitudinal center plane are detected with time resolution in each case in relation to a mean value M152, M154, M156 and M158, in order to identify transverse forces on the coupling element 40 that occur transverse to the direction of travel and result for example from a side-to-side swinging movement of the trailer 350, wherein the amplitude AS of the oscillations is a measure of how pronounced the side-to-side swinging movement is and/or a period duration PS of the swings generated by the side-to-side swinging movements is preferably in the range greater than 1 second.

With a seventh analytical criterion, a comparison is made between the amplitude AS of the oscillations and a predetermined reference value RAS, and with an eighth analytical criterion a comparison is made between the period duration PS of the oscillations and a predetermined reference value RPS, in order to identify whether the side-to-side movements of the trailer 350 are dangerous for the towing vehicle and in order then to output a warning signal WS that is forwarded by the communication unit 290 (FIG. 45).

1. A method for operating a device that is mountable on the rear side of a motor vehicle body, for coupling at least one of i) a trailer and ii) a load carrier unit, comprising a holding arm, which during operation is firmly connected at a first end to the motor vehicle body and at a second end carries a coupling element for at least one of i) the trailer and ii) the load carrier unit, wherein during operation forces acting on the coupling element and transmitted from the holding arm to the motor vehicle body are detected by an evaluation unit using deformation sensors, wherein the holding arm has at least two deformation regions of which the deformation behavior in the event of a force acting on the holding arm is detected in each case by at least one deformation sensor that is rigidly coupled to the respective deformation region of the holding arm and as a result detects its deformation behavior, wherein the evaluation unit has a load analysis stage which, taking as a starting point deformation values of the at least two deformation regions that are determined by the deformation sensors, determines at least one load type on the holding arm using analytical methods.

2. The method as claimed in claim 1, wherein the load analysis stage uses the deformation values with no transformation thereof into forces in at least one of i) the vertical direction and ii) the vehicle longitudinal direction and iii) transverse to the vehicle longitudinal center plane.

3. The method as claimed in claim 1, wherein the at least one analytical method is a value comparison method.

4. The method as claimed in claim 1, wherein, in the value comparison method, the deformation values are compared with at least one of i) one another and ii) reference values.

5. The method as claimed in claim 4, wherein the reference values are reference values that are predetermined, in particular stored.

6. The method as claimed in claim 4, wherein the reference values are determined by tests.

7. The method as claimed in claim 6, wherein the reference values are determined by loading tests of a representative holding arm.

8. The method as claimed in claim 1, wherein, in at least one analytical method, absolute values of the load-induced deformation values are evaluated.

9. The method as claimed in claim 8, wherein in the case of one analytical criterion the focus is on a comparison of the absolute values of the load-induced deformation values with threshold values as reference values.

10. The method as claimed in claim 8, wherein, in the case of at least one analytical criterion, the focus is on a comparison of each of the absolute values of the load-induced deformation values with a stored reference value range.

11. The method as claimed in claim 1, wherein, in at least one analytical method, at least one deformation value of a deformation region is compared with at least one deformation value of the at least one other deformation region.

12. The method as claimed in claim 1, wherein the analytical method is based on a comparison of the behavior of the deformation values of a deformation region having high sensitivity to tongue weight relative to a deformation region having little sensitivity to tongue weight.

13. The method as claimed in claim 11, wherein, in the analytical method, the difference between the two deformation values is determined.

14. The method as claimed in claim 13, wherein, in the analytical method, the ratio of the difference between the two deformation values to the larger of the two deformation values is determined.

15. The method as claimed in claim 11, wherein one analytical criterion focuses on a comparison of the behavior of at least one deformation value of a deformation region having high sensitivity to tongue weight relative to at least one deformation value of a deformation region having little sensitivity to tongue weight.

16. The method as claimed in claim 15, wherein the analytical criterion focuses on the ratio of the difference between the deformation values to the larger of the two deformation values by comparison with stored reference value ranges.

17. The method as claimed in claim 1, wherein one analytical method is used to determine the size of the load-induced deformation value determined in the case of at least one deformation region by a comparison of this load-induced deformation value with at least one loading reference value predetermined for this deformation value.

18. The method as claimed in claim 17, wherein, in the analytical method, the at least one load-induced deformation value is associated with a plurality of predetermined loading reference values by associating the at least one load-induced deformation value with the ranges between each two successive loading reference values.

19. The method as claimed in claim 17, wherein an analytical criterion focuses on the association of the at least one of the deformation values relative to the series of at least three loading reference values provided in relation to this deformation value.

20. The method as claimed in claim 1, wherein, in one analytical method, a comparison is made of at least one of the deformation values with an associated maximum loading reference value.

21. The method as claimed in claim 20, wherein an analytical criterion focuses on the association of the load-induced deformation value of at least one of the load-induced deformation values relative to a maximum loading reference value associated with the deformation value.

22. The method as claimed in claim 1, wherein one analytical method detects at least one of the load-induced deformation values with time resolution.

23. The method as claimed in claim 22, wherein an analytical criterion focuses on a brief time-based change in at least one of the deformation values.

24. The method as claimed in claim 23, wherein, in the analytical method, an increase behavior by at least one of the load-induced deformation values is detected.

25. The method as claimed in claim 24, wherein an analytical criterion compares an edge steepness of the increase behavior with a stored reference value.

26. The method as claimed in claim 22, wherein, in the analytical method, a duration of an increase in at least one of the load-induced deformation values to a maximum value is determined.

27. The method as claimed in claim 22, wherein an analytical criterion focuses on comparing the duration with a reference time.

28. The method as claimed in claim 22, wherein an analytical criterion focuses on a temporal course of at least one of the deformation values.

29. The method as claimed in claim 22, wherein, in the analytical method, a temporal course of an oscillation of at least one of the deformation values about a mean value of this oscillating deformation value is detected.

30. The method as claimed in claim 29, wherein an analytical criterion focuses on a comparison of an amplitude of oscillations of the one of the load-induced deformation values about the mean value with a reference value.

31. The method as claimed in claim 28, wherein an analytical criterion focuses on a comparison of a period duration of the one of the load-induced deformation values with a reference period duration.

32. The method for operating a device that is mountable on the rear side of a motor vehicle body, for coupling at least one of i) a trailer and ii) a load carrier unit, comprising a holding arm, which during operation is firmly connected at a first end to the motor vehicle body and at a second end carries a coupling element for at least one of i) the trailer and ii) the load carrier unit, wherein during operation forces acting on the coupling element and transmitted from the holding arm to the motor vehicle body are detected by an evaluation unit using deformation sensors, wherein the holding arm has at least two deformation regions of which the deformation behavior in the event of a force acting on the holding arm is detected in each case by at least one deformation sensor that is rigidly coupled to the respective deformation region of the holding arm and as a result detects its deformation behavior, wherein each of the deformation values that is made use of by the load analysis stage is corrected by a zero-load correction stage.

33. The method as claimed in claim 32, wherein the zero-load correction stage determines a deformation value under zero load and subtracts it from a determined deformation value under load.

34. The method as claimed in claim 32, wherein the zero-load correction stage is activated before the holding arm is loaded.

35. The method as claimed in claim 32, wherein the zero-load correction stage is activated after the holding arm has moved into a working position.

36. The method as claimed in claim 1, wherein each deformation value that is made use of by the load analysis stage is corrected by an inclination correction stage, which corrects the actual orientation of the holding arm on the basis of an inclination of the vehicle in relation to a deformation value when the holding arm is in an orientation with a vehicle standing on a horizontal reference surface.

37. The method as claimed in claim 36, wherein the inclination correction stage changes the deformation values of the deformation regions such that with these the influence of the changed orientation of the holding arm relative to an orientation of the holding arm with a vehicle standing on a horizontal reference surface is taken into account.

38. The method as claimed in claim 36, wherein the inclination correction stage operates with stored inclination correction values.

39. The method as claimed in claim 38, wherein the inclination correction stage operates with experimentally determined inclination correction values.

40. A device that is mountable on the rear side of a motor vehicle body, for coupling at least one of i) a trailer and ii) a load carrier unit, comprising a holding arm, which during operation is firmly connected at a first end to the motor vehicle body and at a second end carries a coupling element for at least one of i) the trailer and ii) the load carrier unit, wherein during operation forces acting on the coupling element and transmitted from the holding arm to the motor vehicle body are detected by an evaluation unit using deformation sensors, wherein the holding arm has at least two deformation regions of which the deformation behavior in the event of a force acting on the holding arm is detected in each case by at least one deformation sensor that is rigidly coupled to the respective deformation region of the holding arm and as a result detects its deformation behavior, wherein the evaluation unit has a load analysis stage which, taking as a starting point deformation values of the at least two deformation regions that are determined by the deformation sensors, determines at least one load type on the holding arm using analytical methods.

41. The device as claimed in claim 40, wherein the load analysis stage uses the deformation values with no transformation thereof into forces in at least one of i) the vertical direction and ii) the vehicle longitudinal direction and iii) transverse to the vehicle longitudinal center plane.

42. The device as claimed in claim 40, wherein the at least one analytical method is a value comparison method.

43. The device as claimed in claim 40, wherein, in the value comparison method, the deformation values are compared with at least one of i) one another and ii) reference values.

44. The device as claimed in claim 43, wherein the reference values are reference values that are predetermined, in particular stored.

45. The device as claimed in claim 43, wherein the reference values are determined by tests.

46. The device as claimed in claim 45, wherein the reference values are determined by loading tests of a representative holding arm.

47. The device as claimed in claim 40, wherein, in at least one analytical method, absolute values of the load-induced deformation values are evaluated.

48. The device as claimed in claim 47, wherein in the case of one analytical criterion the focus is on a comparison of the absolute values of the load-induced deformation values with threshold values as reference values.

49. The device as claimed in claim 47, wherein, in the case of at least one analytical criterion, the focus is on a comparison of each of the absolute values of the load-induced deformation values with a stored reference value range.

50. The device as claimed in claim 40, wherein, in at least one analytical method, at least one deformation value of a deformation region is compared with at least one deformation value of the at least one other deformation region.

51. The device as claimed in claim 40, wherein the analytical method is based on a comparison of the behavior of the deformation values of a deformation region having high sensitivity to tongue weight relative to a deformation region having little sensitivity to tongue weight.

52. The device as claimed in claim 50, wherein, in the analytical method, the difference between the two deformation values is determined.

53. The device as claimed in claim 52, wherein, in the analytical method, the ratio of the difference between the two deformation values to the larger of the two deformation values is determined.

54. The device as claimed in claim 50, wherein one analytical criterion focuses on a comparison of the behavior of at least one deformation value of a deformation region having high sensitivity to tongue weight relative to at least one deformation value of a deformation region having little sensitivity to tongue weight.

55. The device as claimed in claim 54, wherein the analytical criterion focuses on the ratio of the difference between the deformation values to the larger of the two deformation values by comparison with stored reference value ranges.

56. The device as claimed in claim 40, wherein in one analytical method is used to determine the size of the load-induced deformation value determined in the case of at least one deformation region by a comparison of this load-induced deformation value with at least one loading reference value predetermined for this deformation value.

57. The device as claimed in claim 56, wherein, in the analytical method, the at least one load-induced deformation value is associated with a plurality of predetermined loading reference values by associating the at least one load-induced deformation value with the ranges between each two successive loading reference values.

58. The device as claimed in claim 56, wherein an analytical criterion focuses on the association of the at least one of the deformation values relative to the series of at least three loading reference values provided in relation to this deformation value.

59. The device as claimed in claim 40, wherein, in one analytical method, a comparison is made of at least one of the deformation values with an associated maximum loading reference value.

60. The device as claimed in claim 59, wherein an analytical criterion focuses on the association of the load-induced deformation value of at least one of the load-induced deformation values relative to a maximum loading reference value associated with the deformation value.

61. The device as claimed in claim 40, wherein one analytical method detects at least one of the load-induced deformation values with time resolution.

62. The device as claimed in claim 61, wherein an analytical criterion focuses on a brief time-based change in at least one of the deformation values.

63. The device as claimed in claim 62, wherein, in the analytical method, an increase behavior by at least one of the load-induced deformation values is detected.

64. The device as claimed in claim 63, wherein an analytical criterion compares an edge steepness of the increase behavior with a stored reference value.

65. The device as claimed in claim 61, wherein, in the analytical method, a duration of an increase of at least one of the load-induced deformation values to a maximum value is determined.

66. The device as claimed in claim 61, wherein an analytical criterion focuses on comparing the duration with a reference time.

67. The device as claimed in claim 61, wherein an analytical criterion focuses on a temporal course of at least one of the deformation values.

68. The device as claimed in claim 61, wherein, in the analytical method, a temporal course of an oscillation of at least one of the deformation values about a mean value of this oscillating deformation value is detected.

69. The device as claimed in claim 68, wherein an analytical criterion focuses on a comparison of an amplitude of oscillations of the one of the load-induced deformation values about the mean value with a reference value.

70. The device as claimed in claim 67, wherein an analytical criterion focuses on a comparison of a period duration of the one of the load-induced deformation values with a reference period duration.

71. The device that is mountable on the rear side of a motor vehicle body, for coupling at least one of i) a trailer and ii) a load carrier unit, comprising a holding arm, which during operation is firmly connected at a first end to the motor vehicle body and at a second end carries a coupling element for at least one of i) the trailer and ii) the load carrier unit, wherein during operation forces acting on the coupling element and transmitted from the holding arm to the motor vehicle body are detected by an evaluation unit using deformation sensors, wherein the holding arm has at least two deformation regions of which the deformation behavior in the event of a force acting on the holding arm is detected in each case by at least one deformation sensor that is rigidly coupled to the respective deformation region of the holding arm and as a result detects its deformation behavior, wherein the deformation value that is made use of by the load analysis stage is corrected by a zero-load correction stage.

72. The device as claimed in claim 71, wherein the zero-load correction stage determines a deformation value under zero load and subtracts it from a determined deformation value under load.

73. The device as claimed in claim 71, wherein the zero-load correction stage is activated before the holding arm is loaded.

74. The device as claimed in claim 71, wherein the zero-load correction stage is activated after the holding arm has moved into a working position.

75. The device as claimed in claim 40, wherein each deformation value that is made use of by the load analysis stage is corrected by an inclination correction stage, which corrects the actual orientation of the holding arm on the basis of an inclination of the vehicle in relation to a deformation value when the holding arm is in an orientation with a vehicle standing on a horizontal reference surface.

76. The device as claimed in claim 75, wherein the inclination correction stage changes the deformation values of the deformation regions such that with these the influence of the changed orientation of the holding arm relative to an orientation of the holding arm with a vehicle standing on a horizontal reference surface is taken into account.

77. The device as claimed in claim 75, wherein the inclination correction stage operates with stored inclination correction values.

78. The device as claimed in claim 77, wherein the inclination correction stage operates with experimentally determined inclination correction values.

79. The device that is mountable on the rear side of a motor vehicle body, for coupling at least one of i) a trailer and ii) a load carrier unit, comprising a holding arm, which during operation is firmly connected at a first end to the motor vehicle body and at a second end carries a coupling element for at least one of i) the trailer and ii) the load carrier unit, wherein during operation forces acting on the coupling element and transmitted from the holding arm to the motor vehicle body are detected by an evaluation unit using deformation sensors, wherein the holding arm has at least two deformation regions of which the deformation behavior in the event of a force acting on the holding arm is detected in each case by at least one deformation sensor that is rigidly coupled to the respective deformation region of the holding arm and as a result detects its deformation behavior, wherein the at least two deformation sensors of the sensor arrangement are arranged on the same side of a neutral axis of the holding arm which is not variable in length during a bending deformation of the holding arm.

80. The device as claimed in claim 79, wherein arranged on one side of the holding arm is a force detection module that comprises a sensor arrangement which during operation detects forces acting on the coupling element and transmitted from the holding arm to the motor vehicle body.

81. The device as claimed in claim 80, wherein the sensor arrangement has at least three, in particular four, deformation sensors.

82. The device as claimed in claim 80, wherein the force detection module is not arranged, in the operating condition, on a side of the holding arm facing a road.

83. The device as claimed in claim 80, wherein the force detection module is arranged, in the operating condition, on a side of the holding arm facing away from a road.

84. The device that is mountable on the rear side of a motor vehicle body, for coupling at least one of i) a trailer and ii) a load carrier unit, comprising a holding arm, which during operation is firmly connected at a first end to the motor vehicle body and at a second end carries a coupling element for at least one of i) the trailer and ii) the load carrier unit, wherein during operation forces acting on the coupling element and transmitted from the holding arm to the motor vehicle body are detected by an evaluation unit using deformation sensors, wherein the holding arm has at least two deformation regions of which the deformation behavior in the event of a force acting on the holding arm is detected in each case by at least one deformation sensor that is rigidly coupled to the respective deformation region of the holding arm and as a result detects its deformation behavior, wherein during operation forces acting on the coupling element and transmitted from the holding arm to the motor vehicle body are detected by an evaluation unit having a sensor arrangement that has at least two deformation sensors, wherein the deformation sensors are arranged on at least one deformation transmission element which is connected to the holding arm.

85. The device that is mountable on the rear side of a motor vehicle body, for coupling at least one of i) a trailer and ii) a load carrier unit, comprising a holding arm, which during operation is firmly connected at a first end to the motor vehicle body and at a second end carries a coupling element for at least one of i) the trailer and ii) the load carrier unit, wherein during operation forces acting on the coupling element and transmitted from the holding arm to the motor vehicle body are detected by an evaluation unit using deformation sensors, wherein the holding arm has at least two deformation regions of which the deformation behavior in the event of a force acting on the holding arm is detected in each case by at least one deformation sensor that is rigidly coupled to the respective deformation region of the holding arm and as a result detects its deformation behavior, wherein during operation forces acting on the coupling element and transmitted from the holding arm to the motor vehicle body are detected by an evaluation unit having a sensor arrangement that has at least two deformation sensors, wherein all the deformation sensors of the sensor arrangement are arranged on a common deformation transmission element.

86. The device as claimed in claim 79, wherein in the event of one and the same force acting on the coupling element each of the at least two deformation sensors detects different amounts of deformation of the holding arm.

87. The device as claimed in claim 79, wherein the deformation transmission element is connected to the holding arm in a manner free of relative movement and thus rigidly at at least two securing regions, and wherein at least one of the deformation sensors is arranged between the securing regions of the deformation element.

88. The device as claimed in claim 79, wherein the deformation transmission element is connected to the holding arm by at least three securing regions, and wherein at least one of the deformation sensors is arranged respectively between two of the securing regions.

89. The device as claimed in claim 79, wherein the deformation transmission element is connected to the holding arm in the securing regions using connection elements.

90. The device as claimed in claim 89, wherein the connection elements are connected on the one hand rigidly to the holding arm and on the other rigidly to the securing regions of the deformation transmission element.

91. The device as claimed in claim 90, wherein the connection elements are integrally formed on the holding arm.

92. The device as claimed in claim 79, wherein the connection elements transmit deformations of the holding arm in deformation regions of the holding arm that respectively lie between the connection elements to the securing regions of the deformation transmission element.

93. The device as claimed in claim 89, wherein a deformation region of the holding arm lies in each case between two connection elements.

94. The device as claimed in claim 79, wherein the holding arm has at least two deformation regions, of which deformations are transmitted to securing regions of the deformation transmission element by way of connection elements that are arranged on either side of the respective deformation region, wherein a deformation-affected region of the deformation transmission element lies between the securing regions.

95. The device as claimed in claim 94, wherein the at least two deformation regions are arranged successively in a direction of extent of the holding arm.

96. The device as claimed in claim 79, wherein at least one deformation sensor is arranged in one of the deformation-affected regions of the deformation transmission element.

97. The device as claimed in claim 94, wherein each deformation-affected region is connected to a deformation-resistant region of the deformation transmission element, and wherein the securing regions respectively lie in a deformation-resistant region.

98. The device as claimed in claim 97, wherein the deformation-affected regions are respectively arranged between two deformation-resistant regions.

99. The device as claimed in claim 97, wherein the deformation-resistant regions and the deformation-affected regions are arranged successively in a deformation direction.

100. The device as claimed in claim 94, wherein the deformation-affected regions take the form of deformation concentration regions.

101. The device as claimed in claim 79, wherein the material of the deformation transmission element outside the deformation-affected regions takes the form of deformation-resistant or deformation-insusceptible material.

102. The device as claimed in claim 79, wherein the material of the deformation transmission element in the deformation-affected regions is prone to deformation as a result of being given a shape, for example a narrowing in cross section.

103. The device as claimed in claim 79, wherein the deformation transmission element has, next to the respective deformation-affected region, a deformation-free region on which at least one reference deformation sensor is arranged.

104. The device as claimed in claim 103, wherein the respective deformation-free region is made from the same material as the deformation-affected region.

105. The device as claimed in claim 103, wherein the respective deformation-free region is connected on one side to a deformation-resistant region of the deformation transmission element.

106. The device as claimed in claim 103, wherein the deformation-free region of the deformation transmission element is formed in the manner of a tongue.

107. The device as claimed in claim 103, wherein the deformation-free region of the deformation transmission element is made from the same material, in particular with the same material thickness, as the deformation-affected region.

108. The device as claimed in claim 103, wherein the reference deformation sensors are thermally coupled to the deformation transmission element.

109. The device as claimed in claim 108, wherein the reference deformation sensors are thermally coupled to the deformation sensors by way of the deformation transmission element.

110. The device as claimed in claim 109, wherein, for the purpose of optimum thermal coupling, between the respective deformation sensor and the reference deformation sensor associated therewith, each deformation-affected region that is provided with a deformation sensor is thermally coupled to the deformation-free region associated therewith and carrying the associated reference deformation sensor.

111. The device as claimed in claim 103, wherein the deformation-free region carrying the respective reference deformation sensor has the same thermal behavior as the deformation-affected region carrying the corresponding deformation sensor.

112. The device as claimed in claim 103, wherein the respective deformation-free region carrying the reference deformation sensor has a geometric shape that is comparable with the deformation-affected region carrying the deformation sensor.

113. The device as claimed in claim 103, wherein the deformation-free region of the deformation transmission element is made from the same material as the deformation-affected region of the deformation transmission element.

114. The device as claimed in claim 103, wherein at least one temperature sensor is associated with the reference deformation sensors for the purpose of monitoring function.

115. The device as claimed in claim 79, wherein the deformation transmission element takes a plate-like form and each deformation-affected region carrying a deformation sensor is formed by a narrowing in cross section of the deformation transmission element.

116. The device as claimed in claim 115, wherein the narrowing in cross section of the deformation transmission element is formed by a narrowing of a surface extent of the deformation transmission element.

117. The device as claimed in claim 79, wherein the deformation sensors and the reference deformation sensors take the form of extension sensors, in particular strain gages.

118. The device as claimed in claim 79, wherein the deformation sensors and the reference deformation sensors take the form of magnetostrictive or optical sensors.

119. The device that is mountable on the rear side of a motor vehicle body, for coupling at least one of i) a trailer and ii) a load carrier unit, comprising a holding arm, which during operation is firmly connected at a first end to the motor vehicle body and at a second end carries a coupling element for at least one of i) the trailer and ii) the load carrier unit, wherein during operation forces acting on the coupling element and transmitted from the holding arm to the motor vehicle body are detected by an evaluation unit using deformation sensors, wherein the holding arm has at least two deformation regions of which the deformation behavior in the event of a force acting on the holding arm is detected in each case by at least one deformation sensor that is rigidly coupled to the respective deformation region of the holding arm and as a result detects its deformation behavior, wherein the holding arm has, between the first end and the second end, a first deformation region and a second deformation region which, when there is a force acting in the longitudinal center plane of the holding arm parallel to the direction of travel, each undergo deformations that differ from the deformations when there is a force acting in the longitudinal center plane and transversely to the direction of travel.

120. The device as claimed in claim 119, wherein, when there is a force acting transversely, in particular perpendicular, to the longitudinal center plane, the first and the second deformation region each undergo deformations that differ from the deformations when there is a force acting in the longitudinal center plane at least one of i) parallel and ii) transversely to the direction of travel.

121. The device as claimed in claim 119, wherein the first and the second deformation region are arranged successively, as seen in a direction of extent of the holding arm.

122. The device as claimed in claim 40, wherein each deformation sensor is connected up to the associated reference deformation sensor in a Wheatstone bridge.

123. The device as claimed in claim 40, wherein the evaluation unit has a processor which converts the values corresponding to the deformations in the deformation-affected regions, using transformation values that are determined by calibration and stored in a memory, into the corresponding values of forces acting three spatial directions running transversely, in particular perpendicular, to one another and on the coupling element.

124. The device as claimed in claim 40, wherein two of the forces run parallel to and in particular in the longitudinal center plane of the holding arm but transversely, in particular perpendicular, to one another, and wherein the third force runs transversely, in particular perpendicular, to the longitudinal center plane of the holding arm.

125. The device as claimed in claim 123, wherein transformation values for combinations of forces acting on the coupling element in different octants are stored in the memory.

126. The device as claimed in claim 40, wherein the evaluation unit detects values of deformation sensors and in particular reference deformation sensors for the purpose of determining deformations.

127. The device as claimed in claim 126, wherein the evaluation unit detects values of at least one temperature sensor for the function check of the reference deformation sensors.

128. The device as claimed in claim 127, wherein the evaluation unit detects values of respectively one temperature sensor associated with the respective reference deformation sensor.

129. The device as claimed in claim 40, wherein the holding arm carries the coupling element at its second end.

130. The device as claimed in claim 129, wherein the holding arm and the coupling element form a cohesive part.

131. The device as claimed in claim 129, wherein the holding arm takes the form of a ball neck and carries the coupling element, which comprises a coupling ball, at the second end.

132. The device as claimed in claim 40, wherein the holding arm comprises a receiving body that is formed for detachably receiving the coupling element.

133. The device as claimed in claim 132, wherein the receiving body has an insertion receptacle that is accessible through an insertion opening.

134. The device as claimed in claim 132, wherein the coupling element comprises a carrier arm.

135. The device as claimed in claim 132, wherein the carrier arm is configured to be inserted into the insertion receptacle and fixed therein with an insertion portion.

136. The device as claimed in claim 132, wherein the carrier arm carries a coupling ball.

137. The device as claimed in claim 135, wherein the insertion portion is received in the insertion receptacle transversely, in an insertion direction, with positive engagement and in the functional condition is fixed in the insertion direction by a positive-engagement body.

138. The device that is mountable on the rear side of a motor vehicle body, for coupling at least one of i) a trailer and ii) a load carrier unit, comprising a holding arm, which during operation is firmly connected at a first end to the motor vehicle body and at a second end carries a coupling element for at least one of i) the trailer and ii) the load carrier unit, wherein during operation forces acting on the coupling element and transmitted from the holding arm to the motor vehicle body are detected by an evaluation unit using deformation sensors, wherein the holding arm has at least two deformation regions of which the deformation behavior in the event of a force acting on the holding arm is detected in each case by at least one deformation sensor that is rigidly coupled to the respective deformation region of the holding arm and as a result detects its deformation behavior, wherein the holding arm is provided with at least three deformation sensors which respond in particular in different ways to three forces acting on the coupling element in spatial directions that run transversely to one another, and wherein the at least three deformation sensors deliver sensor values from which at least one force component acting on the coupling element is determined using an evaluation unit.

139. The device as claimed in claim 40, wherein the evaluation unit determines at least one of the values of its force component running in the spatial directions.

140. The device as claimed in claim 40, wherein the evaluation unit determines the value of its force component running in the direction of gravity.

141. The device as claimed in claim 40, wherein the evaluation unit determines the value of its force component running in the direction of travel of the motor vehicle.

142. The device as claimed in claim 40, wherein the evaluation unit determines the value of its force component running transversely, in particular perpendicular, to a vertical longitudinal center plane.
